(19) United States
(12) Patent Application Publication
(10) Pub. No.: US 2002/0019785 A1
(43) Pub. Date: Feb. 14, 2002

(54) System and method for returning merchandise

(76) Inventor: Jonathan Whitman, Baltimore, MD (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/864,155

(22) Filed: May 25, 2001

Related U.S. Application Data
(60) Provisional application No. 60/206,950, filed on May 25, 2000.
(60) Provisional application No. 60/228,666, filed on Aug. 29, 2000.

(51) Int. Cl. G06F 17/60

(52) U.S. Cl. 705/28

(57) ABSTRACT

A method and system for returning, including exchanging, items provided by remote providers, such as e-tailers, catalog sellers, and direct merchants. Returnees access the remoter provider servers or a returns server to initiate the return process. Data is received regarding the returnee and the item condition. A return ticket, including a coded identifier, is transmitted, based on the data received, along with locations of extension stores. The returnee returns the item to an extension store, which is connected via a network and the returns server to the remote provider servers. The coded identifier is read at the extension store, and communicated information regarding the item is used to determine return. Other features include a reverse auction for some returned items, direct shipment of returned items to other customers, and warehousing of returned items. Returnees and others are also able to purchase items with many payment forms via the extension stores.

This application claims priority from U.S. Provisional Patent Application Ser. No. 60/206,950 filed May 25, 2000, and from U.S. Provisional Patent Application Ser. No. 60/228,666 filed Aug. 29, 2000. The entirety of both of these provisional patent applications are incorporated herein by reference.

### BACKGROUND OF THE INVENTION

1. Field of the Invention

The present invention relates to the field of returns of ordered merchandise and other items, and in particular to a method and system for providing electronically and networked based assistance, including assistance via the Internet, for item returns and for providing retail locations other than where purchased or brick and mortar retail locations for virtual merchants selling products remotely via networks, and in person assistance for providing returns for items ordered remotely via networks.

2. Background of the Technology

In the United States, the retail industry is a $2.6 trillion market, a driving force of the economy, a vast source of jobs and the lifeblood for millions of small, medium and large-sized businesses across the country. Today, the retail industry is undergoing a major revolution, the Internet revolution. In only five years, the World Wide Web has emerged as a new channel for retailer-consumer interactions ranging from direct online purchases to online consumer research, comparison shopping and product evaluation.

As a result, the Internet is fundamentally changing not only where people buy, but also how, how often, how much, when, what, and even why. Yet, there are some aspects of the traditional retail shopping experience that the Internet has not been able to address, namely, the kind of human, interaction for post-sale issues such as returns, exchanges and order reconciliation found in traditional brick and mortar operations.

While the World Wide Web has transformed the way consumers make purchasing decisions, the Internet shopping experience has become unwieldy and far too impersonal. Recent research studies show that 62 percent of online shoppers had given up at least once while looking for products to buy, and 42 percent had turned to traditional channels to make their purchase. An astonishing two-thirds, or 67 percent, of online purchases are never completed because of inadequate customer service and post-sale support.

Today, in this ever growing and competitive electronic commerce landscape, the key driver of success or failure is the “customer experience”. The unfortunate reality is that e-businesses are losing untold millions in online sales to consumers all too willing to spend money, but equally determined to have a satisfactory customer experience as pleasant as what they have come to expect from brick and mortar merchants. As a result, online companies are losing precious opportunities for sales, customer relationships and positive word-ofmouth, adding up to staggering amounts of lost revenues and capital undervaluation.

As the buyers and sellers in online shopping communities continue to define themselves, certain online consumer shopping trends have emerged as key parts of e-commerce success. Chief among these trends is long-term relationship building rather than first-time visitor attraction. As security concerns fade, and convenience and price become increasingly important “givens” to online shoppers, customer service will emerge as a make-or-break criterion for return shoppers. In the online buyer-seder relationship, power is moving to the buyer. As a result, in the balance between online customer acquisition and maintenance, e-tailers will need to start emphasizing “nurture” over “capture”.

Another way to appreciate the importance of the customer experience is by considering the value of the customer relationship. On the negative side, one bad customer experience can cause a consumer to abandon a site permanently. With plenty of competitor sites to visit, shoppers have little incentive to return to an online merchant that has failed to meet their needs. Even worse, when customers have a bad experience online, their displeasure is shared with others who themselves spread the negative review even further. As a result, an e-business may lose the lifetime value of many shoppers by providing one bad experience.

In contrast, providing a great customer experience on the Web can result in strong word-of-mouth exposure, media accolades and increased revenue. If customers achieve their goals online, they feel good about the experience, which will likely lead to future visits by shoppers and long-term loyalty for the site, including positive referrals to friends and family. That loyalty can result in the capture of substantial lifetime revenue.

What do e-commerce customers want? Research of online shopper buying habits has identified the key criteria in the buying decision process as service, security, selection and price. Selection and price have been important considerations long before the Web. But customer service and security, which repeatedly appear in e-commerce surveys as key issues, are becoming equally important on the Internet, as they are both driven by the customer experience. In fact, one leading study identifies product return and exchange concerns as the second leading barrier to online purchasing.

It is no surprise, then, that many studies list post-sale customer service as a key driver of online purchases. Whether they are on the Internet to quickly, buy one item or to browse and compare offerings from different online merchants, today's online shoppers are mainly concerned with accomplishing their goal of finding and buying the right item while feeling confident that the merchant will satisfactorily handle complaints, returns and exchanges.

For businesses to fully exploit the new economy of the Internet, they must undertake the challenging process of clarifying their goals, identifying their customers, and then making a commitment to create and maintain the good experience by blending streamlined Internet efficiency with traditional retailing values. Done right, such a strategy pays for itself many times over in increased revenue, a strengthened brand, better word-of-mouth marketing and greater customer loyalty, leaving it well positioned for future success.

Thus there is a problem in that people purchasing merchandise and otherwise obtaining items unseen typically have little comfort or assistance in resolving any dispute about these items or obtaining returns or exchanges. While this problem existed for many years with mail order businesses, the problem has become exacerbated with greatly increased numbers of purchases online, such as via the Internet.

With regard to merchants, such as e-tailers and other companies doing business on or wanting to utilize the Internet and other networks, a problem exists in that, while retailers are able to get consumers to visits sites, customer retention can often fall because customers are typically unable to return or find difficulty with returning items or otherwise interacting on a personal level with people representing these merchants.

E-tailers and other merchants utilizing networks, such as the Internet, also have another problem. For many virtual merchants, their business model depends upon or does not account for handling return of merchandise, both from the perspective of missing returns or partial returns and from the perspective of handling the supply chain with regard to returned items.

Further, with normal brick-and-mortar business merchandise returns, the merchant typically does not issue a refund or other return until a person intercedes and inspects the returned product to ensure it meets the merchant's requirements, including completeness of the returned item. For example, if a consumer returns a camcorder to an electronics outlet, unless the battery is included, the consumer will not receive the full refund. However, with a virtual model, the same consumer may be returning the item by mail, and a dispute may arise. The merchant in this case will have either an unhappy customer or added expense from taking back an incomplete return. In addition, even if the return is perfect, the merchant is unlikely to have a system in place to handle the return, both within the merchant's facility and with respect to any outside suppliers.

What is needed is a method and system that provide the following: 1) assistance to the consumer or other obtainer of items with receiving a refund or other compensation and providing such refunds immediately, in the same manner as refunds are provided by brick-and-mortar businesses; 2) personal connection between the consumer and the business, such that consumers are retained at an increased level and will return to the business; and 3) assistance to the business with the process of handling returned goods, from both the perspective of missing or fraudulent returns, and the perspective of reduced and managed supply chain costs.

### SUMMARY OF THE INVENTION

The present invention provides a method and system for network or other virtual purchases or other obtainers of items (also referred to as “returnees”) to receive a physical connection point for dealing with these items. One embodiment of the present invention includes providing at least one, and preferably a number of physical locations as “extension stores” (physical or brick and mortar that serve as item return locations) for virtual providers of the items. In one embodiment, these extension stores, while independent, are dedicated to serving as locations primarily for returns. For example, in accordance with this embodiment, over a thousand locations could be provided as local extension stores (also referred to as “returns locations”) for online merchants. Any purchaser via the Internet is able to bring the product back to any of these local extension stores, regardless of the location of the merchant, and the purchaser is able to be treated as if the purchaser were in the merchant's store.

To accomplish these features, embodiments the present invention include one or more extension stores linked, such as via a network (e.g., the Internet), with merchants or others providing items, or at least allowing returns, including exchanges, via the network. In addition, embodiments of the present invention include methods and systems for obtaining and transferring data gathered by the merchants via, for example, the merchants' web sites, to one or more servers for the extension stores. In the event of additional assistance being needed by a customer or other party interacting with the merchant, information, such as the product to be returned, its condition, and other information about the product and the customer, is provided by the customer to the e-tailer, such as via a network. The input information is verified, such as with an initial verification by the merchant. The information is transferred to the server for the extension stores. Upon receipt and verification of information, an electronic ticket is then generated for the customer, which optionally includes a bar code or other unique identifier (coded information) for the product to be returned, and the customer is provided with at least one closest extension store to which the product can be returned. The customer then prints out the ticket and returns the item to the extension store, where a refund, including an instant refund, or replacement product is provided upon verification.

An embodiment of the present invention further includes methods and systems for addressing the handling of the returned product. In general, at least the following three item return scenarios are handled in accordance with embodiments of the present invention: 1) the item is returned unopened and undamaged; 2) the item is returned opened and undamaged; and 3) the item is returned damaged or incomplete. If the item is retry ed unopened and undamaged, the item may follow one of several tracks. In a first track, the item is stored and shipped or immediately shipped to another consumer upon receipt of instructions to so ship from the merchant. In a second track, the item is simply returned to the merchant or a warehouser for the item.

If the item is returned opened and undamaged, an embodiment of the present invention includes liquidation of the item by the extension stores. In one embodiment, the extension stores have an associated server on a network, such as a website, for liquidation of such items by reverse auction. One embodiment of the reverse auction is referred to as a “falling auction,” in which the price of the item is set and then drops periodically. In an embodiment of the present invention, the merchant for which the item is being liquidated is able to provide input as to the duration of the liquidation (e.g., length of falling auction) and other factors, such as the initial auction price and the increments of price reduction.

For returned items that are damaged or incomplete, in an embodiment of the present invention, the extension stores reduce the costs and effort associated with return of the product to the manufacturer by gathering the defect information and, as directed by merchants, sending the item back to the manufacturer.

Some advantages of the present invention include the following: 1) decreased operating expenses by outsourcing product-handling systems and processes designed for reverse logistics; 2) reduced expensive customer service calls that erode profit margins and increase operating costs; 3) minimization of the considerable losses that result from incomplete and fraudulent returns by inspecting items before issuing refunds; 4) improved merchandising efforts by capture and analysis of real-time return information; 5) assessment of product line profitability, supply-chain efficiency, and other vital performance issues; 6) expansion of customer relationships by offering unique returns and customer service options; and 7) recapture of significant value by reselling returned items at higher than liquidation prices. Further, the present invention provides the following: 1) free customer shipping on returned or exchanged merchandise; 2) extended and weekend hours for free and convenient drop-off, 3) instant charge card credits for in-store returned merchandise; 4) instant exchange and store credits for in-store returned merchandise; 5) 24-hour customer service center for pre-sale and post-sale questions; 6) direct shipping of returned merchandise to merchant warehouses; 7) direct shipping of returned merchandise to merchant suppliers; 8) returned merchandise sales through action and liquidation sites; 9) check and cash payments for customers not using credit cards; 10) drop-shipments for customers with delivery difficulties; 11) same-day pickup and delivery from iReturns locations nationwide; 12) in-store product samples for customer inspection and evaluation; and 13) nationwide advertising exposure with network site (e.g., Internet/World Wide Web) links and in-store kiosks.

To achieve the stated and other advantages of the present invention, as embodied and described below, the invention includes a method for providing return of items via a network and via an item return location, the method comprising: receiving a selection to return an item; receiving information relating to the item to be returned; determining return information for the item from the received information relating to the item to be returned; assigning coded information relating to the item to be returned, the coded information being associated with the determined return information; transmitting the coded information via the network, the coded information to be provided with return of the item; at the item return location, reading the provided coded information; accessing the determined return information; and evaluating the item for return based on the determined return information.

To achieve the stated and other advantages of the present invention, as embodied and described below, the invention further includes a system for providing return of an item via a network, comprising: a server, the server being accessible by at least one terminal via the network for obtaining return of the item and for transmitting coded information to the at least one terminal; a return location terminal coupled to the server via the network; and a coded information reader coupled to the return location terminal; wherein the server receives a selection to return an item from the at least one terminal; wherein the server receives information relating to the item to be returned; wherein the server determines return information for the item from the received information relating to the item to be returned; wherein the server assigns coded information relating to the item to be returned, the coded information being associated with the determined return information; wherein the server transmits the coded information to the at least one terminal via the network, the coded information to be provided with return of the item; wherein the coded information reader reads the provided coded information; and wherein the return location terminal accesses the determined return information.

To achieve the stated and other advantages of the present invention, as embodied and described below, the invention further includes a method for a returnee to return an item purchased from a first party via a second party, the method comprising: the first party receiving information relating to the item and producing return information; the first party transmitting coded information to the returnee; the second party receiving the coded information; and the second party accessing the produced return information to determine whether to accept return of the item.

To achieve the stated and other advantages of the present invention, as embodied and described below, the invention further includes a system for providing return of items via a network and via an item return location, the system comprising: means for receiving a selection to return an item; means for receiving information relating to the item to be returned; means for determining return information for the item from the received information relating to the item to be returned; means for assigning coded information relating to the item to be returned, the coded information being associated with the determined return information; means for transmitting the coded information via the network, the coded information to be provided with return of the item; at the item return location, means for reading the provided coded information; means for accessing the determined return information; and means for evaluating the item for return based on the determined return information.

Additional advantages and novel features of the invention set forth in part in the description that follows, considered in conjunction with the accompanying drawing figures, will become more apparent to those skilled in the art upon examination of the following or upon learning by practice of the invention. It is to be understood, however, that the drawings are designed solely for the purposes of illustration and not as a definition of the limits of the invention.

### BRIEF DESCRIPTION OF THE FIGURES

In the drawings:

FIG. 1 presents an overview of the system components of an embodiment of the present invention;

FIG. 2 is a list of routine names for various functions for a network-based system and method as shown in FIGS. 3-41, in accordance with an embodiment of the present invention;

FIG. 3 shows a flow diagram of the process of customer or other user item return initiation via a network, such as the Internet or World Wide Web, in accordance with an embodiment of the present invention;

FIG. 4 presents a flow diagram of a first variation of the return and exchange process initiated following the item return initiation via a network as shown in FIG. 3, in accordance with an embodiment of the present invention;

FIG. 5 is a flow diagram of a second variation of the return and exchange process initiated following the item return initiation via a network as shown in FIG. 3, in accordance with an embodiment of the present invention;

FIG. 6 shows a flow diagram of a third variation of the return and exchange process initiated following the item return initiation via a network as shown in FIG. 3, in accordance with an embodiment of the present invention;

FIG. 7 presents a flow diagram of an in store purchase process in accordance with an embodiment of the present invention;

FIG. 8 is a flow diagram of a network purchase routine, such as a purchase via the Internet, in accordance with an embodiment of the present invention;

FIG. 9 shows a flow diagram of a same day pickup routine in accordance with an embodiment of the present invention;

FIG. 10 is a flow diagram of a drop shipment routine in accordance with an embodiment of the present invention;

FIG. 11 presents a flow diagram of a guest shipment routine in accordance with an embodiment of the present invention;

FIG. 12 is a flow diagram of a license plate transfer routine in accordance with an embodiment of the present invention;

FIG. 13 shows a flow diagram of an e-tailer's hotline subroutine (AA) for use in conjunction with FIGS. 4, 5, and 6, in accordance with an embodiment of the present invention;

FIG. 14 presents a flow diagram of an in store purchase subroutine (AB) for use in conjunction with FIGS. 4, 5, 6, and 7 in accordance with an embodiment of the present invention;

FIG. 15 is a flow diagram of a tendering subroutine (AC) for use in conjunction with FIGS. 4, 8, 11, 14, 16, 18, 20, and 23, in accordance with an embodiment of the present invention;

FIG. 16 shows a flow diagram of a payment direction subroutine (AD) for use in conjunction with FIG. 14, in accordance with an embodiment of the present invention;

FIG. 17 presents a flow diagram of a store subroutine (AE) for use in conjunction with FIGS. 4, 5, 6, 11, 12, and 24, in accordance with an embodiment of the present invention;

FIG. 18 is a flow diagram of a check tender subroutine (AF) for use in conjunction with FIGS. 15 and 16, in accordance with an embodiment of the present invention;

FIG. 19 shows a flow diagram of a cash tender subroutine (AG) for use in conjunction with FIG. 15, in accordance with an embodiment of the present invention;

FIG. 20 presents a flow diagram of a credit tender subroutine (AH) for use in conjunction with FIG. 15, in accordance with an embodiment of the present invention;

FIG. 21 is a flow diagram of a shipping subroutine (Al) for use in conjunction with FIGS. 9, 10, 11, 28, 29, 30, and 31, in accordance with an embodiment of the present invention;

FIG. 22 shows a flow diagram of a bay audit subroutine (AK) for use in conjunction with FIG. 12, in accordance with an embodiment of the present invention;

FIG. 23 presents a flow diagram of a pending purchase subroutine (AL) for use in conjunction with FIG. 8, in accordance with an embodiment of the present invention;

FIG. 24 is a flow diagram of a receive shipment subroutine (AM) for use in conjunction with FIG. 9, in accordance with an embodiment of the present invention;

FIG. 25 shows a flow diagram of a batch picking process subroutine (AN) for use in conjunction with FIG. 21, in accordance with an embodiment of the present invention;

FIG. 26 presents a flow diagram of a disposition subroutine (AO) for use in conjunction with FIGS. 4, 5, and 30, in accordance with an embodiment of the present invention;

FIG. 27 is a flow diagram of a billing subroutine (AP) for use in conjunction with FIGS. 9, 10, 28, 29, and 31, in accordance with an embodiment of the present invention;

FIG. 28 shows a flow diagram of a manufacturer disposition subroutine (D1) for use in conjunction with FIG. 26, in accordance with an embodiment of the present invention;

FIG. 29 presents a flow diagram of an e-tailer disposition subroutine (D2) for use in conjunction with FIG. 26, in accordance with an embodiment of the present invention;

FIG. 30 is a flow diagram of a liquidation disposition subroutine (D3) for use in conjunction with FIG. 26, in accordance with an embodiment of the present invention;

FIG. 31 shows a flow diagram of a hold for reshipment subroutine (D4) for use in conjunction with FIG. 26, in accordance with an embodiment of the present invention;

-FIG. 32 presents an example main selection screen for a GUI for use in accordance with an embodiment of the present invention;

FIG. 33 is an example RF application menu for use with an embodiment of the present invention;

FIG. 34 shows an example web purchase form for use with an embodiment of the present invention;

FIG. 35 presents an example return form or ticket with representative bar code for use with an embodiment of the present invention;

FIG. 36 is an example shipment label for use with an embodiment of the present invention;

FIG. 37 shows an example of a receipt for use with an embodiment of the present invention;

FIG. 38 presents an example return checklist for use via a network, such as the Internet, in accordance with an embodiment of the present invention;

FIG. 39 is an example of store number and license plate formats for use in accordance with embodiments of the present invention;

FIG. 40 shows the first part of an example list of data inputs from a merchant for use in accordance with an embodiment of the present invention;

FIG. 41 presents the second part of an example list of data inputs from a merchant for use in accordance with an embodiment of the present invention;

FIG. 42 shows list of routine names for various functions and system components for a network-based system and method as shown in FIGS. 43-89, in accordance with a second embodiment of the present invention;

FIG. 43 is a flow diagram of a first portion of a return process initiated by a customer on a network, in accordance with a second embodiment of the present invention;

FIG. 44 shows a flow diagram of a second portion of a return process initiated by a customer on a network, in accordance with a second embodiment of the present invention;

FIG. 45 presents a flow diagram of a first portion of a return process at a store and via a network, in accordance with a second embodiment of the present invention;

FIG. 46 is a flow diagram of a second portion of a return process at a store and via a network, in accordance with a second embodiment of the present invention;

FIG. 47 shows a flow diagram of a third portion of a return process at a store and via a network, in accordance with a second embodiment of the present invention;

FIG. 48 presents a flow diagram of a fourth portion of a return process at a store and via a network, in accordance with a second embodiment of the present invention;

FIG. 49 is a flow diagram of an in store purchase routine for use in accordance with a second embodiment of the present invention;

FIG. 50 shows a flow diagram of a network purchase routine for use in accordance with a second embodiment of the present invention;

FIG. 51 presents a flow diagram of the first portion of a sameday pickup routine for use in accordance with a second embodiment of the present invention;

FIG. 52 is a flow diagram of the second portion of the sameday pickup subroutine of FIG. 51;

FIG. 53 shows a flow diagram of the first portion of a drop shipment routine for use in accordance with a second embodiment of the present invention;

FIG. 54 presents a flow diagram of the second portion of the drop shipment subroutine of FIG. 53;

FIG. 55 is a flow diagram of the first portion of a guest shipment routine for use in accordance with a second embodiment of the present invention;

FIG. 56 shows a flow diagram of the second portion of the guest shipment subroutine of FIG. 55;

FIG. 57 presents a flow diagram of an in store purchase subroutine for use in conjunction with FIGS. 47 and 49, in accordance with a second embodiment of the present invention;

FIG. 58 is a flow diagram of a tendering subroutine for use in conjunction with FIGS. 50, 55, 57, 59, 62, 63, and 64, in accordance with a second embodiment of the present invention;

FIG. 59 shows a flow diagram of a payment direction subroutine for use in conjunction with FIGS. 47 and 57, in accordance with a second embodiment of the present invention;

FIG. 60 presents a flow diagram of a storage subroutine for use in conjunction with FIGS. 48, 56, 65, 66, 67, 68, 71, and 76, in accordance with a second embodiment of the present invention;

FIG. 61 is a flow diagram of a cash tender subroutine for use in conjunction with FIG. 58, in accordance with a second embodiment of the present invention;

FIG. 62 shows a flow diagram of a credit tender subroutine for use in conjunction with FIG. 58, in accordance with a second embodiment of the present invention;

FIG. 63 presents a flow diagram of a check tender subroutine for use in conjunction with FIG. 58, in accordance with a second embodiment of the present invention;

FIG. 64 is a flow diagram of a create virtual account subroutine for use in conjunction with FIGS. 50, 56, and 59, in accordance with a second embodiment of the present invention;

FIG. 65 shows a flow diagram of the first portion of a shipping subroutine for use in conjunction with FIGS. 70, 71, and 72, in accordance with a second embodiment of the present invention;

FIG. 66 presents a flow diagram of the second portion of the shipping subroutine of FIG. 65;

FIG. 67 is a flow diagram of the third portion of the shipping subroutine of FIGs.65 and 66;

FIG. 68 shows a flow diagram of a receive shipment subroutine for use in conjunction with FIG. 51, in accordance with a second embodiment of the present invention;

FIG. 69 presents a flow diagram of a batch picking process subroutine for use in conjunction with FIG. 65, in accordance with a second embodiment of the present invention;

FIG. 70 is a flow diagram of a disposition direction subroutine for use in conjunction with FIGS. 48 and 72, in accordance with a second embodiment of the present invention;

FIG. 71 shows a flow diagram of a guest pickup subroutine for use in conjunction with FIGS. 52 and 54, in accordance with a second embodiment of the present invention;

FIG. 72 presents a flow diagram of a liquidation subroutine for use in conjunction with FIG. 70, in accordance with a second embodiment of the present invention;

FIG. 73 is a flow diagram of the first portion of a bay audit subroutine for use in conjunction with FIGS. 75 and 76, in accordance with a second embodiment of the present invention;

FIG. 74 shows a flow diagram of the second portion of the bay audit subroutine of FIG. 3;

FIG. 75 is a flow diagram of the first portion of a license plate transfer subroutine for use in accordance with a second embodiment of the present invention;

FIG. 76 shows a flow diagram of the second portion of the license plate transfer subroutine of FIG. 3;

FIG. 77 presents an example main selection screen for a GUI for use in accordance with a second embodiment of the present invention;

FIG. 78 is an example RF application menu for use with a second embodiment of the present invention;

FIG. 79 shows an example web purchase form for use with a second embodiment of the present invention;

FIG. 80 presents an example return form or ticket with representative bar code for use with a second embodiment of the present invention;

FIG. 81 is an example shipment label for use with a second embodiment of the present invention;

FIG. 82 shows an example of a receipt for use with a second embodiment of the present invention;

FIG. 83 presents an example return checklist for use via a network, such as the Internet, in accordance with a second embodiment of the present invention;

FIG. 84 is an example of store number and license plate formats for use in accordance with embodiments of the present invention;

FIG. 85 shows the first part of an example list of data inputs from a merchant for use in accordance with a second embodiment of the present invention;

FIG. 86 presents the second part of an example list of data inputs from a merchant for use in accordance with a second embodiment of the present invention;

FIG. 87 presents a pictogram of a system architecture in accordance with a second embodiment of the present invention;

FIG. 88 is a first version of dynamic rate-monotonic analysis (RMA) in accordance with a second embodiment of the present invention; and

FIG. 89 shows a second version of dynamic RMA in accordance with a second embodiment of the present invention.

### DETAILED DESCRIPTION

An embodiment of the present invention, referred to as “iRetums,” levels the Internet playing field by allowing online retailers their first opportunity to compete both in the servicing and pricing end of their business model, eliminating the cost, delay, and frustration customers experience when trying to return or exchange products. iReturns acts as a brick and mortar extension of the virtual etailer, with thousands of physical locations nationwide, offering accessibility to tens of millions of online shoppers who value in-person customer service, such as immediate credit card and cash refunds, product exchanges and replacements, and an actual human to address any issues that may arise. Additionally, iReturns offers many unique localized services to e-tailers, which are designed to enhance revenues while dramatically increasing customer loyalty, brand awareness, and market share. Most importantly, iReturns is an unrelated business that is able to offer these local services without exposing its e-tailing partners to sales tax requirements.

Through a method and system that includes an aggressive and unique advertising and marketing strategy, iReturns provides a premium brand with exceptional market penetration and name recognition with which consumers quickly identify and expect to be part of their online shopping experience. In this increasingly competitive marketplace, the single most important product online retailers offer is customer service. Until now, it has simply been impossible to provide the same level of individual attention as traditional retailers. iReturns changes everything by offering virtual retailers the ability to compete in ways they could never have imagined possible.

As part of the efficiency model of Internet retailers, most aspects of online shopping take place on the computer. When customers have questions about an item before or after it has been purchased, the only recourse often available to them is emailing the merchant and waiting, sometimes days, for a response. This has naturally led to a great deal of frustration when trying to adjust an order, especially if the customer needs the item for a special occasion, such as a birthday or anniversary.

In an embodiment of the present invention, when wishing to return or exchange a product purchased online from an iReturns e-tailing partner, customers are able to visit any iReturns location throughout the country, seven days a week, for prompt courteous and personalized attention. Additionally, shoppers are able to reach the iReturns call center 24 hours a day for information about the nearest iReturns location, a list of iReturns e-tailing partners, and to discuss any pre-sale or post-sale concerns they have about a particular purchase. As an extension of the online merchant itself, iReturns creates invaluable goodwill, enhancing the possibility the consumer will return and buy again.

For customers shopping on the Internet, the shipping cost of online merchandise adds significantly to the bottom line price. As a way of attracting new business, some e-tailers are including free or discounted shipping as an incentive to visit their site, but it is often limited in scope and duration. While the majority of online consumers typically consider shipping to be an offset of sale tax charges not required on most Internet purchases, research shows they also consider the hidden cost of post-sale adjustments in making their purchase decisions.

Chief among these is the expense of returning an unwanted item to the merchant, almost always borne by an unhappy customer. To ensure the safe handling of returned items, customers are also obligated to purchase insurance coverage as well as a more expensive level of service that offers delivery tracking. In many cases, depending on the size, weight and price of the product, the total non-refundable shipping cost paid by the customer to receive and return an item could add an additional 20 to 30 percent to the purchase price. And if a product is lost in transit, the consumer must wait for the refund until the loss claim is processed. This added expense and risk of return shipping represent a major concern for potential customers when comparing virtual retailers with their brick and mortar counterparts.

An embodiment of the present invention addresses this problem by having up to thousands of physical locations nationwide, offering accessibility to tens of millions of online shoppers who can bring their merchandise into a store for return or exchange without the expense of return shipping. As a result of this savings, when compared to other online merchants, there is a perceived extra value when shopping with iReturns e-tailers.

Aside from the extra cost of sending back merchandise, the inconvenience of standing in line at the post office or waiting for a delivery pickup makes many potential shoppers think twice about buying on the Web. For most consumers, these are not even options because of the tremendous demands on their time. For others, their frustration is heightened by the fact that most shipping facilities are unavailable evenings and weekends when they have the time to attend to personal matters. This leads to significant delays in handling customer concerns after the online sale, and is another reason why many unsatisfied shoppers do not return to a website for future purchases.

The present invention addresses this problem by having thousands of physical locations nationwide, offering accessibility to tens of millions of online buyers who can bring their merchandise into a store for return or exchange every day and evening, including weekends. Now, Internet shoppers have the convenience of handling their purchase adjustments when it is convenient for them, rather than being forced to make difficult alterations to their busy schedules.

With so many Internet purchases handled by credit cards today, there is an understandable concern on the part of every Web shopper regarding the way their billing is handled. Aside from security issues relating to credit card fraud, surveys conclude the next most important billing concern of online shoppers is the manner in which credits are issued to their charge cards.

The present invention addresses this problem by having thousands of physical locations nationwide, offering accessibility to tens of millions of online shoppers who can bring their merchandise into a store for immediate credit on their charge card, avoiding weeks of delays while building invaluable customer satisfaction. Customers who obtain full instant credit on their charge cards are more likely to repurchase other items from the same Internet retailer, creating new sales possibilities with each return.

Without the present invention, to make an exchange, customers are required to send the unwanted product back at their expense and inconvenience, while waiting until the merchant receives it before a replacement item is shipped. If the consumer is in a hurry to obtain the new merchandise, the only practical solution has been for the e-tailer to process a new order, incurring additional credit card charges until the old product is finally credited, long after receipt.

The present invention addresses this problem by having thousands of physical locations nationwide, offering accessibility to tens of millions of online shoppers who can bring their merchandise into a store for immediate exchange or store credit, avoiding weeks of delays, extra shipping costs and credit card charges. Once an item is brought into an iReturns location, it is as if it has arrived at the merchant's door, and a replacement order can be immediately processed without delay or extra charges. With iReturns, a customer can shop with confidence, knowing that an exchange can be accommodated the same day, instead of weeks later.

By solving these Internet shopping concerns, iReturns elevates the e-tailer's image and reputation, because the comfort level of knowing that iReturns services are available immeasurably enhances the customer experience each and every time shoppers buy online.

One purpose of iReturns is to assist e-tailers in providing their online buyers with a positive shopping experience, especially when it is necessary for them to return or exchange unwanted products to the merchant. The iReturns process is designated to assure the e-tailing customer a smooth and efficient transaction, in contrast to the complicated experience many virtual merchants offer.

As with most Internet related activities, returning or exchanging merchandise with the present invention begins with a click of the mouse. When online shoppers wish to return or exchange products purchased from an iReturn etailing partner, they may come to iReturns.com and click on the merchant's logo, or they can log directly on to the vendor's website. The customer then clicks the “Returns & Exchanges” button located on the e-tailer's home page, and is presented with a brief form to input specific order information that allows the merchant to recognize the transaction.

After providing the reason for the return and the price to be refunded-or the replacement item in the case of exchange-the customer clicks on the “Submit” button, which proceeds to the iReturns website authorization page, containing all of the customer's information, the e-tailer's return requirements, an authorization number bar code-all transferred to iReturns at the time of submission-and the location of the nearest extension store, in order to complete the return. Once this information is processed, iReturn is immediately prepared to receive the returned merchandise.

The customer then takes the product, along with the printed return authorization, to a brick and mortar extension store, where a courteous employee, after checking to ensure that the e-tailer' s requirements are met, enters the authorization number from the printout and issues a credit to the customer's charge card. The transaction is then transmitted to the e-tailer for its records, and in the case of an exchange, a replacement item is immediately shipped to the customer. The end result is a happy customer who will return to the e-tailer and buy time and time again.

Returned merchandise is always a problem for online virtual retailers, because it inevitably causes substantial losses. Since most online vendors ship only brand-new unopened items, once a customer opens the package and decides to return it, even if it unused, the merchant can no longer offer it at the regular price and must find a way to resell it. Additionally, since most e-tailers do not have sufficient facilities for returned items, they need a quick solution for these products as they are sent back.

Depending on the relationship retailers have with their suppliers, they might be able to replace opened-boxed items for new ones that they can put back into inventory. Often, however, this replacement option is not available to online vendors, or it comes with additional costs and fees.

In many cases, online retailers buy new closeouts, discontinued, or seasonal merchandise that they clearly understand to be non-replaceable, requiring e-tailers to liquidate all returned or damaged products for cents on the dollar. Lastly, defective items that are returned must be shipped back at the merchant's expense to the supplier for replacement or adjustment.

When e-tailers accept returned merchandise directly, they must dedicate costly resources to: 1) receive the item; 2) determine its disposition; 3) prepare it for reshipment and forward it to the stocking warehouse, supplier or liquidator; and 4) process the credit adjustment; all of which cost the merchant money and distract it from its main focus of generating revenues.

The present invention eliminates all of these steps, by offering several methods of disposing the merchandise it receives from online shoppers, each custom designed to an e-tailer's needs based upon the item returned, its condition and its ability to be resold. By outsourcing the entire returns process to iReturns, etailers reduce the loss-potential of every reversed sale while keeping its focus on generating more revenue.

Unopened merchandise that is resalable can be forwarded from any iReturns location directly to the e-tailer's shipping warehouse for immediate restocking, eliminating the expense and delay of having to evaluate and reroute products from one warehouse to another.

There may be an occasion when someone brings back an unopened item to iReturns for which a merchant has a pending order. In such a case, iReturns is able to facilitate the shipment of the merchandise directly to the new customer, under the retailer's name, bypassing the need to send it back to the stocking warehouse for reprocessing and reshipping to the new customer.

Defective returns can be shipped from any iReturns location directly to a retailer's supplier if arrangements have been made for product replacement, doing away with excess delay and shipping costs incurred when merchants received these items at their returns facility, only to reship them back to the supplier for adjustment. Depending on the e-tailer's needs, returned products can be sent out at whatever interval suits their needs, and at whatever level of delivery service fits their budget. iReturns also offers an option for the disposal of returned merchandise that cannot be resold as new or replaced by the manufacturer. Through, for examplei affiliate arrangements with several of the largest retail consumer and business online auction and liquidation websites, the present invention obtains the highest return on the dollar for the e-tailer by dynamically matching each returned product to a reseller specializing in selling such items to retail buyers, without ever mentioning the source of the return. In most cases, products that are returned at iReturns are able to be resold at near-retail prices within hours of receipt, thereby minimizing or eliminating any loss to the e-tailer.

As an added benefit for the virtual retailer, iReturns is able to warehouse and ship returned goods directly to customers as the items are sold, saving additional costs to retailers and giving them the ability to maximize their return on investment on every sale made.

One important part of the iReturn brand is the iReturns.com website, which features an entire shopping mall of the Internet's most customer service oriented online merchants. iReturns e-tailing partners enjoy the invaluable benefits of having their websites exclusively listed online for single-click access by millions of online shoppers demanding the value of iReturn services.

Each iReturns extension store contains several interactive computer kiosks designated to facilitate returns as well as generate new sales. In an embodiment of the present invention, these computers are locked on to the iReturns.com website, and will only navigate to and from iReturns e-tailing partner for maximum effectiveness.

While it is expected that most iReturns transactions will begin at the shopper's own computer, iReturns locations can process walk-in returns and exchanges by allowing customers access to in-store kiosks to help adjust their orders.

As iReturns stores are located in high-traffic malls around the country, they also serve as order centers for those people who are just walking by and drop in, or for others who do not have access to the Internet. In this way, iReturns merchants are able to reach retail mall traffic throughout the country otherwise unavailable to them.

Many computer users as well as non-computer users are unable to shop online because they will not or cannot use credit cards, and they would prefer to pay by check or cash. The most pervasive fear shared among online shoppers today is credit card security. While the industry has made great strides in convincing Internet users that using credit cards online is no less secure than at the local mall or restaurant, recent news about hackers gaining access to millions of credit card accounts has only fueled the paranoia many feel when parting with their credit card number. Others do not have charge cards available for use, or are at their maximum credit limit, but would still like to shop online using a check or cash.

Online businesses recognize the enormous profit potential of this growing segment of retail shoppers, but most are not prepared to accept check payments sent through the mail. Those buyers who find websites willing to accept cash orders are faced with substantial delays while their check is received and clears the bank before their merchandise is shipped.

With thousands of iReturns locations nationwide, in accordance with the present invention, shoppers are able to order from iReturn e-tailing partners online while paying locally by check or cash for immediate order processing. This convenience opens the Internet e-commerce market to tens of millions of consumers who are otherwise not serviced by e-tailers concentrating entirely on credit card orders.

This service is yet another way iReturns helps e-tailers generate new revenues. When a merchant processes an online order and informs the customer that the credit card is declined, it can still close the sale by offering to accept cash or check at any iReturns location. Once the payment is made, the item is shipped immediately, saving the weeks of delay an e-tailer would require to otherwise process the order.

For many Internet shoppers who are working, moving, out-of-town, in school or otherwise on the go, and in cases when e-tailers ship backordered items without first notifying the buyer, it is difficult to make arrangement to accept deliveries, especially since most merchants and shippers require personal signatures on all orders to reduce fraud and lost shipments.

If the customer is not home, the merchandise is then returned to the e-tailer, who must package and ship the order all over again, incurring extra cost to the merchant and customer alike. In the event that the shopper decides not to accept the reshipment, or cannot be located, the charge is inevitability reversed, causing an e-tailer substantial loss due to delivery logistics that could have been avoided by using iReturns.

To avoid these problems, iReturns e-tailing partners are able to offer dropship options that allow their customers to pick up their Internet purchases from any iReturns location nationwide. And with extended night and weekend hours, iReturns provides extra time to pick up orders at no additional charge.

For most e-tailers, especially around the holiday season, timing is paramount to making the sale. When an iReturns e-business is promoting a new or seasonal time that is certain to be popular, it can gain a tremendous edge over the competition by having iReturns stock the product in each store for the same-day pickup. iReturn also offers warehousing facilities in all of its nationwide locations for immediate pickup and delivery throughout the year for e-tailers who want to provide same-day service The goal of every Internet retailer is to avoid having customers so dissatisfied with their purchases that they want to return them. Many times, this happens because of a genuine misunderstanding between what online shoppers thought they were ordering and what they actually received. In some cases, their computer screens could not accurately reflect the proper color, size, or texture of an item. Other times, only one sample of an item's group is illustrated, leaving the rest to the shopper's imagination. iReturns can help online retailers reach this goal of customer satisfaction by being a local resource available to its e-tailing partners when buyers have questions about the appearance of a product. Online clothing retailers, for example, are able to have a swatch book located in each iReturns store, giving their customers the chance to get an exact idea of how their product will look and feel. Upscale merchants who sell expensive items can offer to ship a sample product to an iRetums location for inspection without the risk of losing the sale or sending that item to an uncertain shopper. In fact, any e-tailer offering merchandise that relies substantially on subjective interpretation can benefit from iReturns.

Thus, in contrast with prior art attempts to service catalog ordered goods, embodiments of the present invention do not include authorizing returns on behalf of the merchant or taking complaints from the consumer and dealing with these consumers on a practical level without the merchant's permission. Instead, the present invention includes a method and system for using agents directly for the represented merchants.

For example, if a consumer has a problem with a product they buy, in an embodiment of the present invention, that consumer is able to access, for example, via the Internet to a website or catalogue site for a merchant, and select “return” and “exchange” buttons located on their site. In an embodiment of the present invention, software interfaces between these merchant sites and the extension store server or servers. This interface software allows a form to be provided via the merchant site that helps the consumer identify to the merchant such information as who the person is that bought the product, what the product was, and what the problem is. In one embodiment of the present invention, the merchant then compares information on the product internally to ensure that the consumer information matches the merchant's information (e.g., this product at this price). In addition to or part of this process, in one embodiment, a series of questions are directed at the consumer that help guide the process.

The interactive process with the consumer provides several pieces of information. One piece of information provided is assistance with identifying the following: 1) whether the product is brand new and unopened; 2) whether the product is brand new and opened; and 3) whether the product is opened and defective. The vast majority of returns are opened and resellable, but not in a “brand new” condition. This lack of “brand new” condition presents a problem because, once a product is opened, it is in many cases illegal and in most cases impractical to resell that product “as is.” As a result, the merchant (or the supplier) must liquidate the product. As will be described further, one aspect of the present invention provides assistance with resolving this problem.

Thus, at this point in the process, a few questions have been asked of the consumer, and some of the consumer information is usable to gauge what the next step should be in the process. For example, in the case of a camcorder, the software of the present invention requests that the consumer proactively select options indicating whether the consumer has possession of all of the included items before the return is authorized. One embodiment of the present invention provides only a virtual process for this inquiry stage, and there is thus no way for the merchant to determine absolutely whether the consumer is providing truthful information about the state of the item. However, another part of the process requires that the consumer bring a “ticket” generated through this process into one of the extension stores. This ticket, in one embodiment of the present invention, is or includes a slip of paper that contains, among other things, a coded identifier, such as a bar code, associated with the product for the life of the product. In general, this “ticket” provides summary information or allows access to information regarding the results of the questions and answers, so that when the consumer appears at the extension store, the item is able to be matched to the description the consumer provided (e.g., the camcorder is missing a battery).

One advantage of this process is that it avoids and minimizes confrontation since the consumer is providing a slip of paper that indicates what portions of the item are being returned, and the consumer has little choice but to supply these items in order to complete the return. The questions and answers thus further serve as an outline or warning to the customer indicating that, before the refund can be issued, all these items provided must be complete. The consumer, having proactively confirmed possession of all of the components of the item, has the burden to provide all of these components at the time of the return.

The question and answer feature also allows the system to provide dynamic information based on zip code. In one embodiment, it provides the five closest locations to the customer. It also provides the capability to distribute cooperative marketing couponing which is usable, for example, to drive revenue for the extension stores. For example, if a retailer wants to sell another product to the customer, a coupon for a reduced price for that item may be provided via the extension stores.

The “ticket” printed by the consumer, which has as its most important component a coded identifier, such as a bar code, is returnable at any extension store location. The extension stores are provided with background information on the consumer that is based on the bar code. This information includes a blueprint for how to handle the customer's problem when the bar code is presented. Thus, for example, when the customer walks into an extension store with a camcorder and the bar code for the item, the store scans the bar code, and the extension store's computer system automatically indicates to the extension store's staff the appropriate action, depending upon the information provided and analyzed. If the product is defective, for example, and is to be returned to the manufacturer, in the absence of the present invention, the product would go back to the merchant, since the customer could not directly interface with the manufacturer. The merchant would then have to repack the item as defective and return it to the manufacturer. This approach adds an enormous cost for the merchant because the item must be handled by so many different parties. In a nutshell, the present invention provides fulfillment on behalf of the merchant.

If the product is brand new and unopened (e.g., in shrink wrap and ready to go), the extension store can either send the product back to the fulfilling warehouse or the merchant, or in many cases, depending on how popular the item is or the state of merchant shipping facility, the extension store can hold the item in inventory and ship it to another consumer on behalf of the merchant. For example, camcorders, can sell at a rate of thousands per week. For items like this, instead of the merchant instructing the extension store to ship the item back, when the merchant will just turn around and ship it to someone at another location, this shipping information is immediately transmitted to the extension store. In operation in accordance with an embodiment of the present invention, when the customer with a return enters an extension store with an unopened item, a label is generated, and the item is shipped to a new customer.

The last group of returned items, which is typically the largest group, includes brand new products that are opened. Absent the present invention, these items are normally liquidated for about $0.17 on the dollar. With the present invention, these items are posted on an associated network site, such as an Internet website, which in one embodiment is referred to as “iReturnsforsale.” As with other items addressed by the present invention, within minutes of such an item being returned to an extension store, the item is placed within a “reverse auction,” also referred to a “Falling Price” auction, in which the item begins by being priced at, for example, 80% or 90% of the full price of a new product. On subsequent days the price is reduced until the item is sold. As a result, the merchant ends up receiving significantly higher margins on their return goods than with the prior art and also saves the time and energy that would otherwise be spent liquidating the item. The present invention meets typical merchant goals of minimizing their loss and maximizing supply chain efficiency.

In operation in accordance with an embodiment of the present invention, these types of opened returned items are stored at warehousing facilities associated with the extension stores. The items are then placed on the associated reverse auction web site as an “opened product brand new,” with a reduced initial price. The price is then periodically reduced in accordance with the merchant's instructions until the item is sold. In an embodiment of the present invention, the merchant has complete control over the process-the merchant is able to set the starting price, ending price, and the maximum time to sell. Thus, for example, if the merchant wants to liquidate the item in 10 days, the price of the item must fall an average of 10% per day. When an offer is made, the item is shipped from the warehousing facilities directly to the buyer on behalf of the merchant. In an embodiment of the present invention, the extension stores collect a fee from the proceeds paid for the item, and the remainder of the revenues generated are sent to the merchant. The present invention thus includes a complete supply chain and reverse logistics cycle that, when utilized in its ideal form, greatly reduces the present inefficiency resulting from returned products.

The present invention also includes other associated advantages. For example, one problem that merchants face, besides the inability to connect to consumers, is inability to handle nontraditional payment methods, such as payment by customers that do not want to use a credit card, that have no credit card, or that have no credit remaining on a card. Another problem faced by merchants is an enormous amount of losses associated with mis-deliveries of items because, for example, both husband and wife are working, and the delivery company, for liability reasons or otherwise, refuses to leave the item without a signature. Adding to this problem is that many merchants, especially e-tailers, have only virtual inventories, such that they effectively take orders and process them through their distributors or suppliers on demand, with the result that the product is often not immediately available. Consequently, no firm delivery date may be set, increasing the likelihood of missed delivery. In the event of missed delivery, additional shipping costs can result for the merchant, with the item returned to the merchant without delivery.

To address these problems, embodiments of the present invention offer the service of a drop shipment concept, providing essentially that anytime a product can not be delivered, the product is sent to the local extension store and becomes available for later pickup by the customer. Pickup can occur either proactively, if, for example, the customer knows that they will not be available to personally receive shipment, or on a standby basis in the event of non-delivery. In an embodiment of the present invention, this feature is provided by the extension stores via a single rate charge, and is obtained using agreements with delivery services.

The present invention includes a number of variable features relating to the extension stores. For example, in one embodiment, the extension stores include mall kiosks. By using the coded tickets for returns and other information gathering techniques, the extension stores are able to provide participating merchants with information relating to the customers. In one embodiment, the merchants are able to access tracking database information relating to customer returns. For example, if a customer orders an item on-line via an online merchant, the customer can then approach an extension store (e.g., mall kiosk) and pay for the item. With an embodiment of the present invention, information is immediately transmitted to the online merchant indicating payment has been made and the item may be shipped.

Another aspect of the present invention is improvement with exchanges and the speed at which exchanges are accomplished. For example, absent the present invention, obtaining an exchange quickly often requires that the customer pay for a second item as the exchange and await a refund on the first item. In accordance with embodiments of the present invention, credit for the properly returned item is made immediately upon delivery of the item to the extension store, allowing replacement with an exchange item immediately. In operation, in an embodiment of the present invention, at the merchant network site or at the “iReturns” site, the customer is able to select a button, for example, for exchange, and proceed through the method similarly to any other return. The customer then prints out a coded ticket for the return and brings the item and the ticket to any extension store for immediate exchange. No additional credit on behalf of the customer is required.

In an embodiment of the present invention, if the customer is not able to access or print the bar code information, the customer can obtain this information at the extension store.

The components of the present invention include the following. One or more servers on a network, such as the Internet, which are utilized by the extension stores for providing a web site for accessing for returns and for providing reverse auctions, portals to other sites, and other features associated with the present invention. The server or servers include repositories for data, such as databases, or are otherwise able to access such repositories (e.g., databases on other servers accessible by the extension stores' server or servers). Other components coupled to or coupleable to these servers, including coupling via the network, are interface modules (e.g., computers or other terminals) at the merchant sites or elsewhere that allow the merchants to access information and perform other functions with regard to data and other activities operating via the server or servers. Another component is software, including, but not limited to interface software interacting with merchant network site software. This interface software provides such functions as allowing a customer accessing the merchant site software to perform operations, such as completing return forms, via software located at the one or more servers operated by the extension stores. This interface software also allows such finctions as “pushing” data for the customer, following, for example, any approvals or checks performed by the merchant, to the extension stores' server or servers.

References will now be made in detail to embodiments of the present invention, examples of which are illustrated in the accompanying drawings.

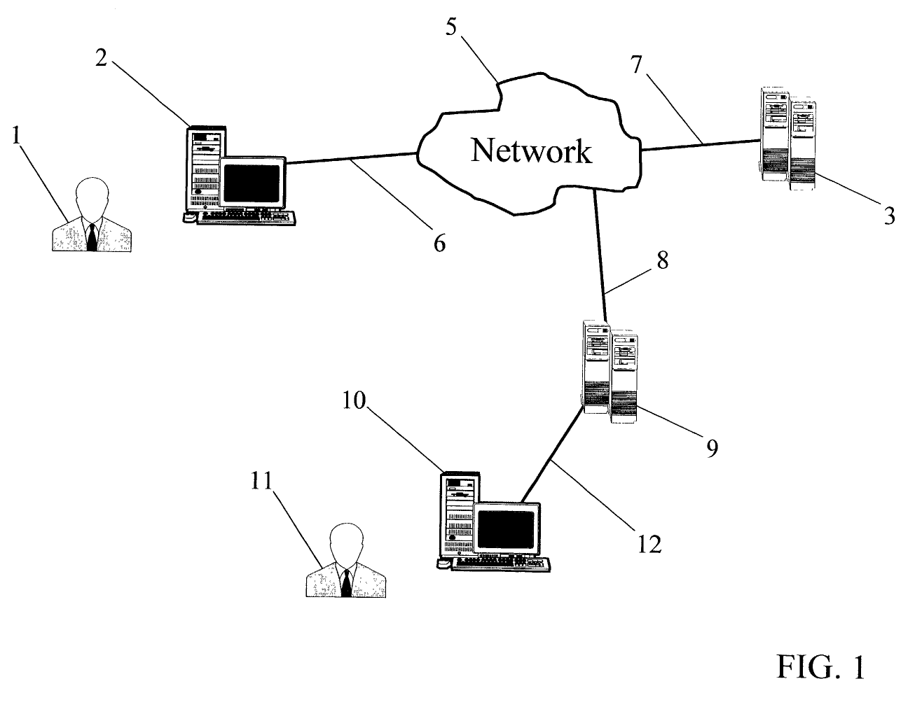

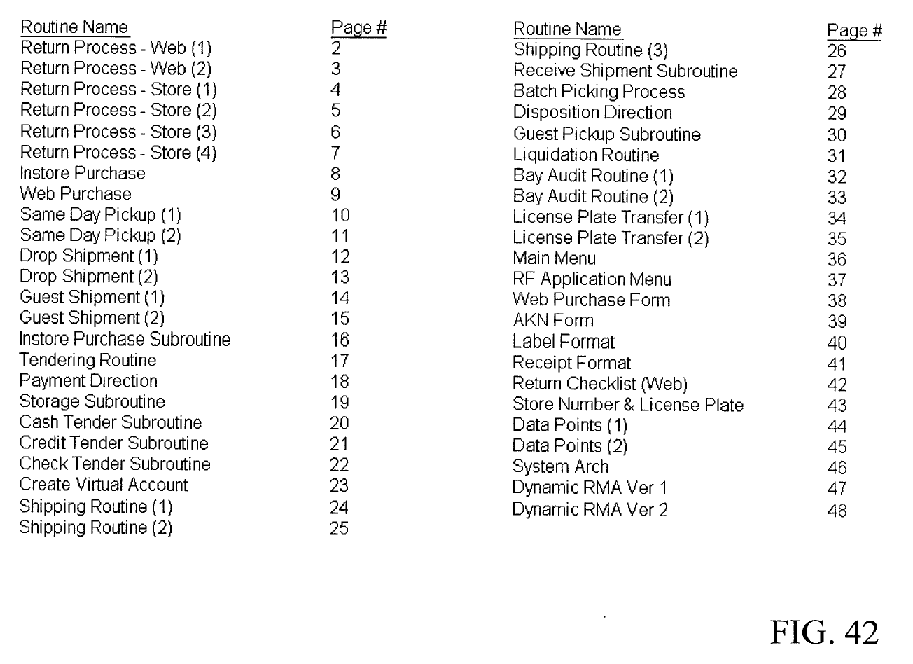

FIGS. 1-41 present system and flow diagrams in accordance with a first embodiment of the present invention, and FIGS. 42-89 present system and flow diagrams in accordance with a second embodiment of the present invention.

FIG. 1 presents an overview of the system components of an embodiment of the present invention. As shown in FIG. 1, in an embodiment of the present invention, a returnee or other user 1, such as a customer, accesses a server 3 via a terminal 2, such as a personal computer (PC), minicomputer, microcomputer, mainframe computer, telephonic device, handheld device, or other device having a processor and capability for transmitting information, and optionally having an attached printer, via a network 5, such as the Internet, and via couplings 6, 7. The server 3 comprises a minicomputer, mainframe computer, microcomputer, PC, or other device having a processor and, optionally, a repository, such as a database and storage capacity, or access to a repository. This server 3 supports, for example, merchants or others to which the returnee or other user 1 is attempting to return an item. The couplings 6, 7 include wired, wireless, fiberoptic, or other links for transmitting data.

In an embodiment of the present invention, also coupled 8 to the network 5 is a second server 9 housing software to support extension stores and other functionality. For example, in one embodiment, software at the second server 9 includes a questionnaire and other return support information that is accessed by the returnee or other user 1 via software link between the second server 9 and the first server 3.

In addition, in an embodiment of the present invention, one or more terminals 10 are coupled 12 to the server 9 for access by users 14 at remote locations, such as at extension stores. Optionally, included with the one or more terminals 10 are coded information readers, such as bar code readers for reading bar code materials printed out by the returnee or other user 1 upon completing network item return functions. In an embodiment of the present invention, the printed bar code materials are provided with the returned item at an extension store, and by reading the printed bar code, the extension store employee, via the server 9, is able to retrieve and confirm information relating to the returned item.

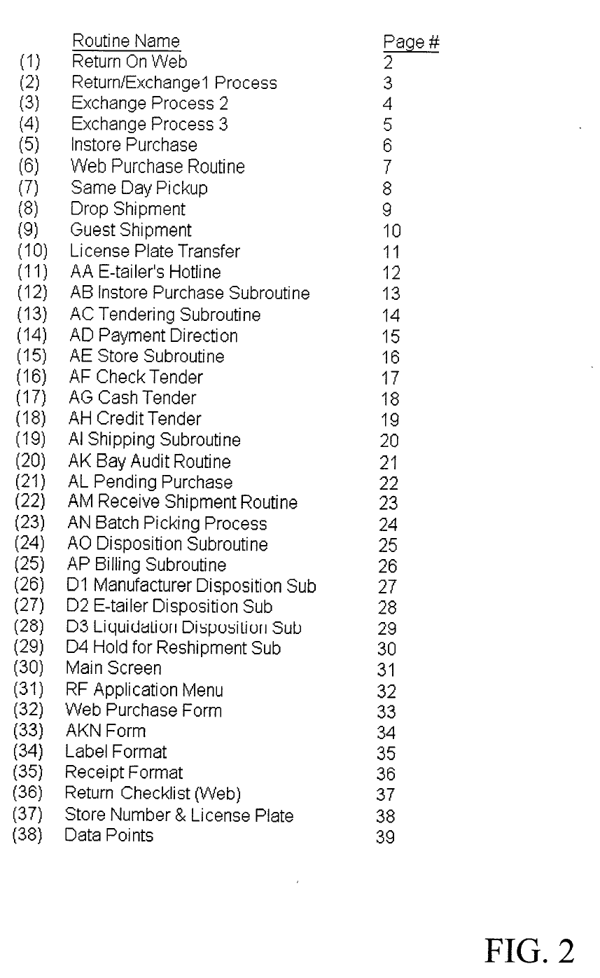

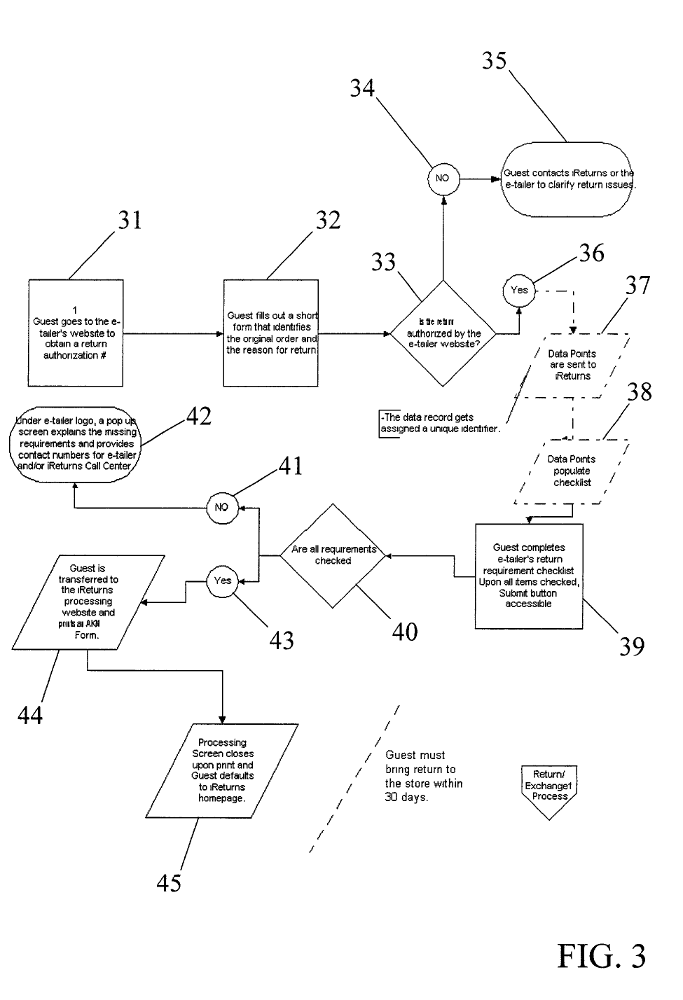

FIG. 2 is a list of routine names for various functions for a network-based system and method as shown in FIGS. 3-41, in accordance with an embodiment of the present invention.

FIG. 3 shows a flow diagram of the process of customer or other user item return initiation via a network, such as the Internet or World Wide Web, in accordance with an embodiment of the present invention. As shown in FIG. 3, a guest or other returnee of an item goes to the merchant's network site to obtain a return authorization number 31. The gues fills out a short form that identifies the original order and the reason for the return 32. A determination is made as to whether the return is authorized 33. If no 34, the guest contacts an extension store or network site (iReturns server), or contacts the merchant to clarify return issues 35. If yes 36, the data points are sent to the iReturns server 37, and the datapoints pupulate a checklist 38. The guest completes the merchant return requirement checklist, and upon all items being checked, the submit button becomes accessible 39.

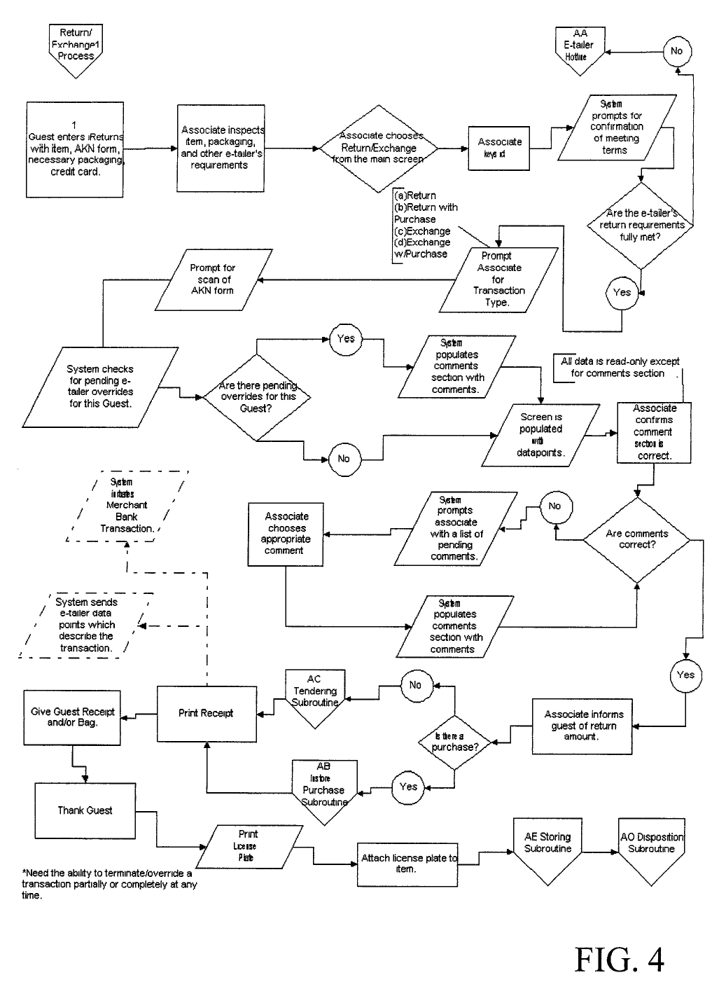

A determination is then made as to whether all requirements are checked 40. If no 41, a pop up screen explains the missing requirements and provides contact numbers for the merchant and/or an iReturns server call center 42. If yes, the guest is transferred to a processing network site and prints an AKN form 44. The processing screen closes upon print, and the guest defaults to the iReturns server homepage 45. The guest is then able to return an item to an extension store within, for example, 30 days, as shown in FIGS. 4,5, and 6.

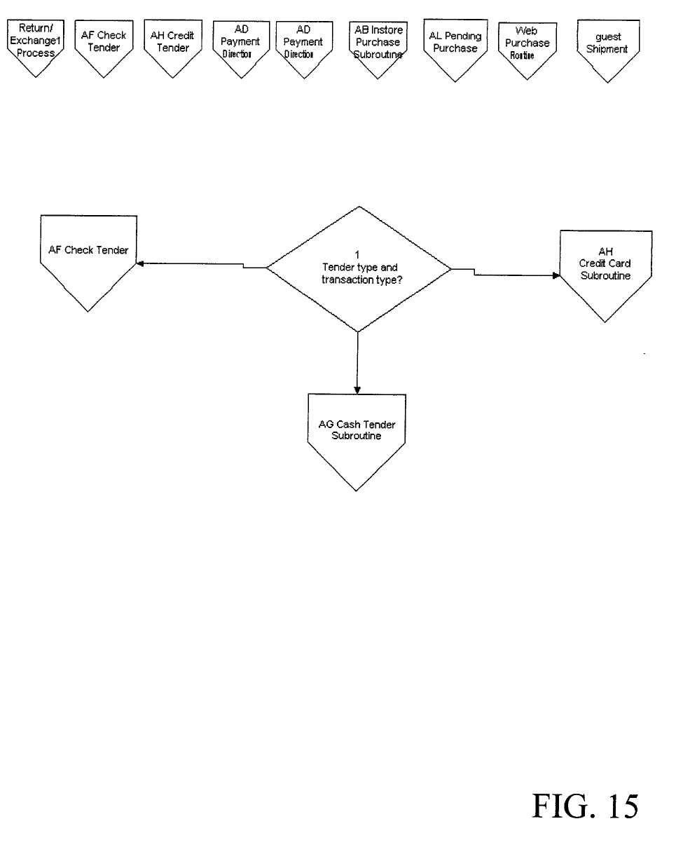

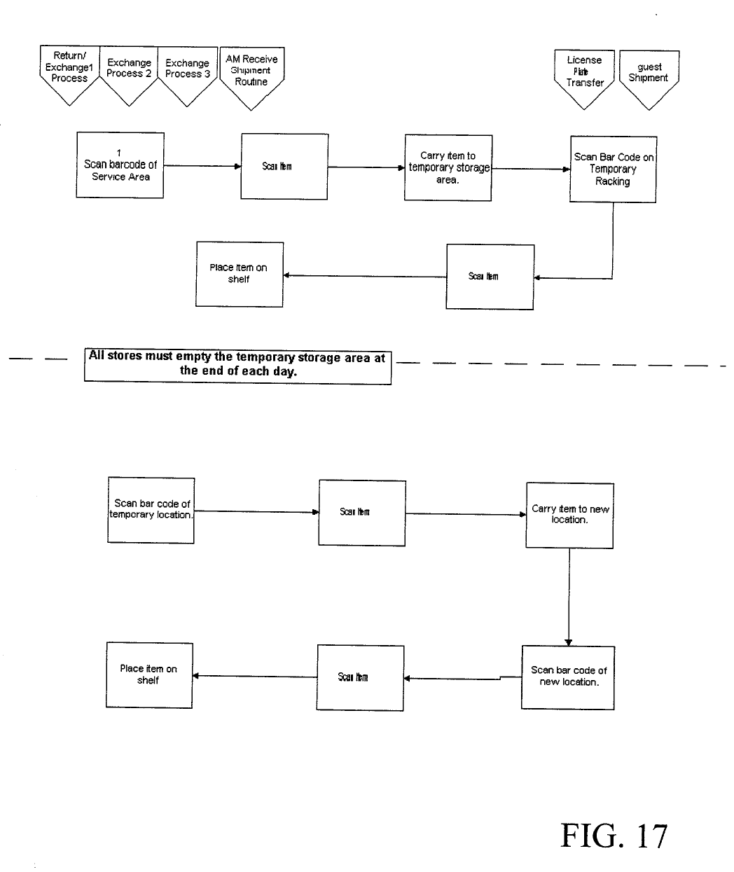

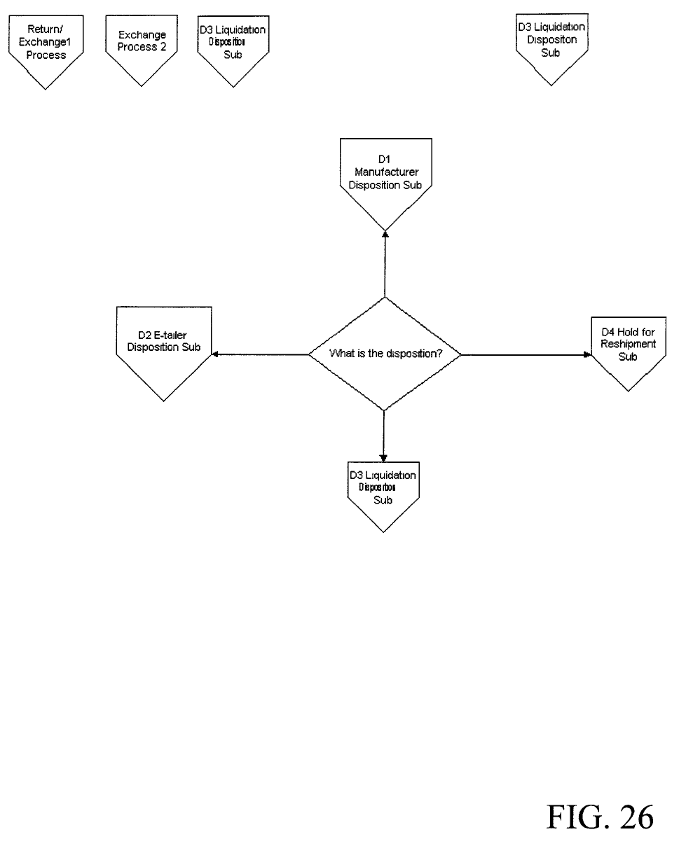

FIG. 4 presents a flow diagram of a first variation of the return and exchange process initiated following the item return initiation via a network as shown in FIG. 3, in accordance with an embodiment of the present invention. In the process shown in FIG. 4, no transaction occurs, other than the return. A receipt is generated via the tendering process of FIG. 15, the returned item is stored via the store routine of FIG. 17, and the disposition of the product is determined via the disposition subroutine of FIG. 26.

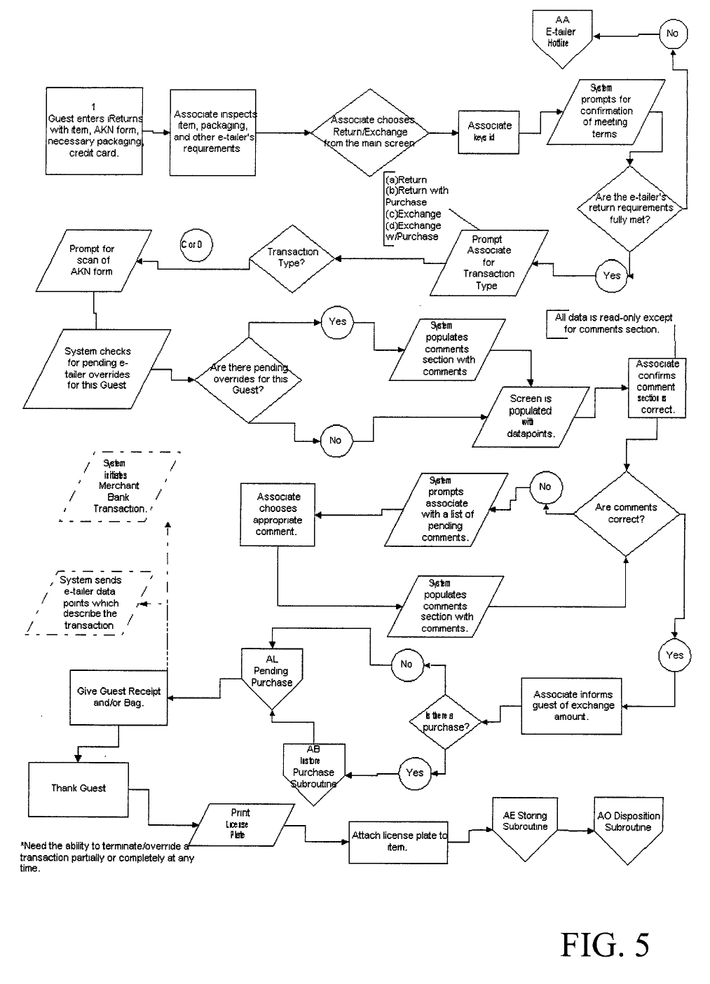

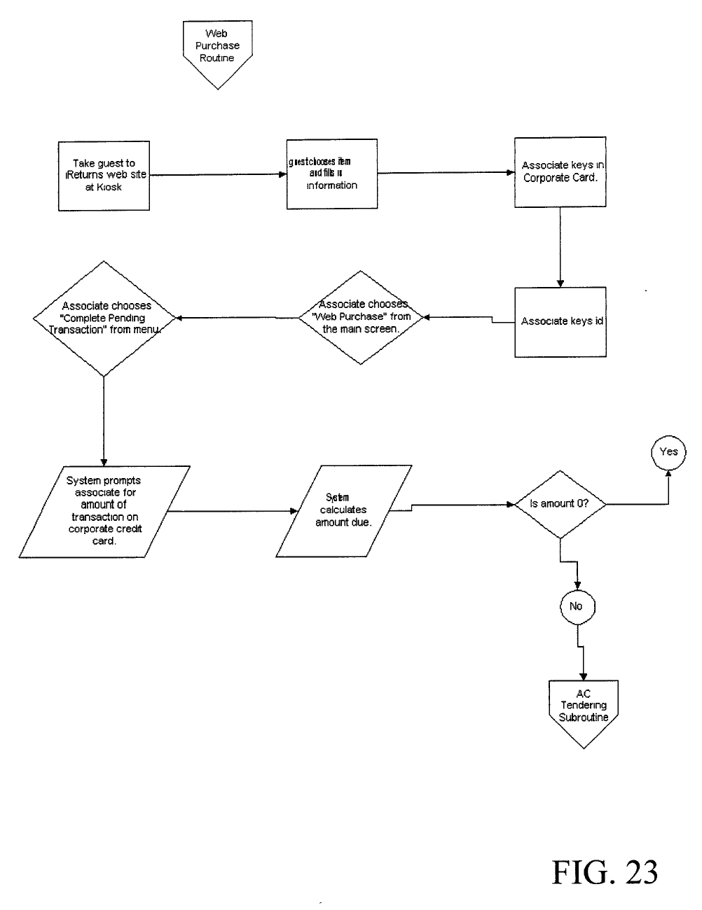

FIG. 5 is a flow diagram of a second variation of the return and exchange process initiated following the item return initiation via a network as shown in FIG. 3, in accordance with an embodiment of the present invention. In the process shown in FIG. 5, a transaction occurs, such as a purchase using cash or debit (c or d) besides the return. The pending purchase routine of FIG. 23 can occur with this process, the returned item is stored via the store routine of FIG. 17, and the disposition of the product is determined via the disposition subroutine of FIG. 26.

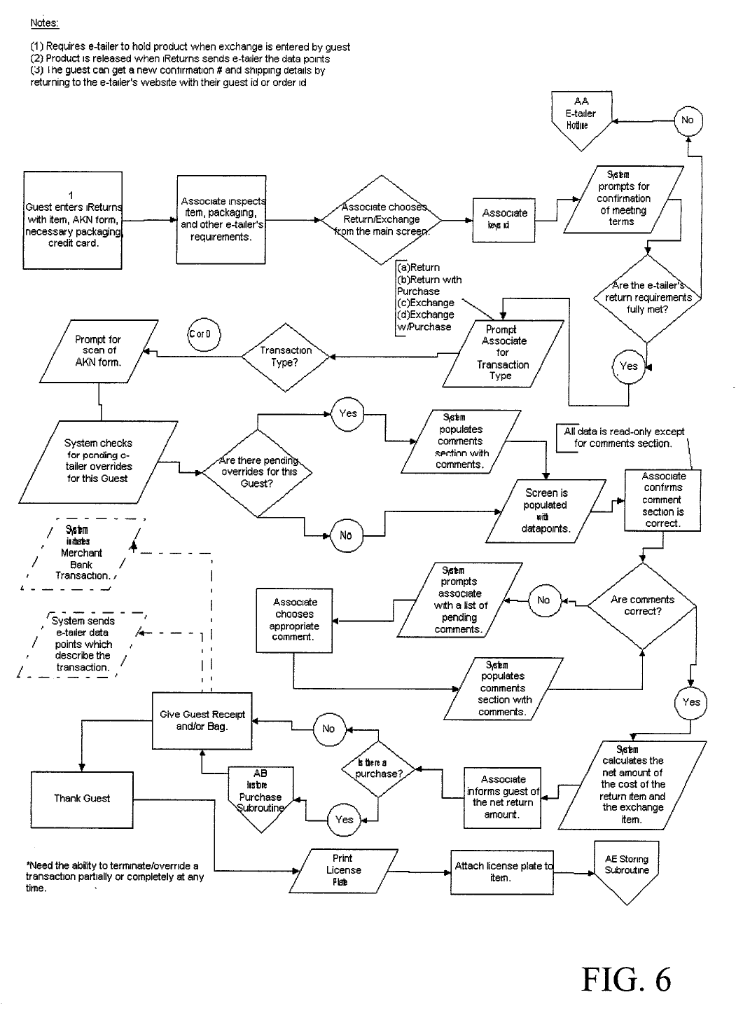

FIG. 6 shows a flow diagram of a third variation of the return and exchange process initiated following the item return initiation via a network as shown in FIG. 3, in accordance with an embodiment of the present invention. In the process shown in FIG. 5, a transaction occurs, such as a purchase using cash or debit (c or d) besides the return. No pending purchase routine occurs with this process, the returned item is stored via the store routine of FIG. 17, and the disposition of the product is determined via the disposition subroutine of FIG. 26.

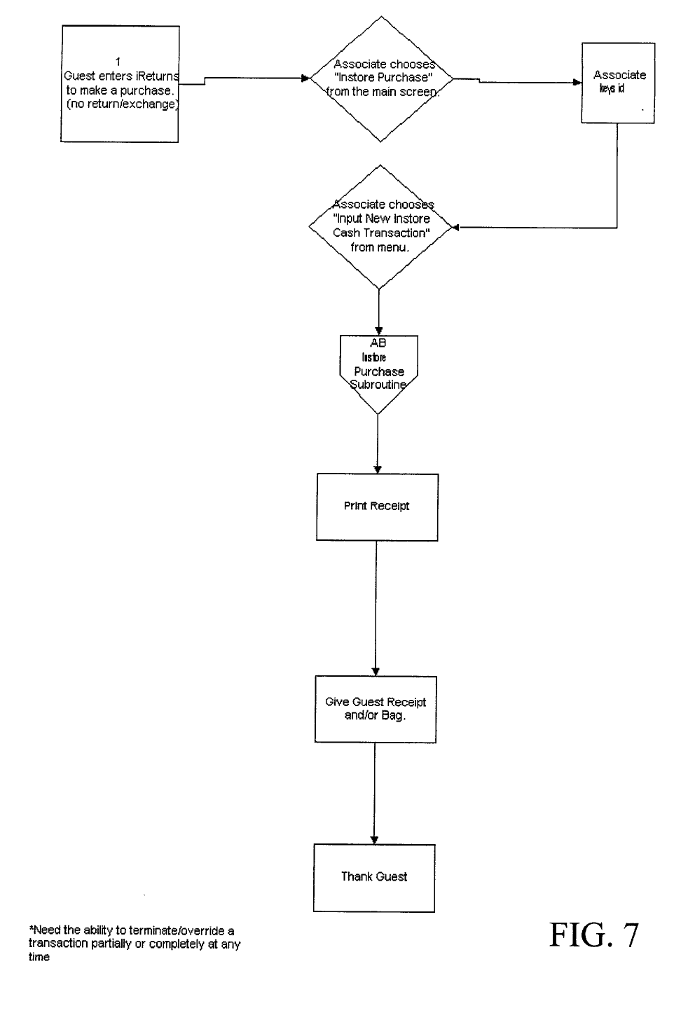

FIG. 7 presents a flow diagram of an in store purchase process in accordance with an embodiment of the present invention.

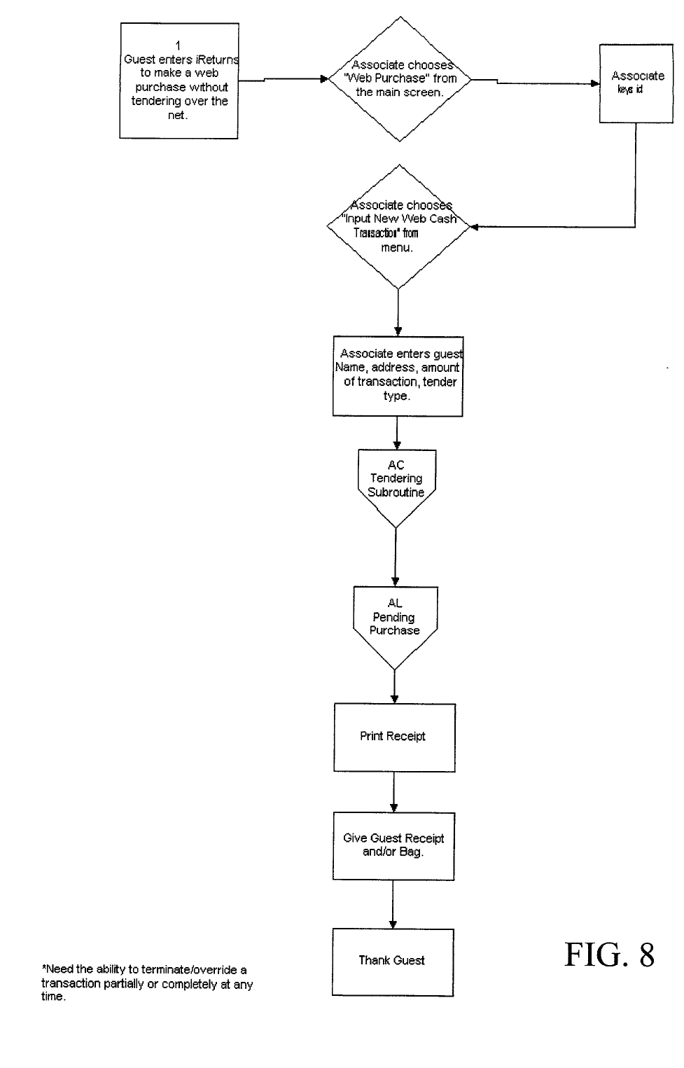

FIG. 8 is a flow diagram of a network purchase routine, such as a purchase via the Internet, in accordance with an embodiment of the present invention.

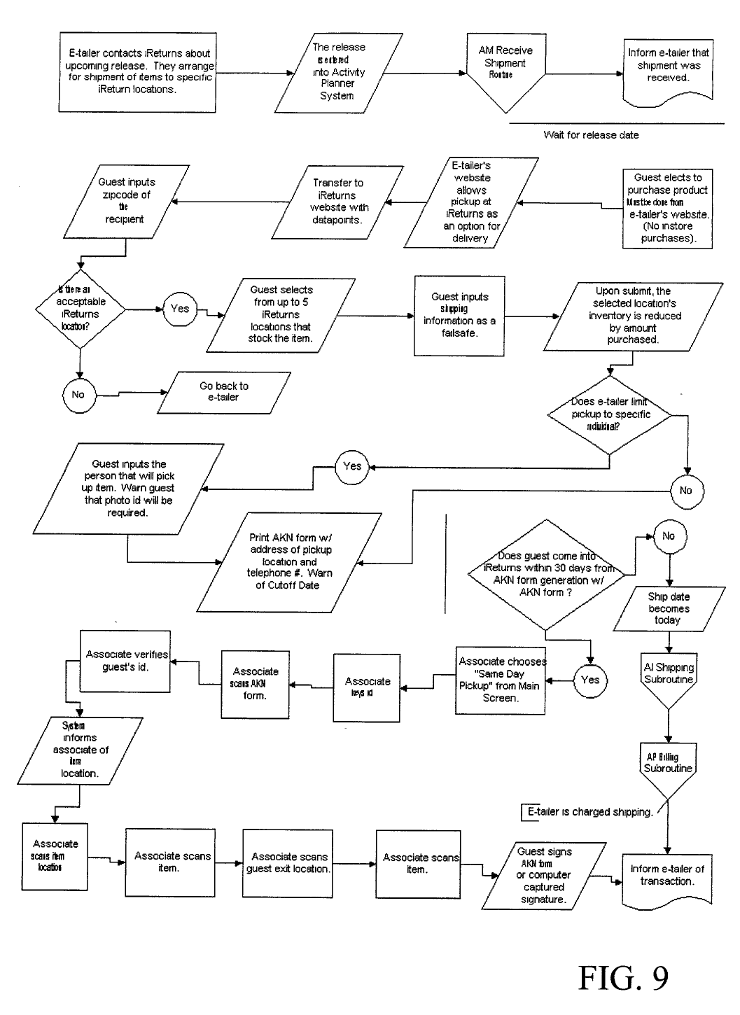

FIG. 9 shows a flow diagram of a same day pickup routine in accordance with an embodiment of the present invention.

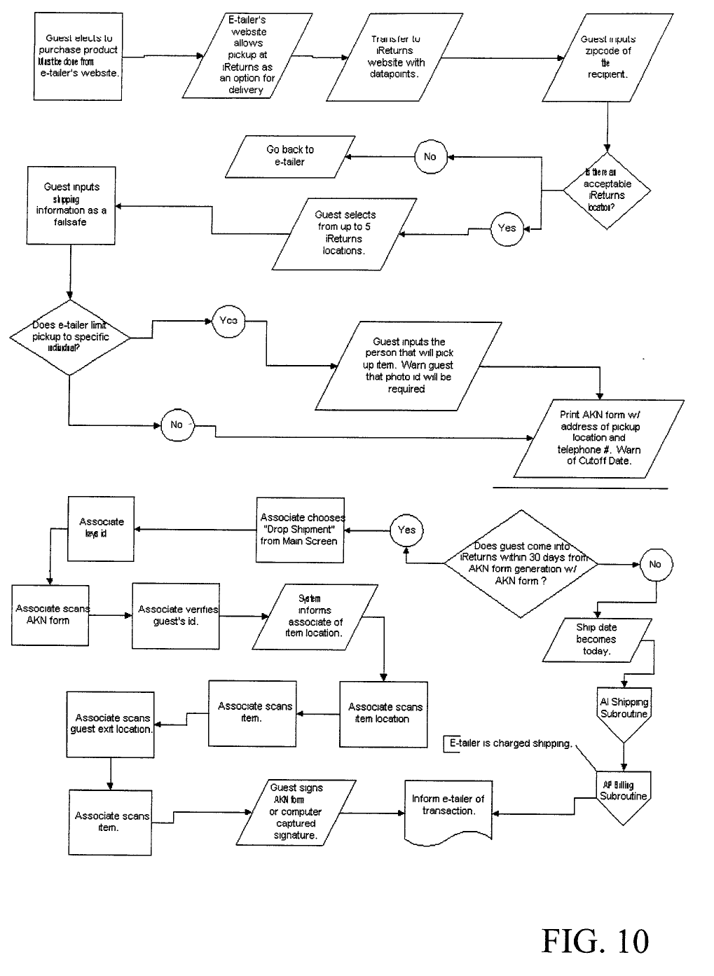

FIG. 10 is a flow diagram of a drop shipment routine in accordance with an embodiment of the present invention.

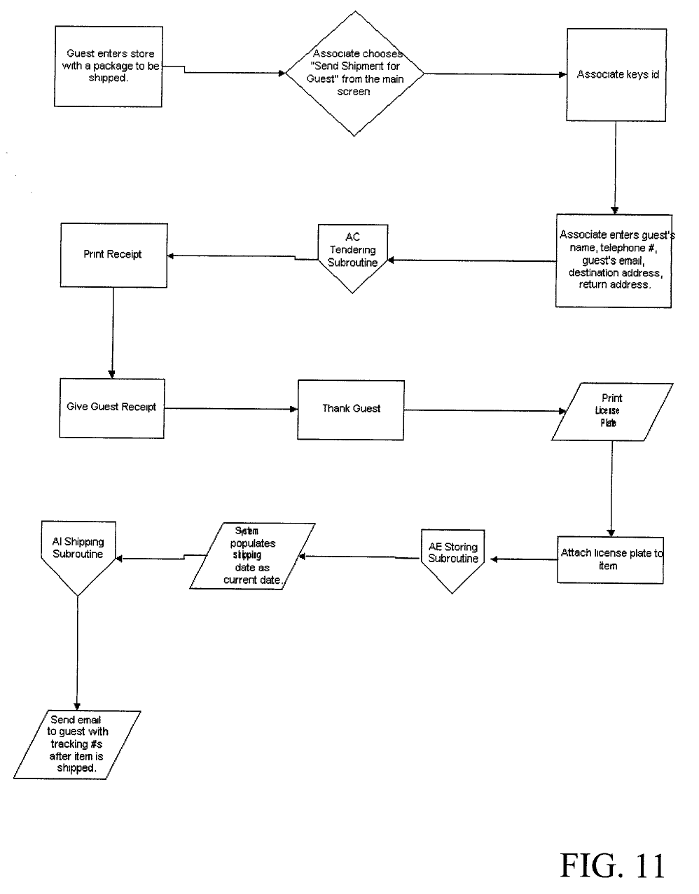

FIG. 11 presents a flow diagram of a guest shipment routine in accordance with an embodiment of the present invention.

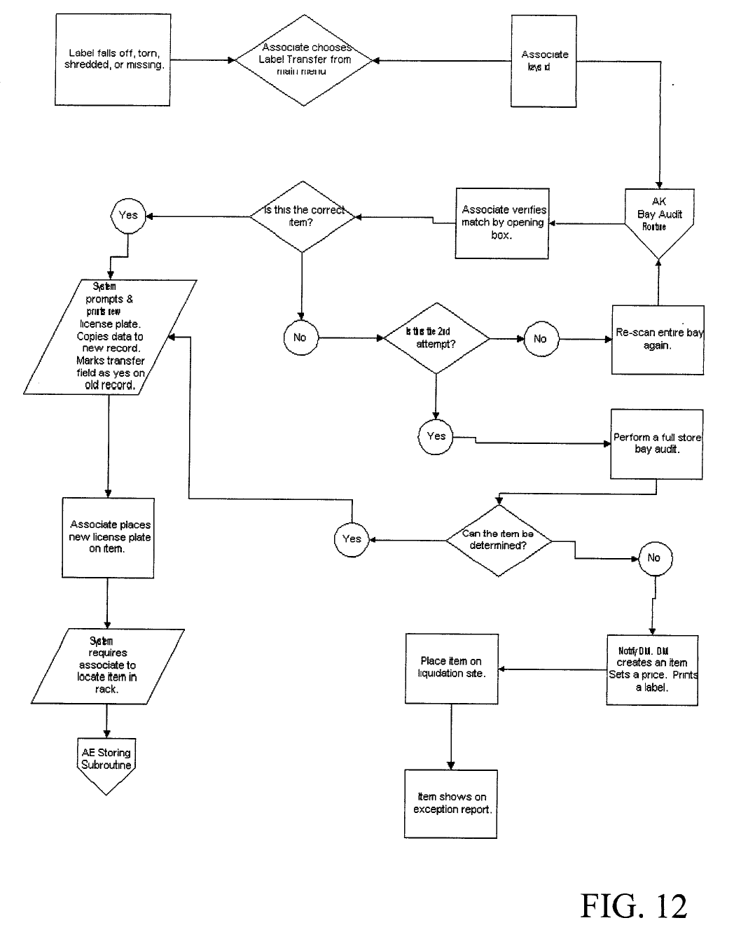

FIG. 12 is a flow diagram of a license plate transfer routine in accordance with an embodiment of the present invention.

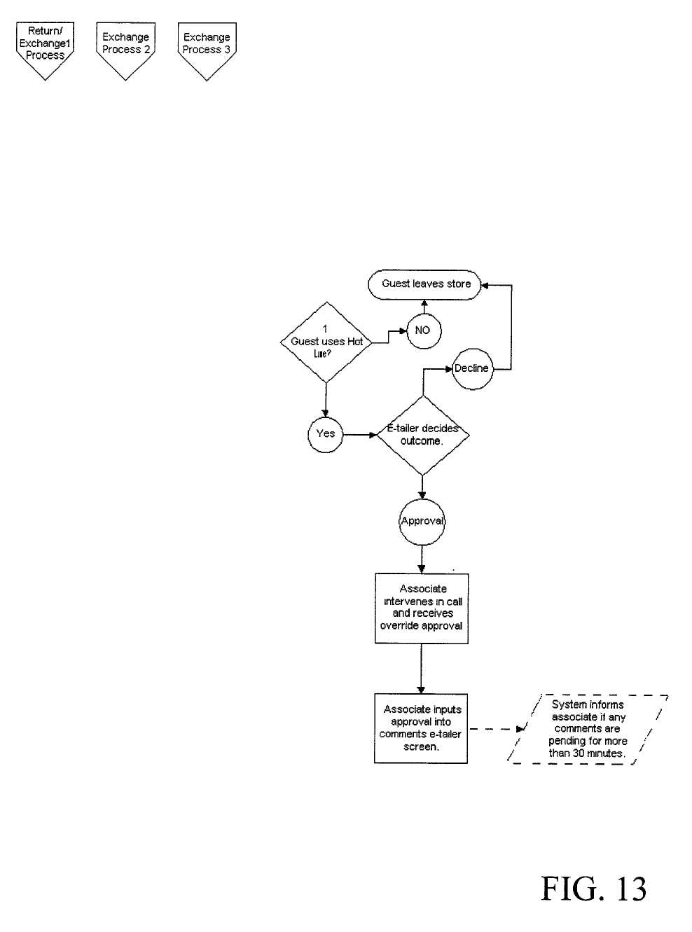

FIG. 13 shows a flow diagram of an e-tailer's hotline subroutine (AA) for use in conjunction with FIGS. 4, 5, and 6, in accordance with an embodiment of the present invention.

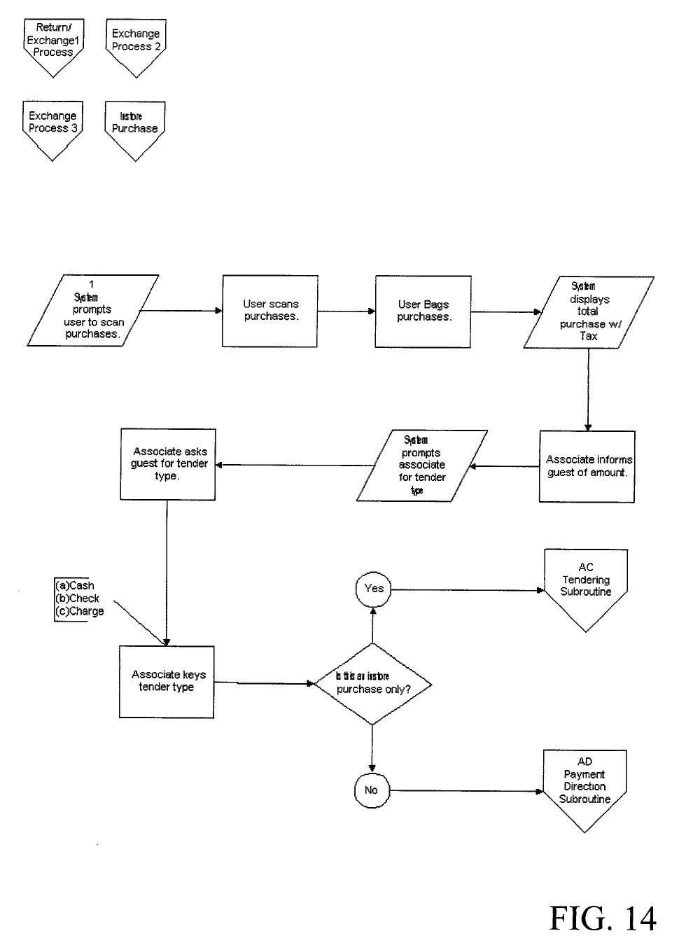

FIG. 14 presents a flow diagram of an in store purchase subroutine (AB) for use in conjunction with FIGS. 4, 5, 6, and 7 in accordance with an embodiment of the present invention.

FIG. 15 is a flow diagram of a tendering subroutine (AC) for use in conjunction with FIGS. 4, 8, 11, 14, 16, 18, 20, and 23, in accordance with an embodiment of the present invention.

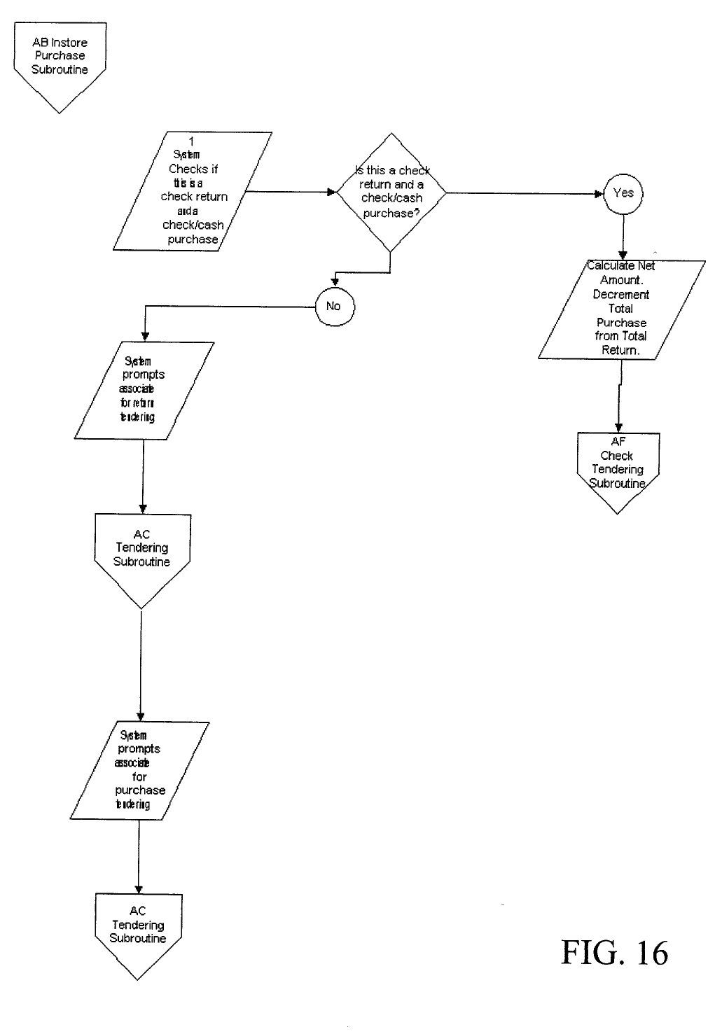

FIG. 16 shows a flow diagram of a payment direction subroutine (AD) for use in conjunction with FIG. 14, in accordance with an embodiment of the present invention.

FIG. 17 presents a flow diagram of a store subroutine (AE) for use in conjunction with FIGS. 4, 11, 12, and 24, in accordance with an embodiment of the present invention.

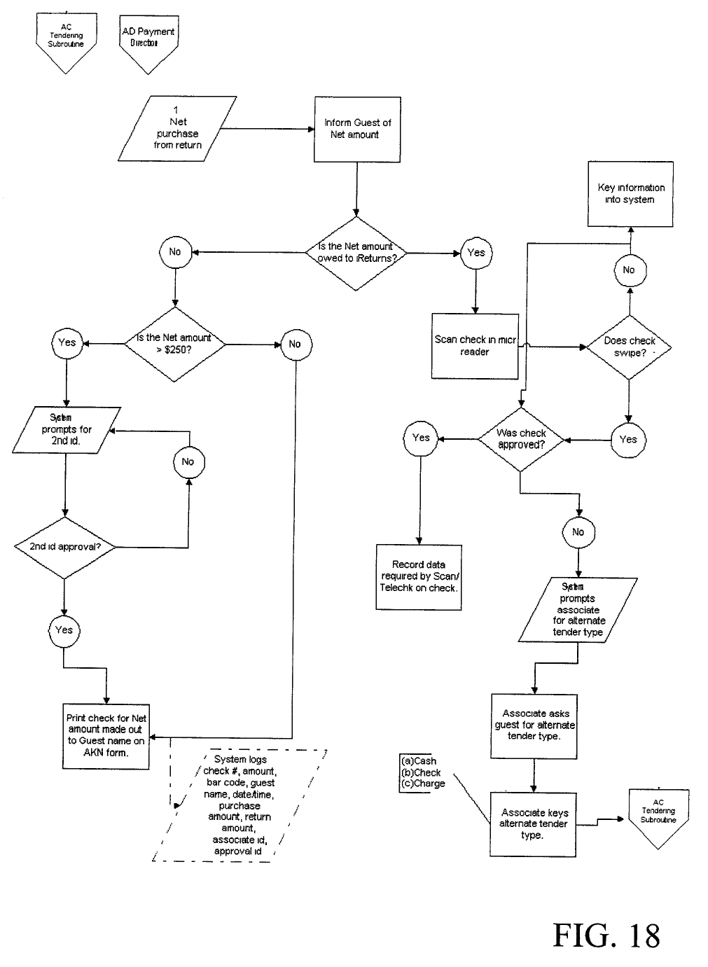

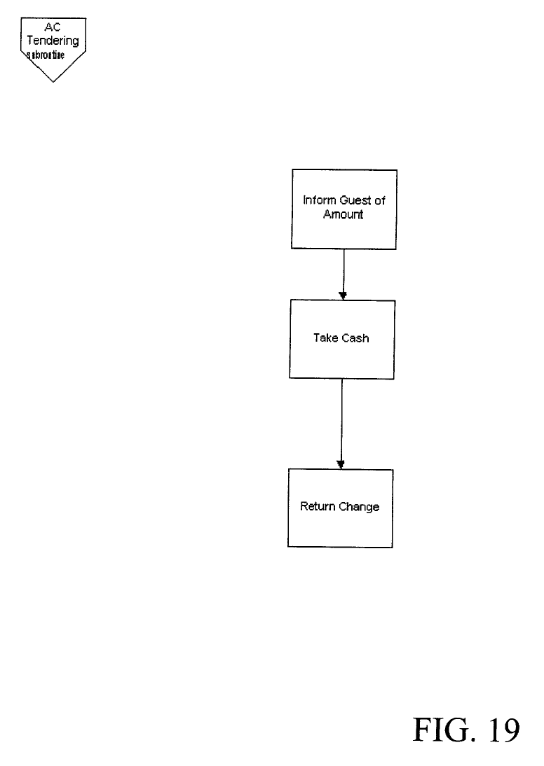

FIG. 18 is a flow diagram of a check tender subroutine (AF) for use in conjunction with FIGS. 15 and 16, in accordance with an embodiment of the present invention.

FIG. 19 shows a flow diagram of a cash tender subroutine (AG) for use in conjunction with FIG. 15, in accordance with an embodiment of the present invention.

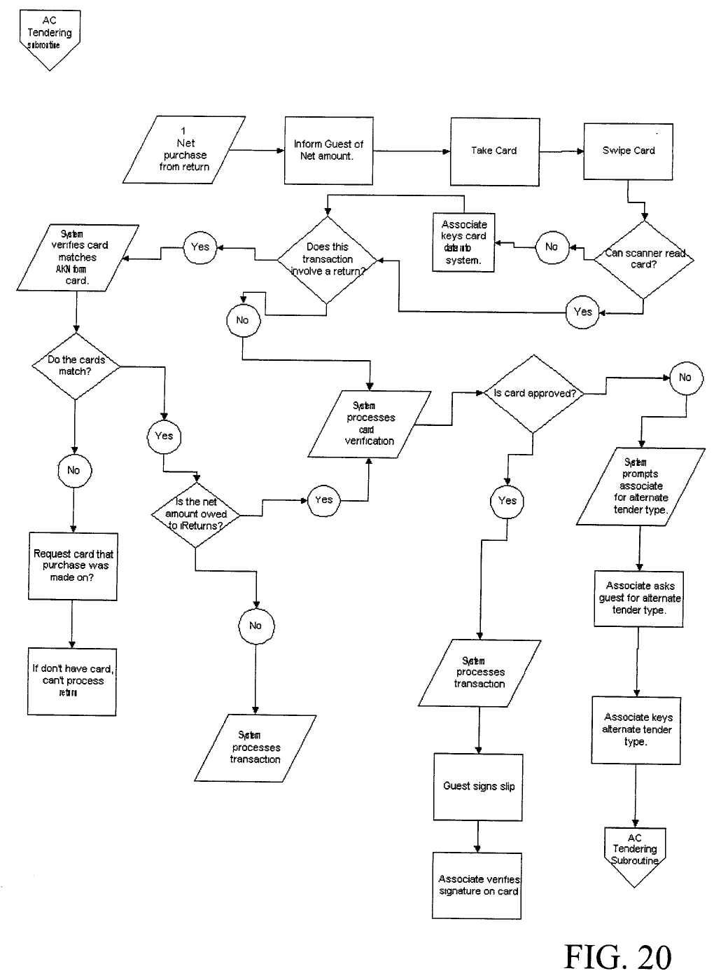

FIG. 20 presents a flow diagram of a credit tender subroutine (AH) for use in conjunction with FIG. 15, in accordance with an embodiment of the present invention.

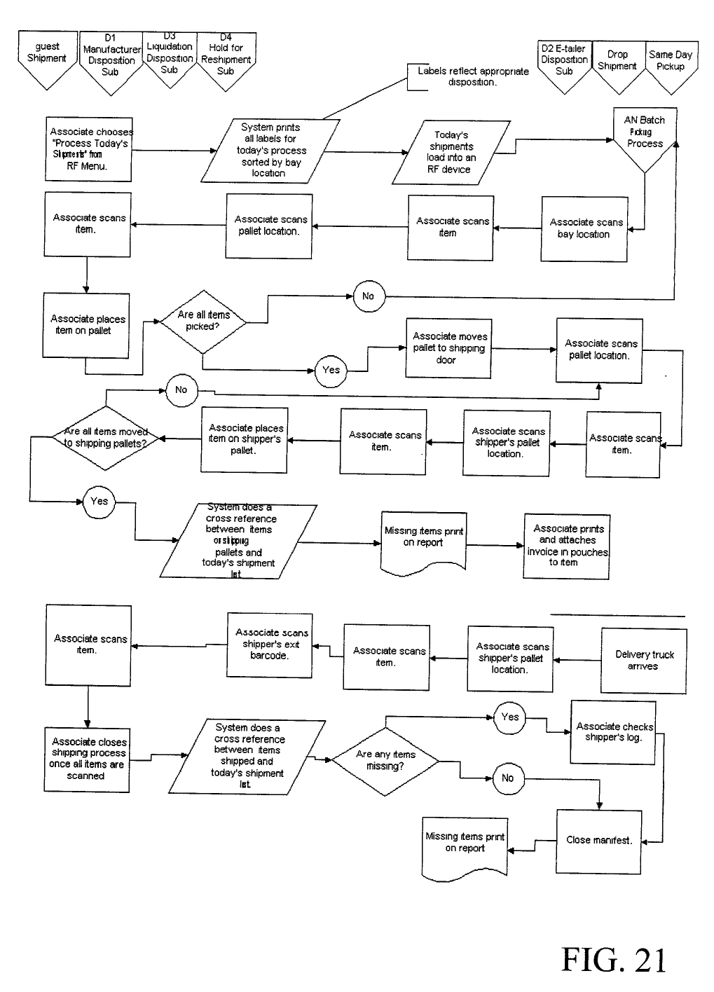

FIG. 21 is a flow diagram of a shipping subroutine (AI) for use in conjunction with FIGS. 9, 10, 11, 28, 29, 30, and 31, in accordance with an embodiment of the present invention.

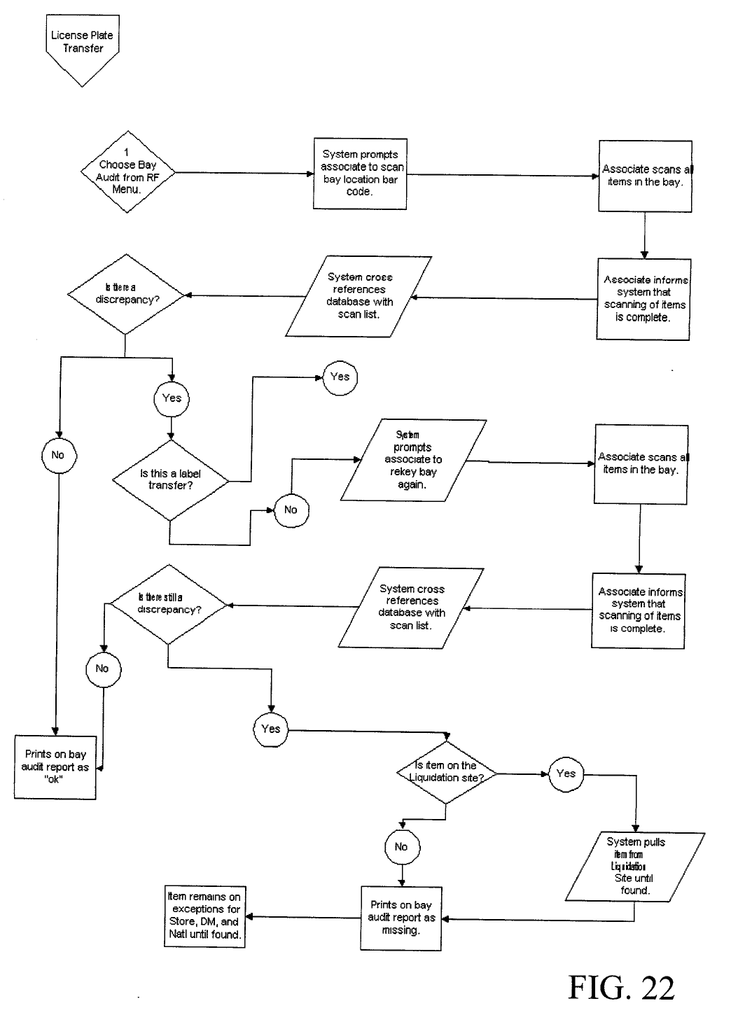

FIG. 22 shows a flow diagram of a bay audit subroutine (AK) for use in conjunction with FIG. 12, in accordance with an embodiment of the present invention.

FIG. 23 presents a flow diagram of a pending purchase subroutine (AL) for use in conjunction with FIGS. 5 and 8, in accordance with an embodiment of the present invention.

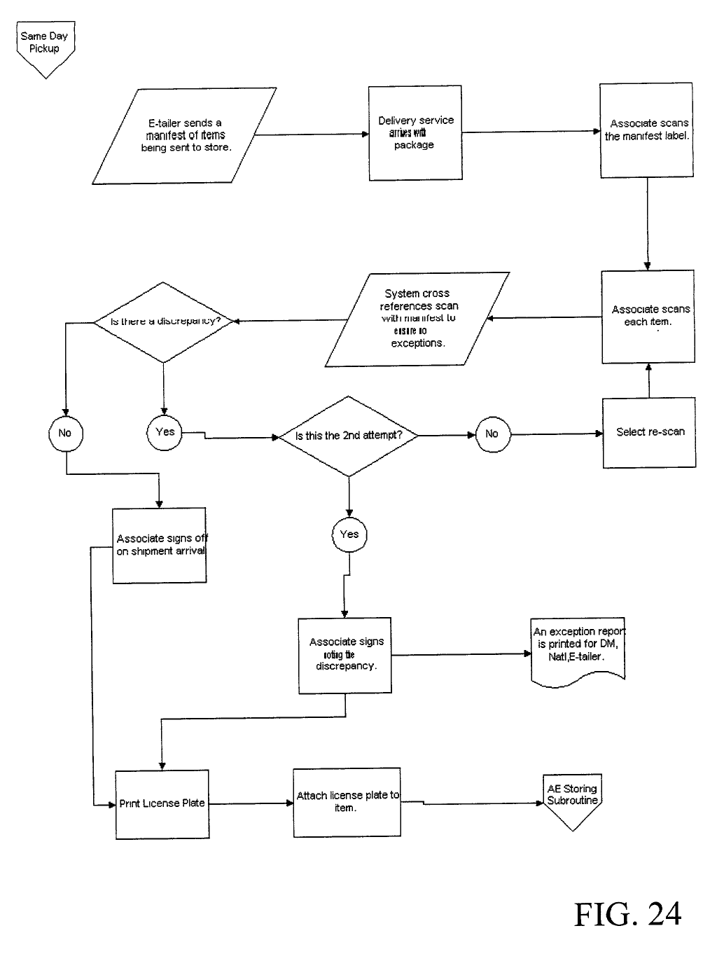

FIG. 24 is a flow diagram of a receive shipment subroutine (AM) for use in conjunction with FIG. 9, in accordance with an embodiment of the present invention.

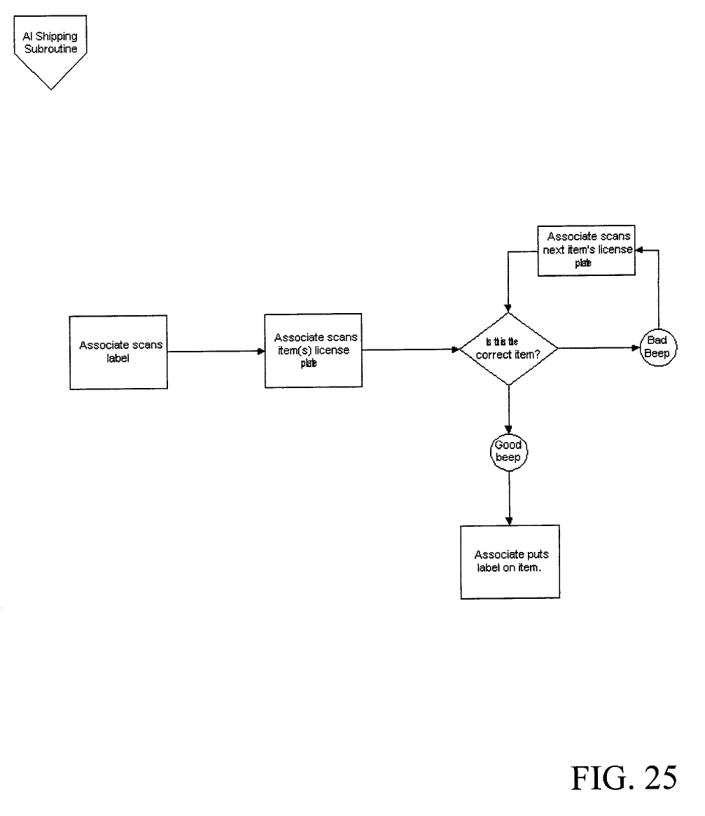

FIG. 25 shows a flow diagram of a batch picking process subroutine (AN) for use in conjunction with FIG. 21, in accordance with an embodiment of the present invention.

FIG. 26 presents a flow diagram of a disposition subroutine (AO) for use in conjunction with FIGS. 4, 5, and 30, in accordance with an embodiment of the present invention.

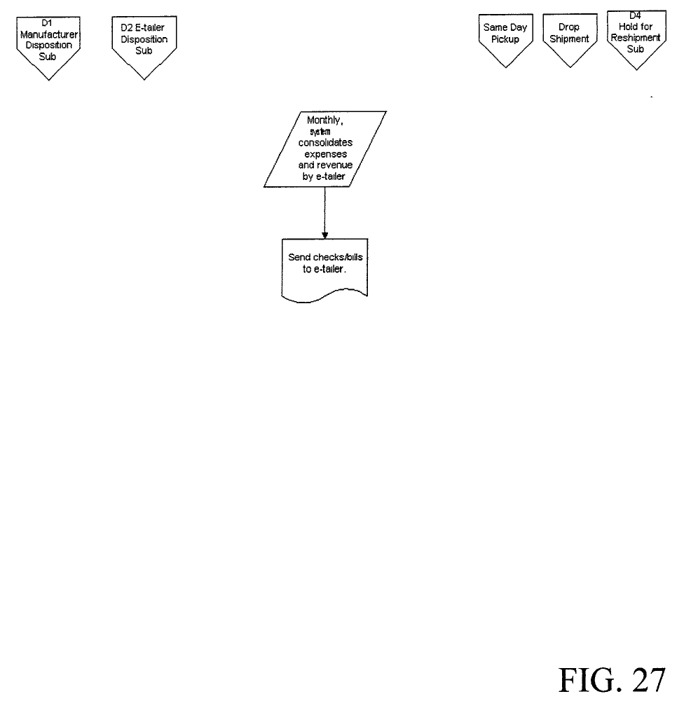

FIG. 27 is a flow diagram of a billing subroutine (AP) for use in conjunction with FIGS. 9, 10, 28, 29, and 31, in accordance with an embodiment of the present invention.

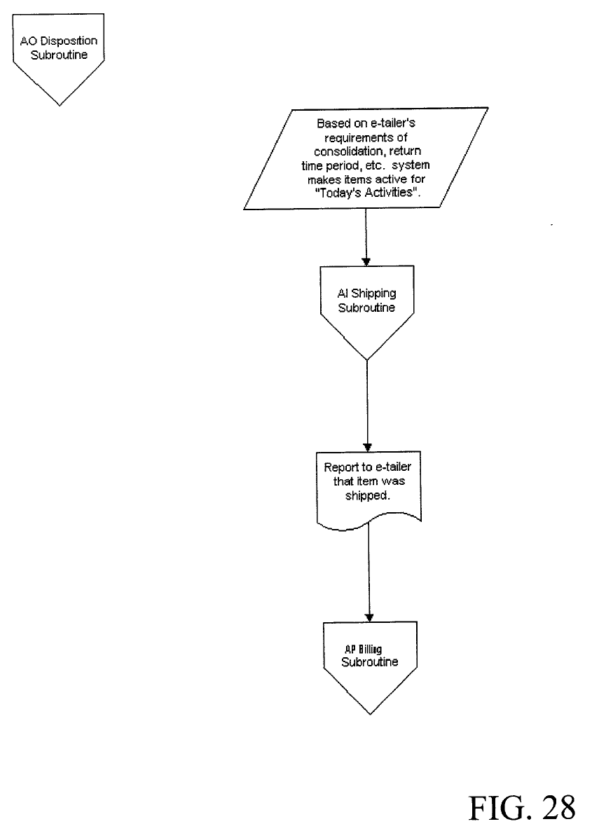

FIG. 28 shows a flow diagram of a manufacturer disposition subroutine (D1) for use in conjunction with FIG. 26, in accordance with an embodiment of the present invention.

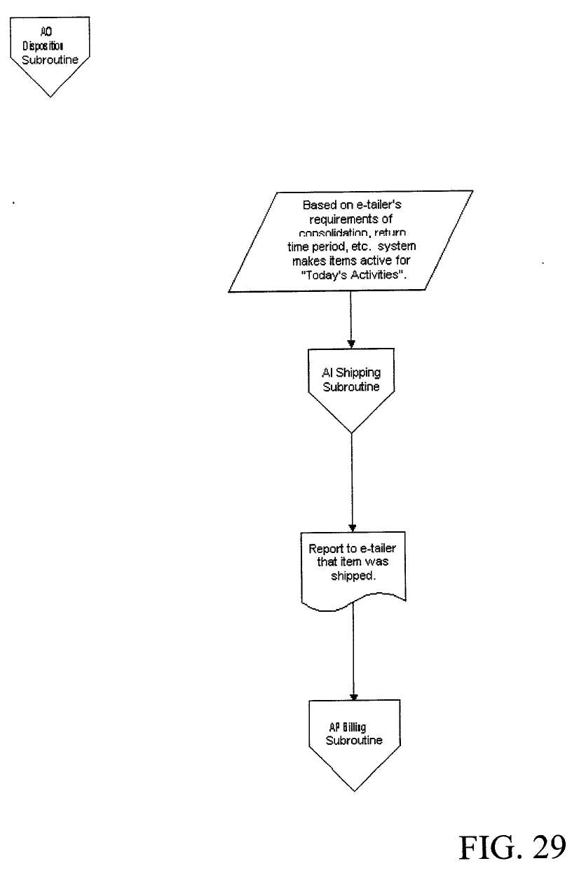

FIG. 29 presents a flow diagram of an e-tailer disposition subroutine (D2) for use in conjunction with FIG. 26, in accordance with an embodiment of the present invention.

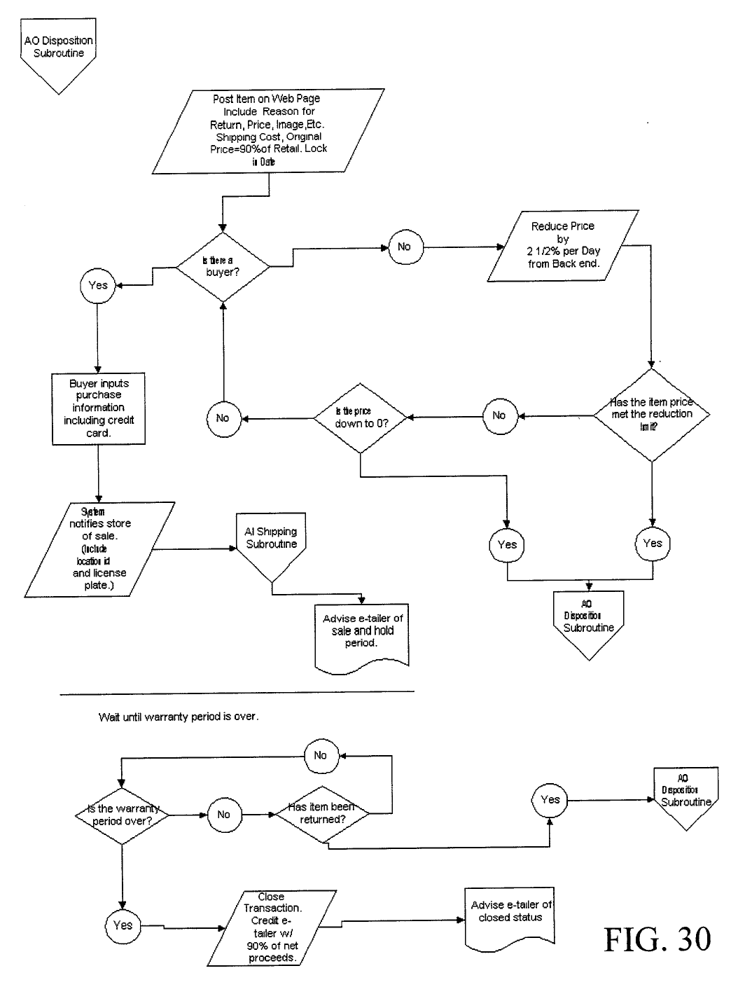

FIG. 30 is a flow diagram of a liquidation disposition subroutine (D3) for use in conjunction with FIG. 26, in accordance with an embodiment of the present invention.

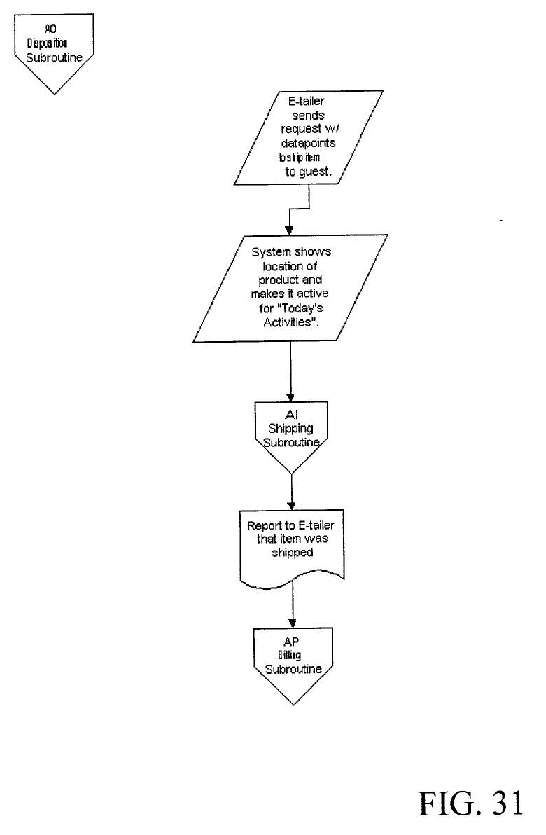

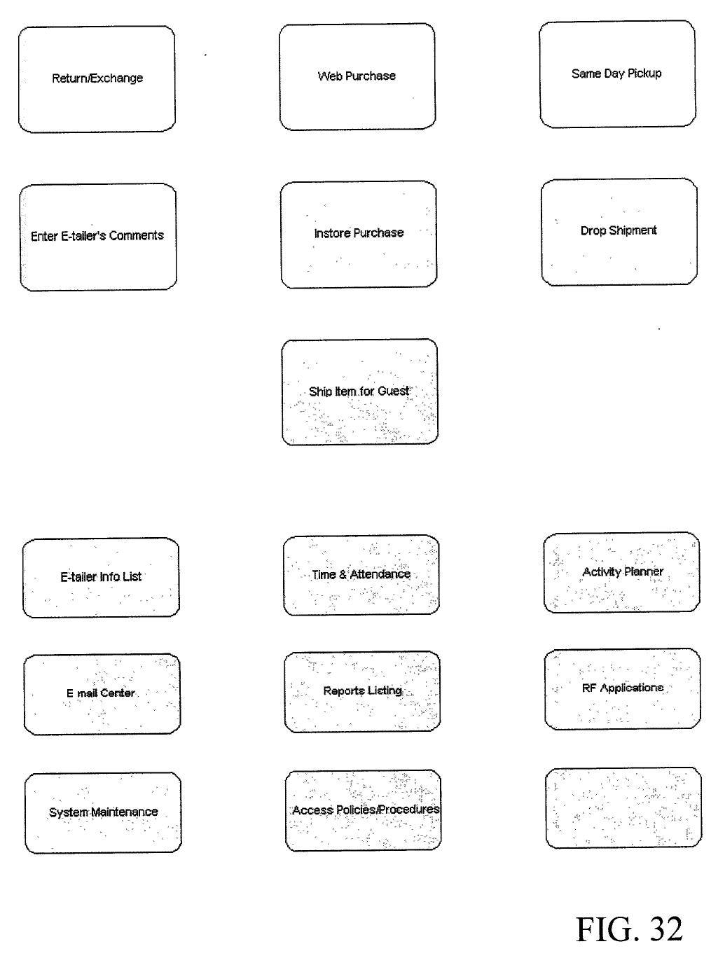

FIG. 31 shows a flow diagram of a hold for reshipment subroutine (D4) for use in conjunction with FIG. 26, in accordance with an embodiment of the present invention.

FIG. 32 presents an example main selection screen for a GUI for use in accordance with an embodiment of the present invention.

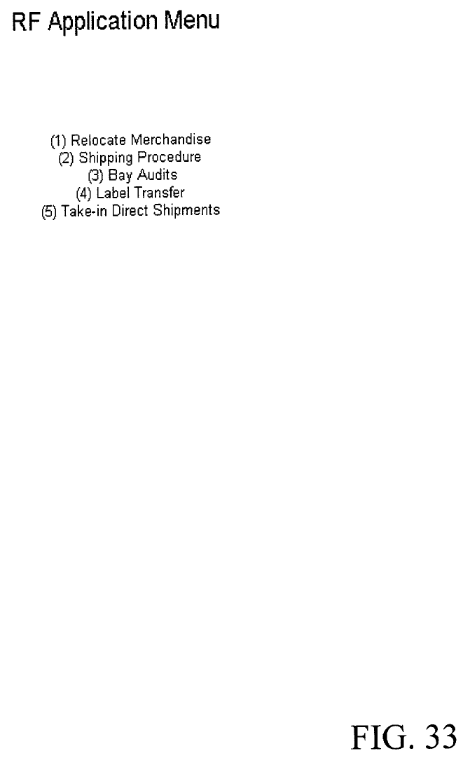

FIG. 33 is an example RF application menu for use with an embodiment of the present invention.

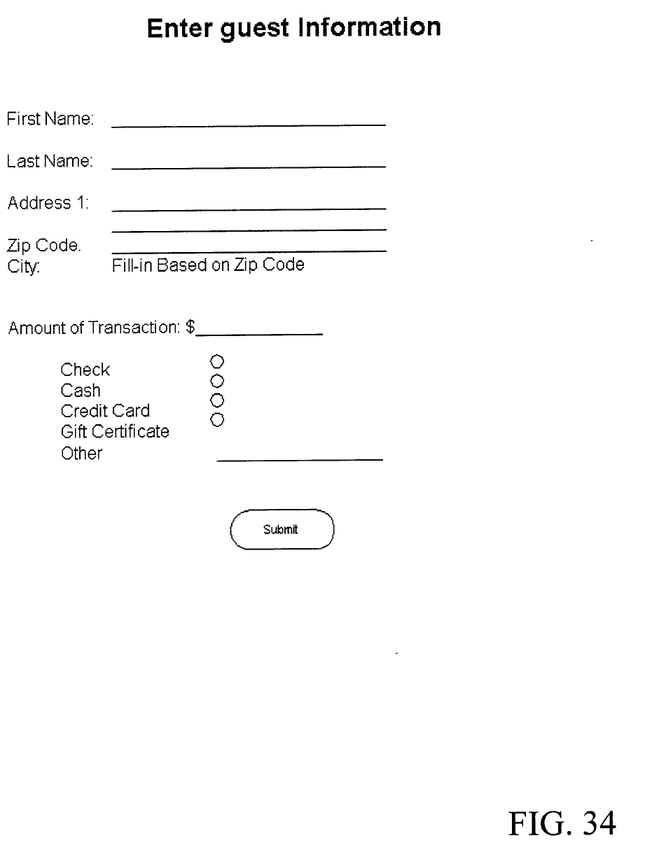

FIG. 34 shows an example web purchase form for use with an embodiment of the present invention.

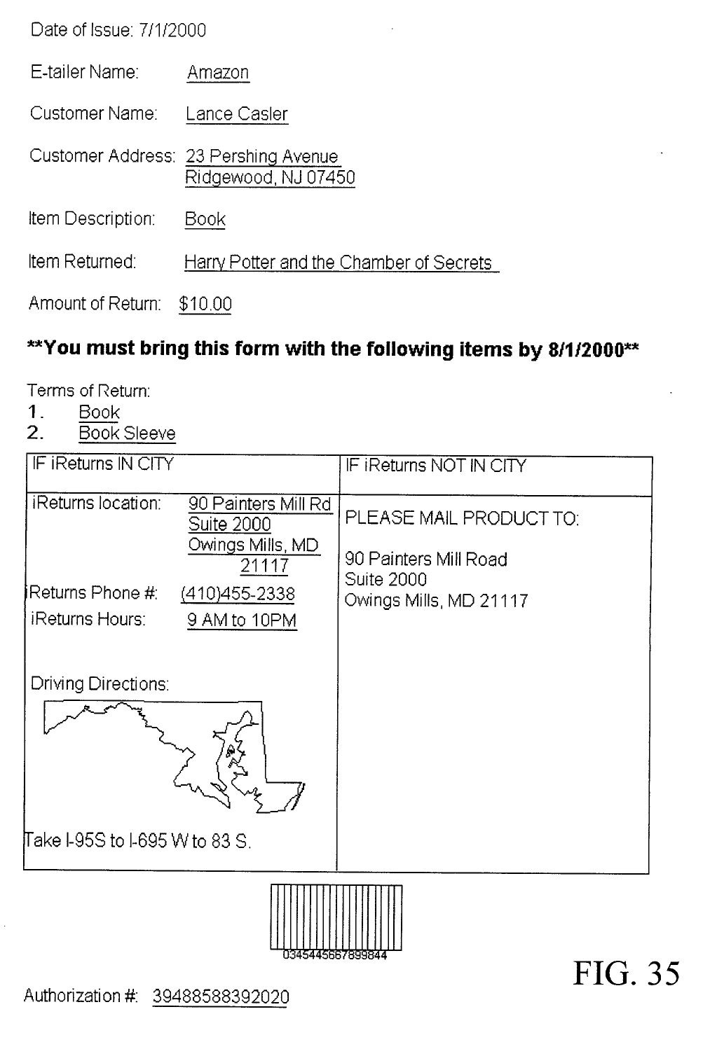

FIG. 35 presents an example return form or ticket with representative bar code for use with an embodiment of the present invention.

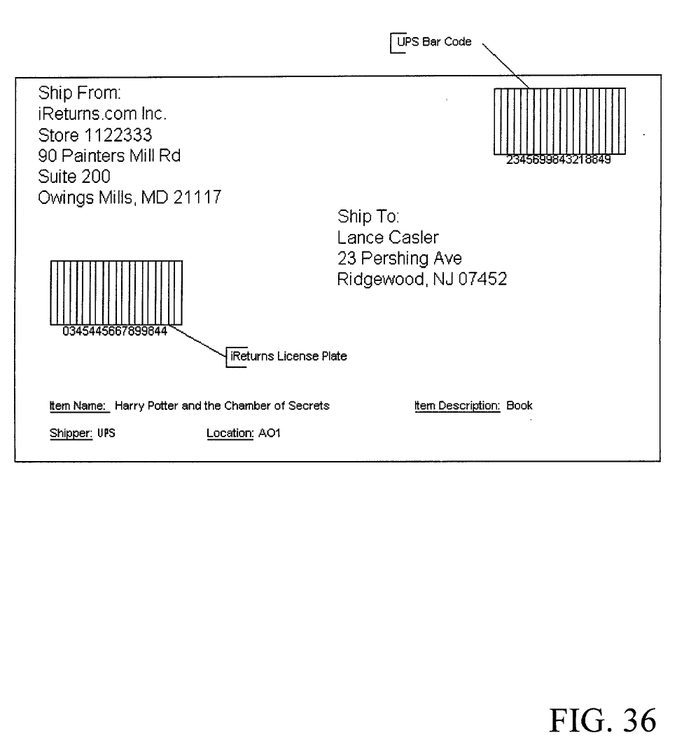

FIG. 36 is an example shipment label for use with an embodiment of the present invention.

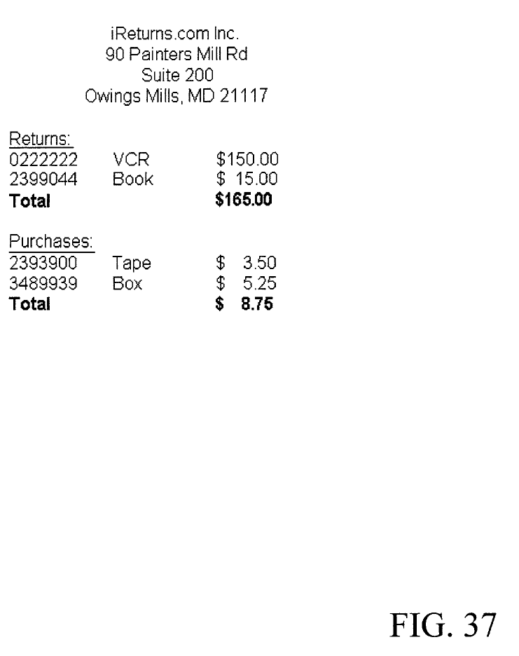

FIG. 37 shows an example of a receipt for use with an embodiment of the present invention.

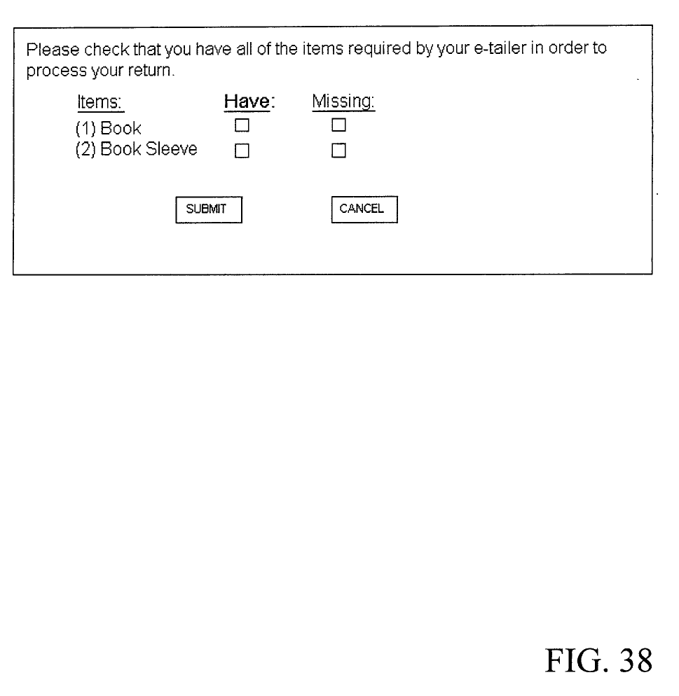

FIG. 38 presents an example return checklist for use via a network, such as the Internet, in accordance with an embodiment of the present invention.

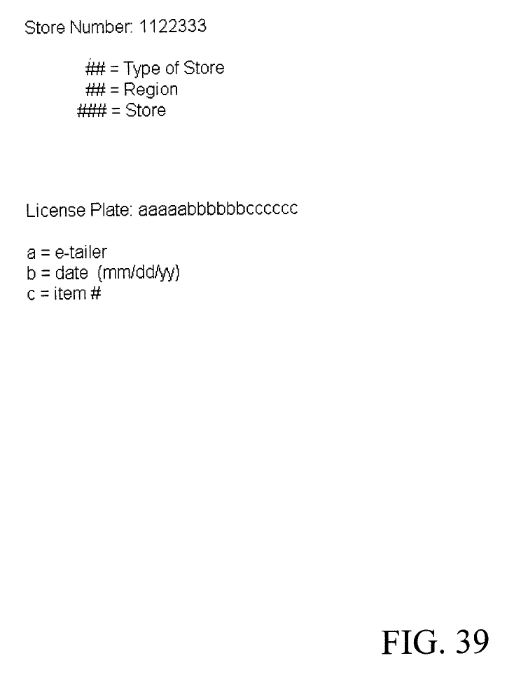

FIG. 39 is an example of store number and license plate formats for use in accordance with embodiments of the present invention.

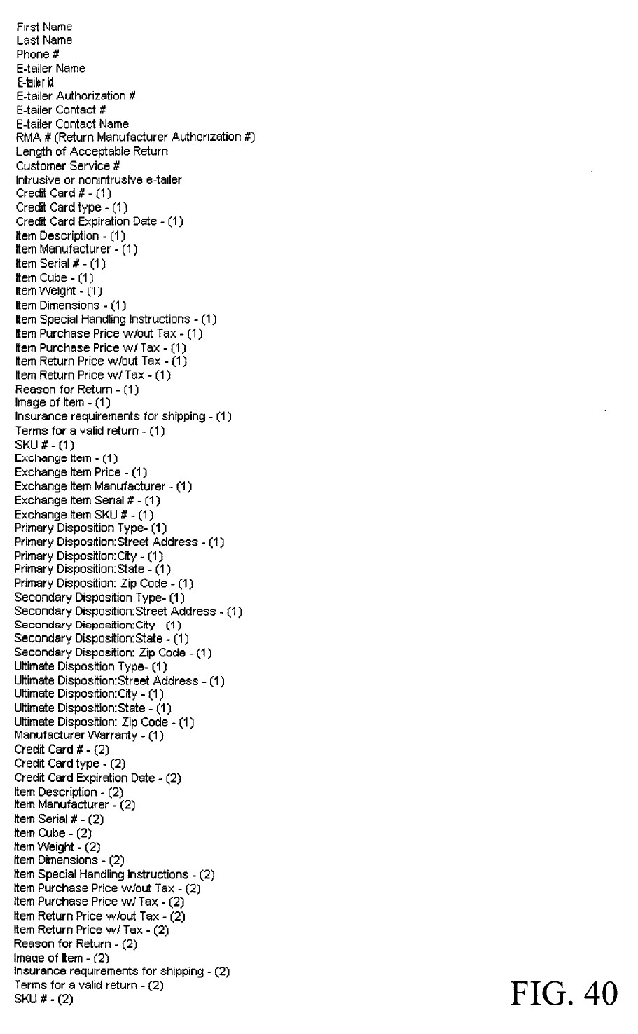

FIG. 40 shows the first part of an example list of data inputs from a merchant for use in accordance with an embodiment of the present invention.

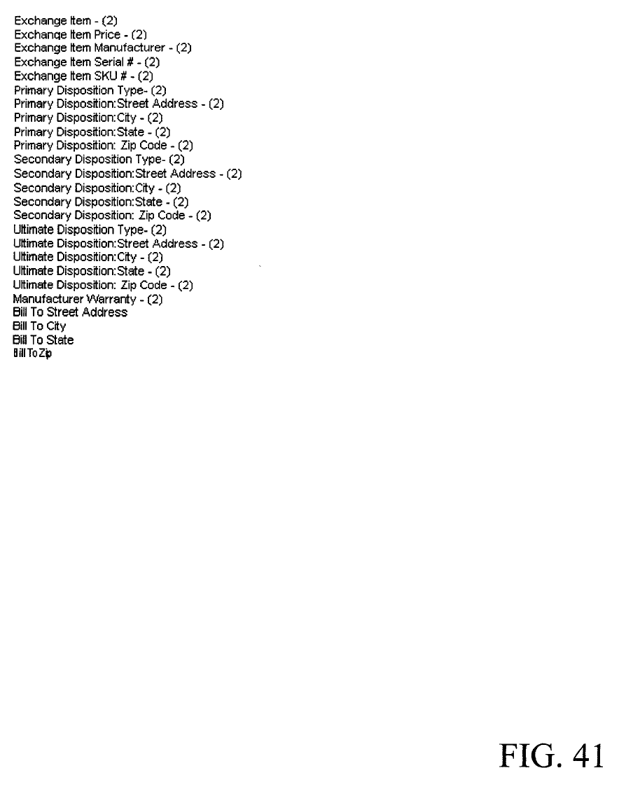

FIG. 41 presents the second part of an example list of data inputs from a merchant for use in accordance with an embodiment of the present invention.

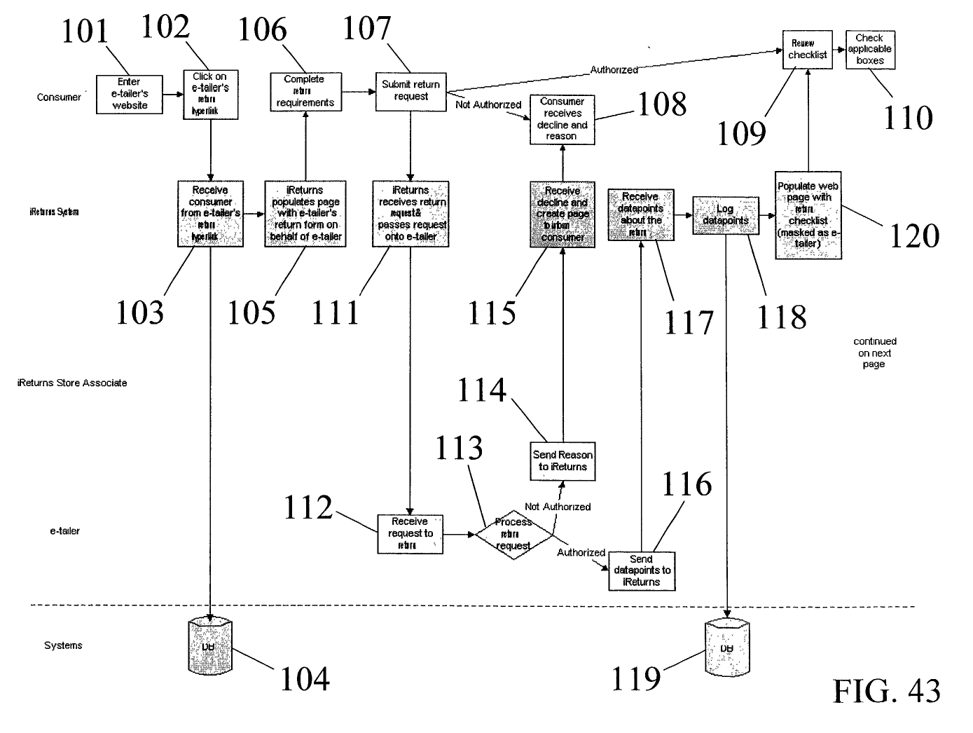

FIG. 42 shows list of routine names for various functions and system components for a network-based system and method as shown in FIGS. 43-89, in accordance with a second embodiment of the present invention.

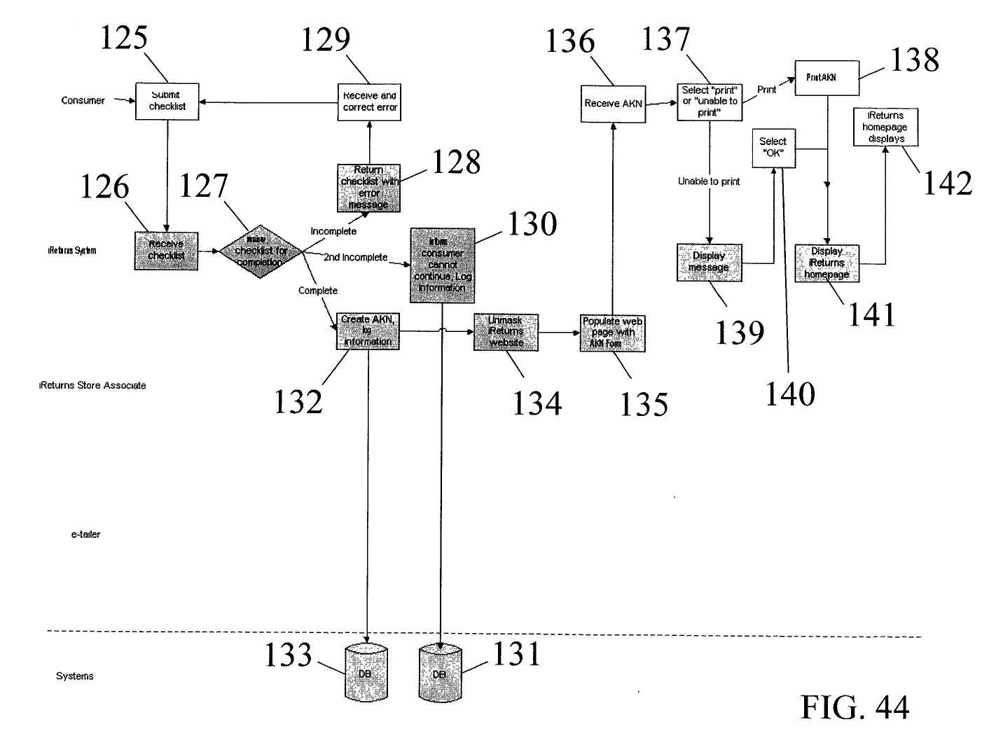

FIGS. 43 and 44 contain a flow diagram of a return process initiated by a customer on a network, in accordance with a second embodiment of the present invention. As shown in FIG. 43, a guest, such as a consumer or customer, enters a network site for a merchant 101. The guest selects the merchant's return network link 102. The iReturns server receives the guest via the merchant's return network link 103. Data is sent to a repository, such as a database 104. The iReturns server populates the accessed network page with the merchant's return form 105.

The guest then completes the return requirements 106 and submits the return request 107. If not authorized, the guest receives a decline and a reason 108. If authorized, the guest receives a checklist to review 109 and checks applicable boxes 110. The iReturns server receives the return request and passes the request to the merchant 111. The merchant receives the request to return the item 112. The merchant then processes the return request 113. If the return is not authorized, a reason is sent to the iReturns server by the merchant 114. The iReturns server receives the decline and creates a page to inform the guest of the decline 115, and the guest then receives the decline and the reason 108.

If the merchant processing of the return request 113 is authorized, the merchant sends data points to the iReturns server 116. The iReturns server receives the data points about the return 117 and logs the datapoints 118, which are stored in a repository, such as a database 119. The iReturns server then populates the network page with a return checklist (masked as the merchant) 120. The guest then reviews the checklist 109 and checks applicable boxes 110.

As shown in FIG. 44, the guest then submits the checklist 125, which is received by the iReturns server 126. The iReturns server reviews the checklist for completion 127. If the checklist is incomplete, it is returned to the guest with an error message 128. The guest receives and corrects the error 129, and resubmits the checklist 125, restarting this portion of the process. If the iReturns server determines that the checklist is incomplete a second time, the guest is informed that the return function cannot continue, and the information is logged 130 to a repository, such as a database 131. If the iReturns server determines that the checklist is complete, an AKN is created, and the information is logged 132 to a repository, such as a database 133. The iReturns server network site is then unmasked 134, and the network site is populated with the AKN form 135.

The guest then receives the AKN 136, and selects “print” or “unable to print” 137. If the guest is able to print, the AKN is printed 138. If the guest is unable to print, the iReturn server network site displays this message 139, and the guest is prompted to select “OK” 140. The iReturn server network site hompage is then displayed 141, and the guest returns to the iRetum server network site.

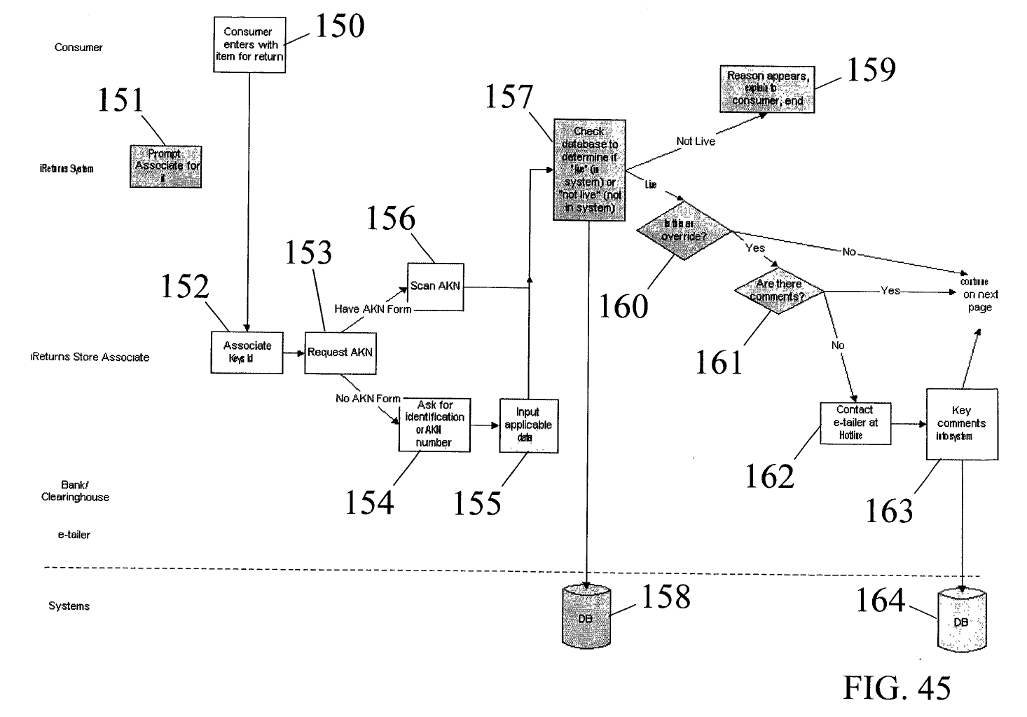

FIGS. 45-48 present a flow diagram of a return process at a store and via a network, in accordance with a second embodiment of the present invention. As shown in FIG. 45, the guest enters the store with an item for return 150. The iReturns server prompts an extension store associate for identification (ID) 151. The asociate keys keys the ID 152. The associate then requests the AKN form 153. If there is no AKN form, the associate asks for identification of the guest or an AKN number 154, and inputs the applicable data 155. If there is an AKN form, the associate scans it 156. The iReturns server then checks to determine if the return is “live” (i.e., in the system) or “not live” (i.e., not in the system) 157 by accessing a repository, such as a database 158.

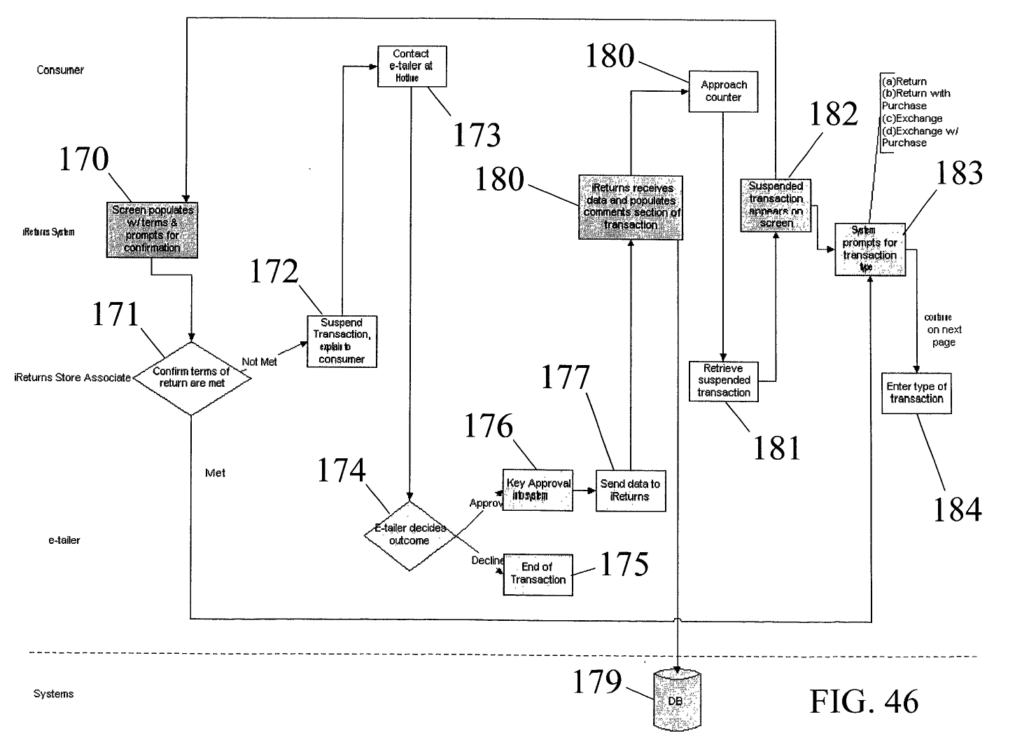

If the return is “not live,” the reason appears, and this is explained to the guest and the process ends 159. If the return is “live,” a determination is made whether there is an override 160. If there is an override, a query is made whether there are any comments 161. If there is an override, and there are no comments, the associate contacts the merchant via a hotline 162 and keys any comments into the system 163, which are input to a repository, such as a database 164. If there is no override, or if there are comments, as well as after the comments are entered, the process proceeds to FIG. 46.

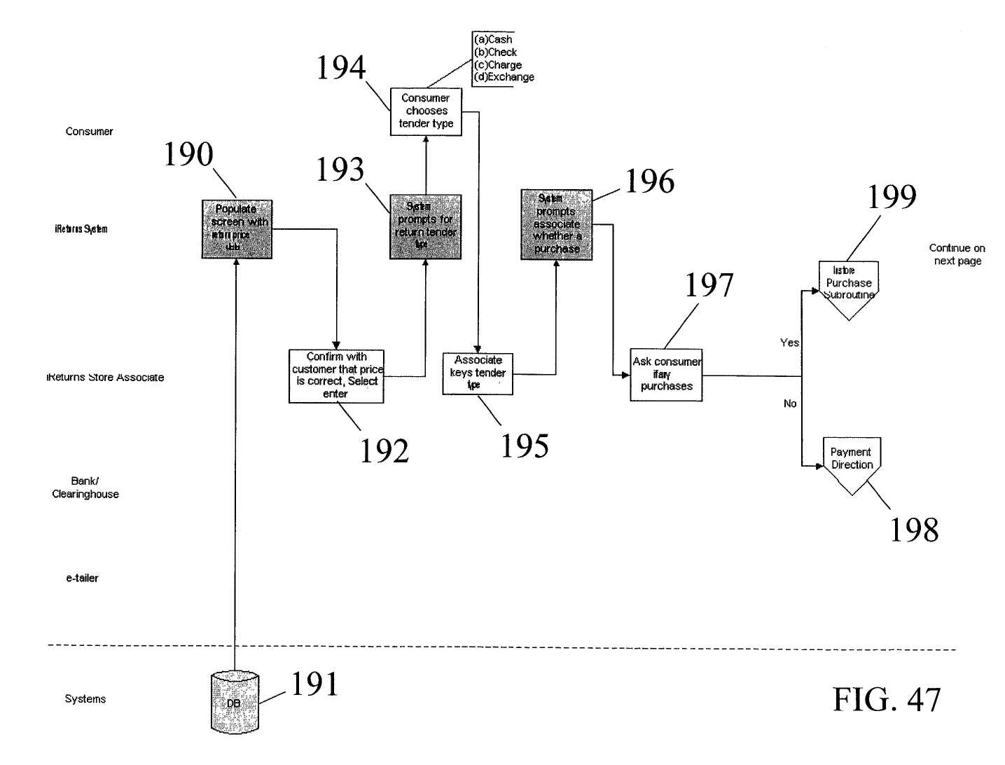

As shown in FIG. 46, the iReturns server populates the network site with terms and prompts for confirmation 170. The store associate then determines whether th terms are met 171. If the terms are not met, the transaction is suspended and an explanation is provided to the guest 172. The guest then contacts the merchant via, for example, a holine 173. The merchant then decides the outcome 174. If the transaction is declined, the transaction ends 175. If the transaction is approved, the merchant keys approval into the system 176 and sends the data to the iReturns server 177. The iRetums server receives the data and populates the comments section of the transaction 178. The iReturns server also provides data to a repository, such as a database 179. The guest then approaches the counter 180, and the store associate retrieves the suspended transaction 181. The suspended transaction then appears on the screen 182, and the process then returns to the screen population action 170, or the system prompts for the transaction type 183. If the associate confirms that the terms of the return are met 181, the procedure also proceeds to the system prompts for transaction type 183. The transaction type is then entered 184, and the procedure proceeds to FIG. 47.

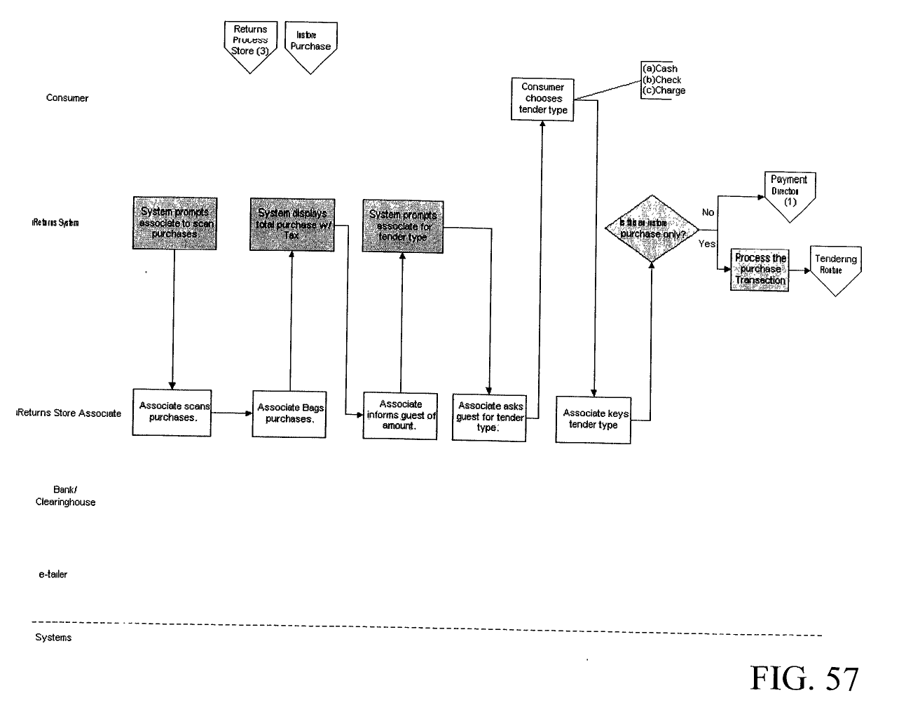

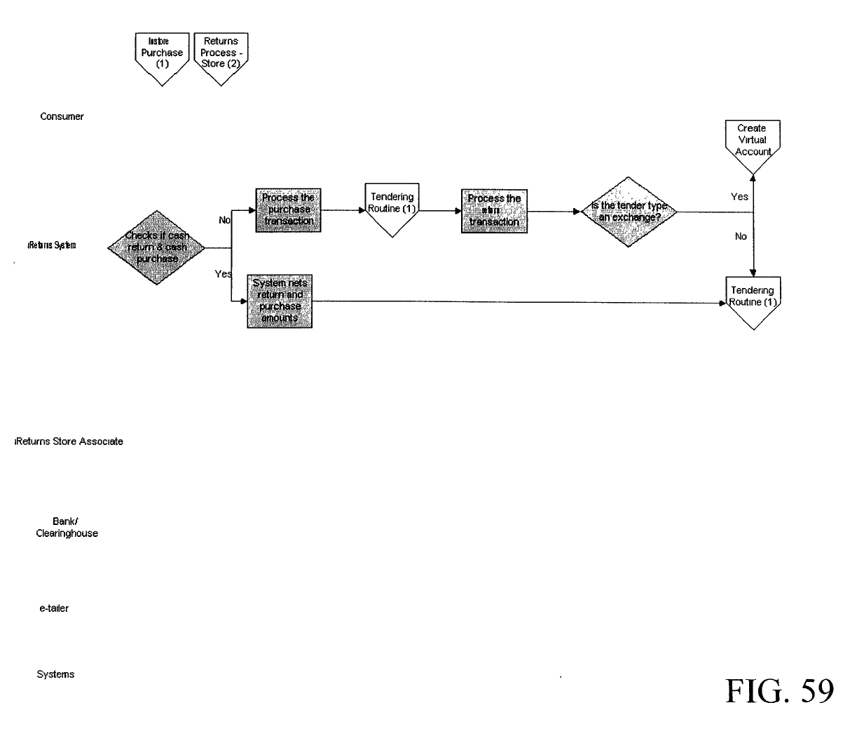

As shown in FIG. 47, the iReturns server populates the network page with return price data 190 obtained from a repository, such as a database 191. The store associate confirms with the guest that the price is correct and selects enter 192. The iReturns server prompts for return of tender type 193, and the guest chooses a tender type 194. The store associate keys in tender type 195, and the iReturns server prompts the store associate whether a purchase will be made 196. The store associate asks the consumer if any purchase will be made 197. If yes, the in store purchase subroutine 199 proceeds, as shown in FIG. 57. If no, the payment direction subroutine 198 proceeds, as shown in FIG. 59.

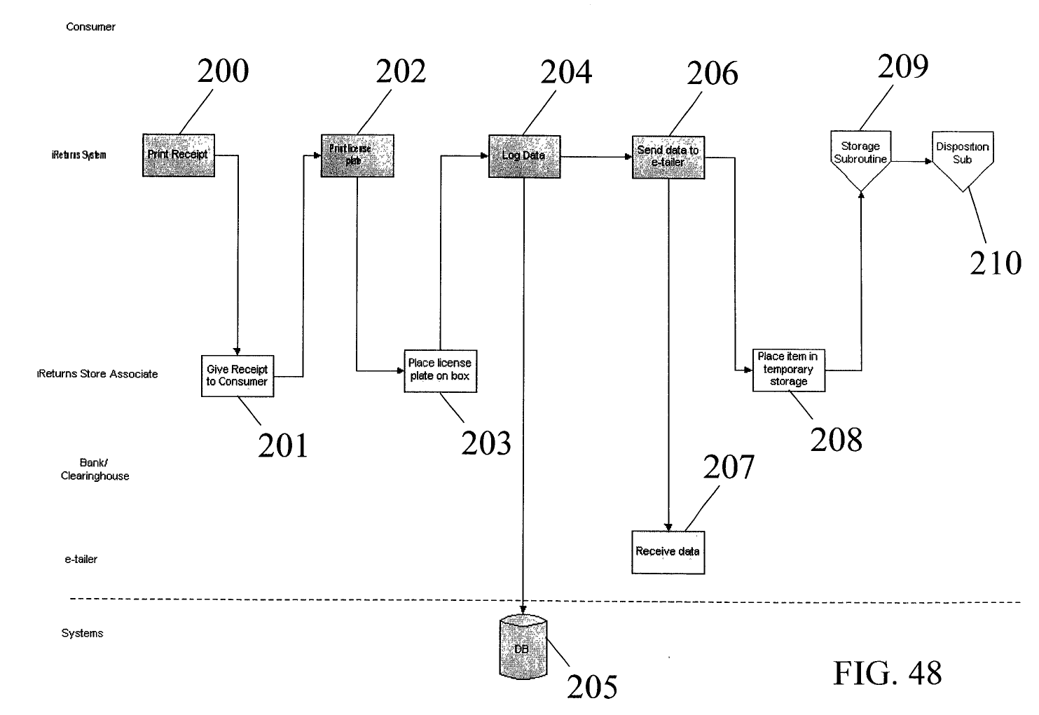

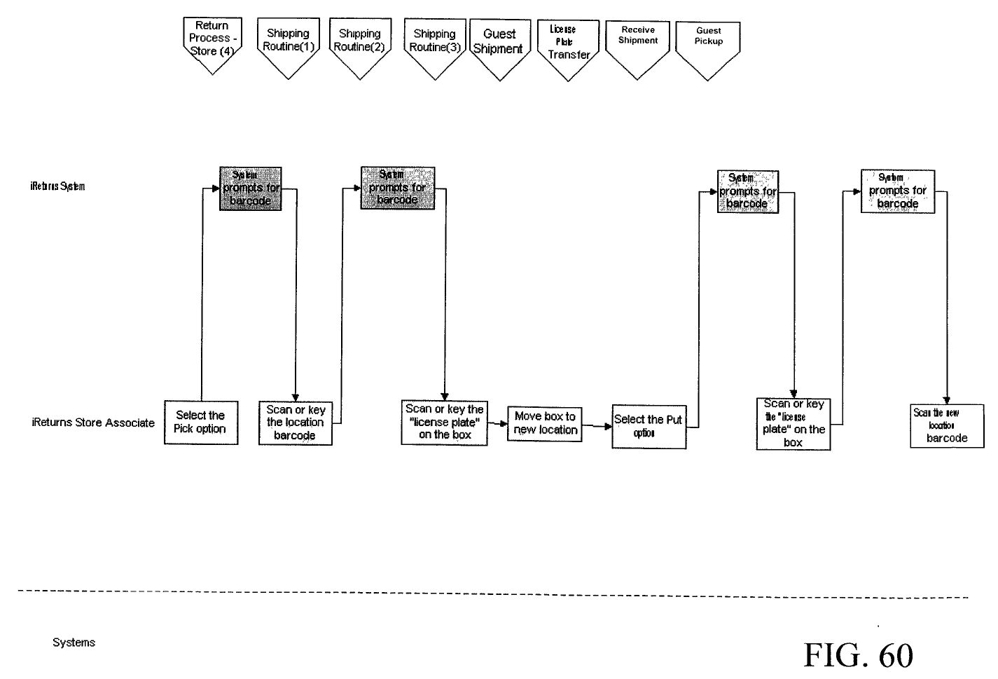

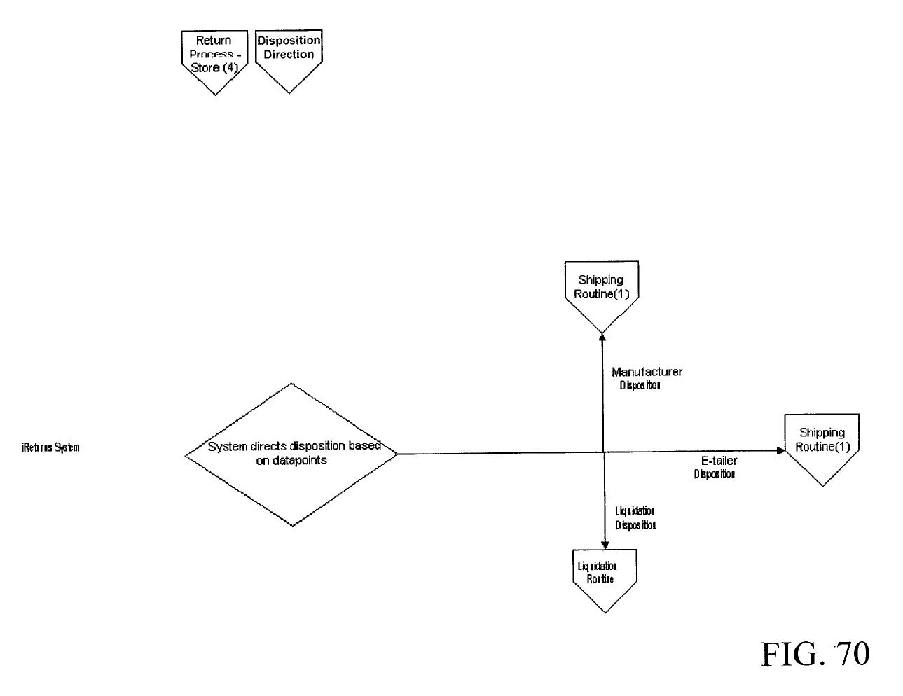

The procedure then proceeds to FIG. 48. The iReturns server prints a receipt 200, and the store associate provides the receipt to the guest 201. The iReturns server then prints a license plate 202, and the store associate places the license plate on the box for the return item 203. The iReturns server then logs the data 204, placing the data in a repository, such as a database 205. The iReturns server then sends the data to the merchant 206, which receives the data 207. The store associate places the returned item in temporary storage 208, and the iReturns server proceeds with the storage subroutine 209 of FIG. 60, and the disposition subroutine 210 of FIG. 70.

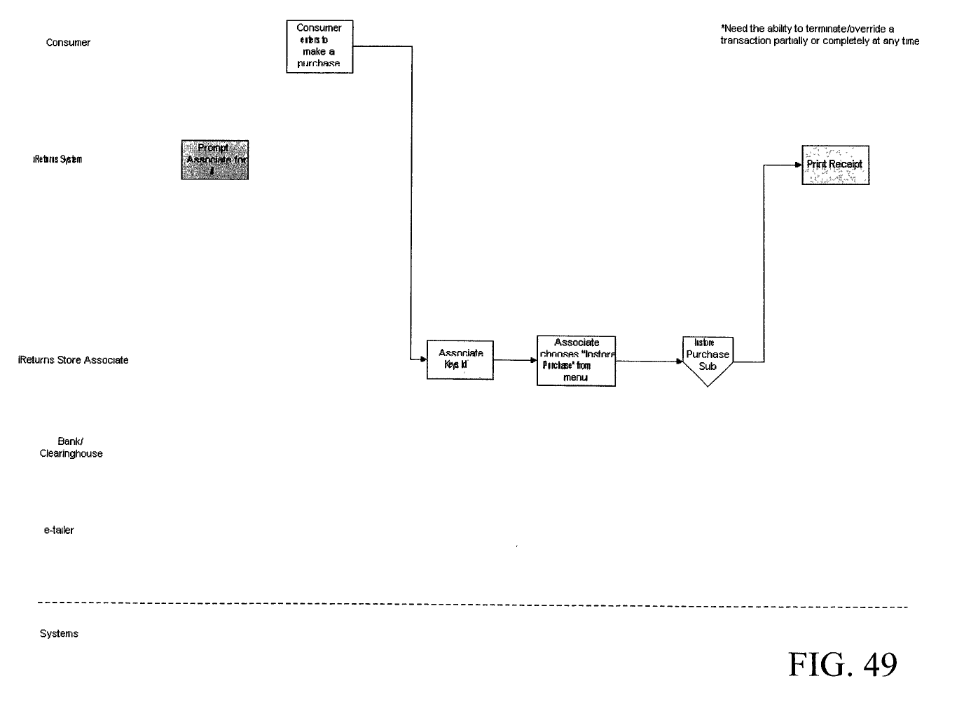

FIG. 49 is a flow diagram of an in store purchase routine for use in accordance with a second embodiment of the present invention.

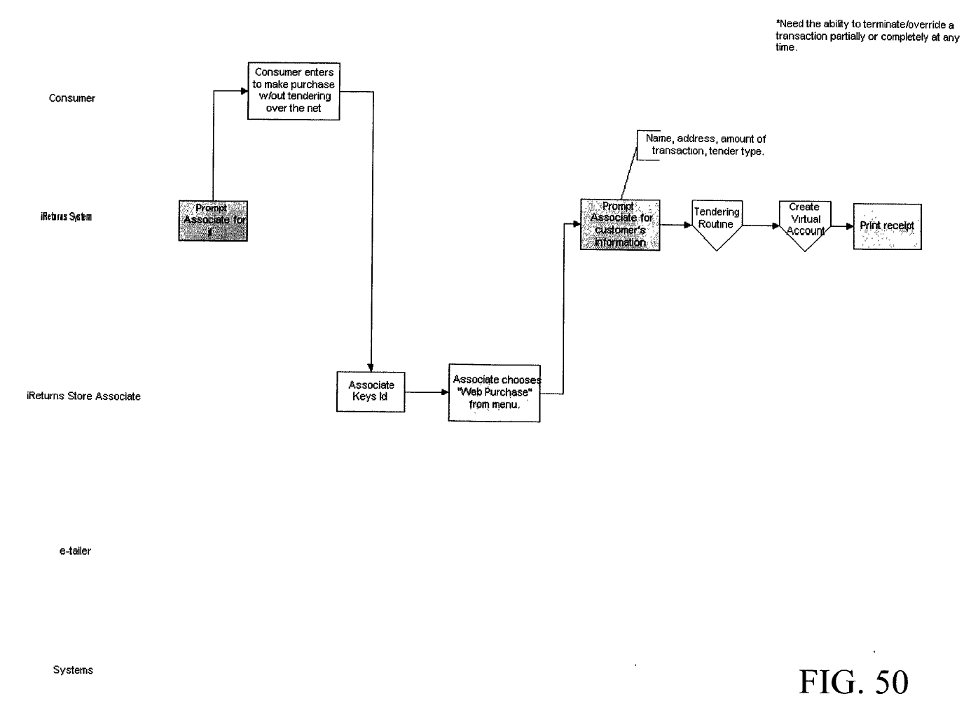

FIG. 50 shows a flow diagram of a network purchase routine for use in accordance with a second embodiment of the present invention.

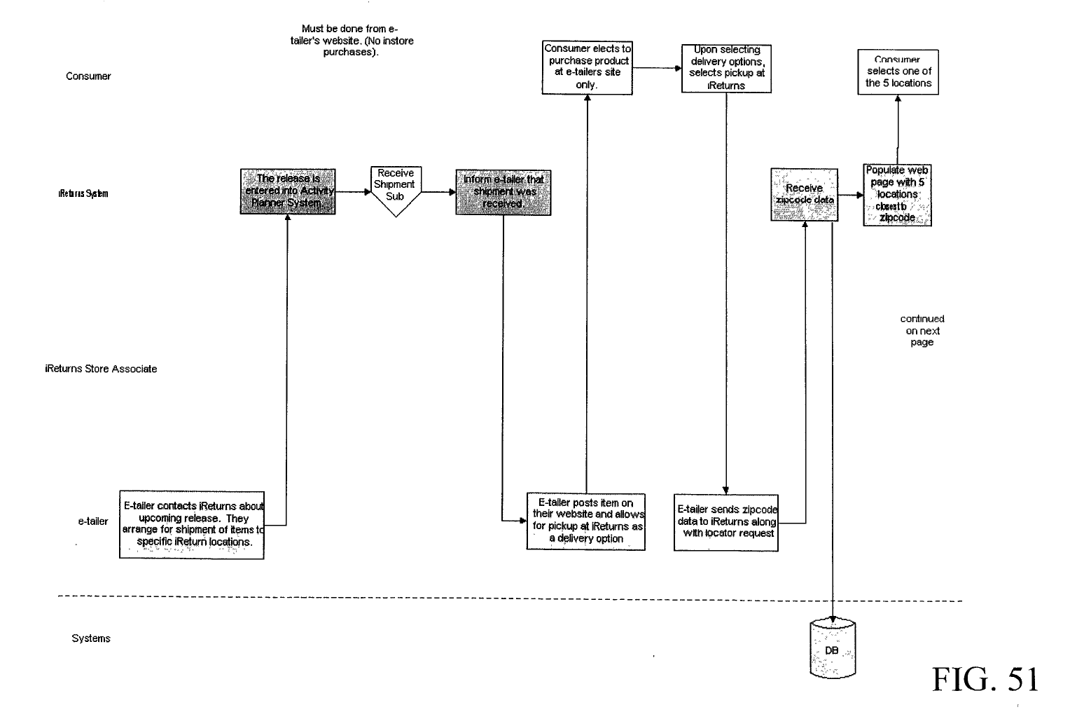

FIG. 51 presents a flow diagram of the first portion of a sameday pickup routine for use in accordance with a second embodiment of the present invention.

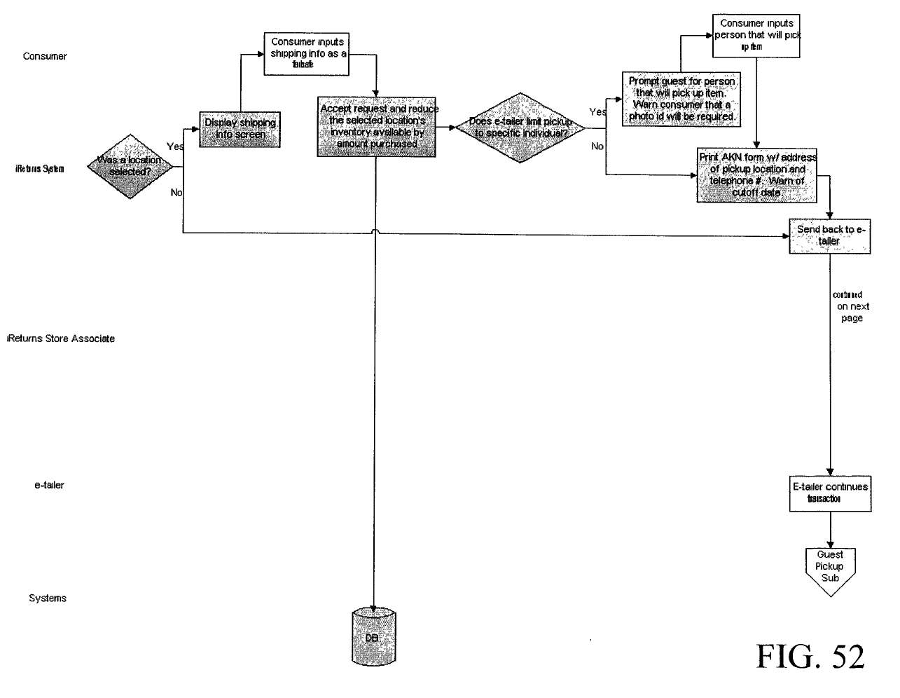

FIG. 52 is a flow diagram of the second portion of the sameday pickup subroutine of FIG. 51.

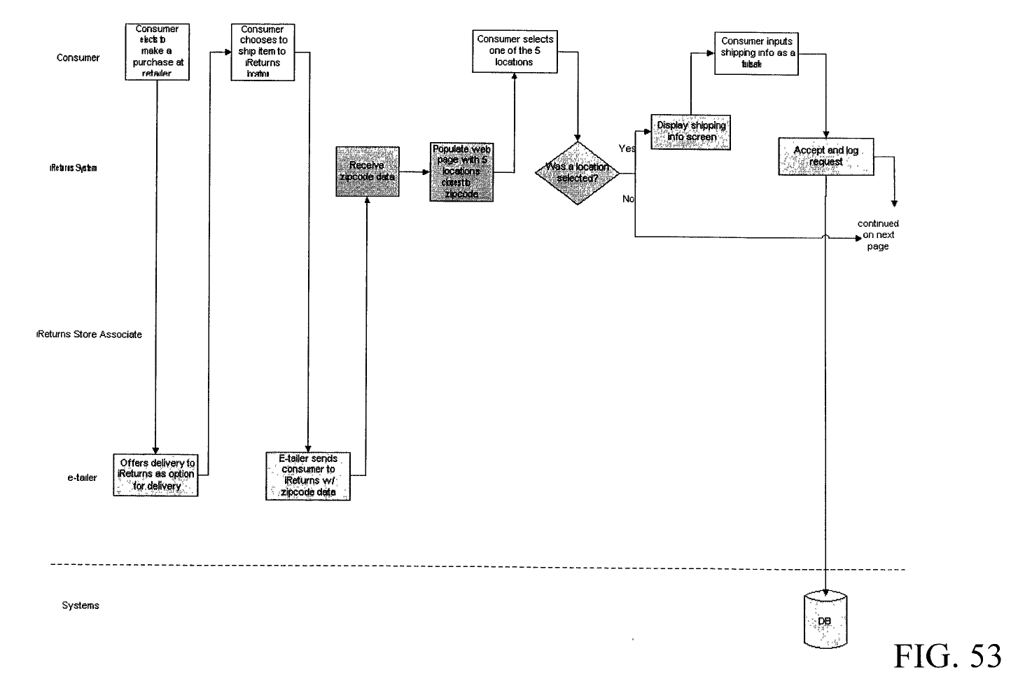

FIG. 53 shows a flow diagram of the first portion of a drop shipment routine for use in accordance with a second embodiment of the present invention.

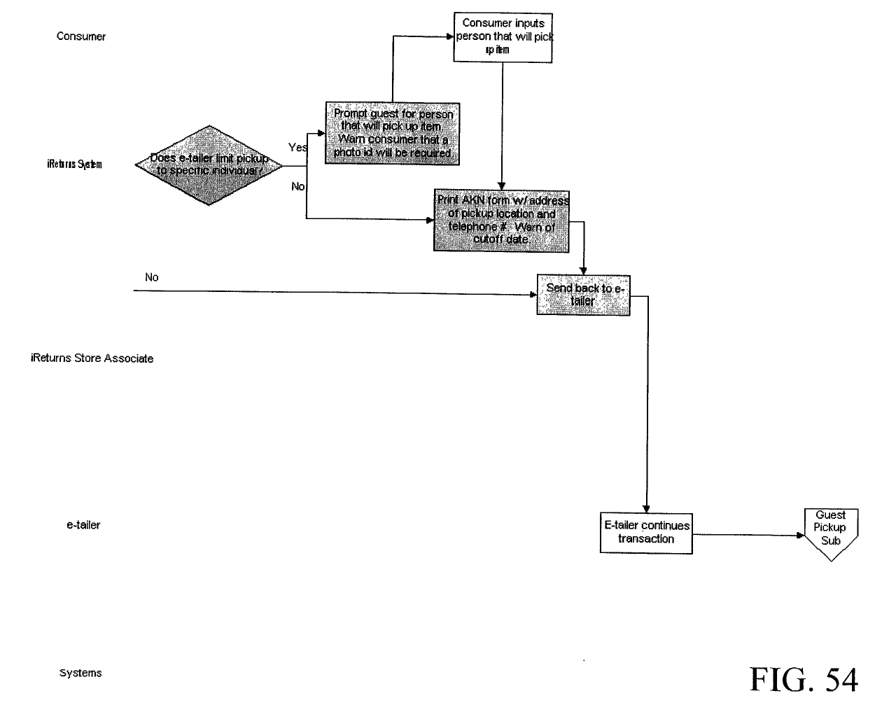

FIG. 54 presents a flow diagram of the second portion of the drop shipment subroutine of FIG. 53.

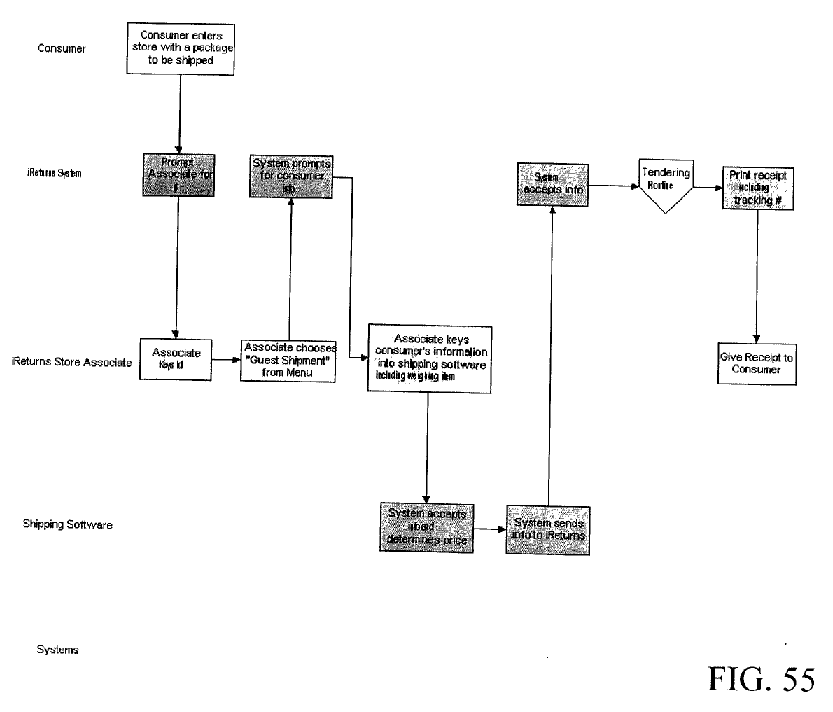

FIG. 55 is a flow diagram of the first portion of a guest shipment routine for use in accordance with a second embodiment of the present invention.

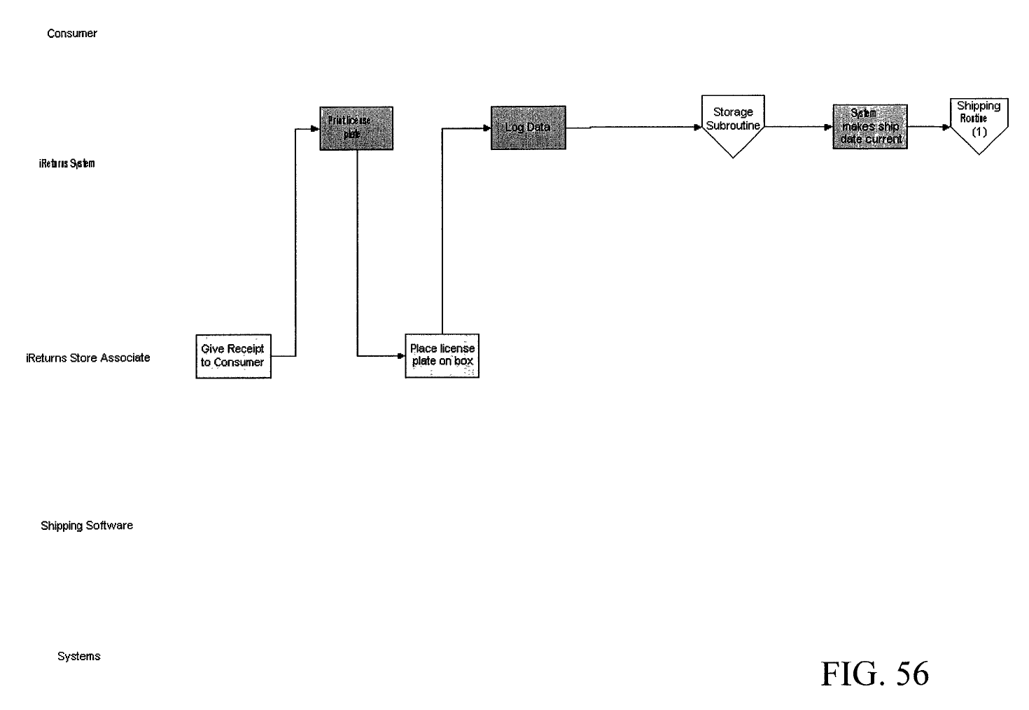

FIG. 56 shows a flow diagram of the second portion of the guest shipment subroutine of FIG. 55.

FIG. 57 presents a flow diagram of an in store purchase subroutine for use in conjunction with FIGS. 47 and 49, in accordance with a second embodiment of the present invention.

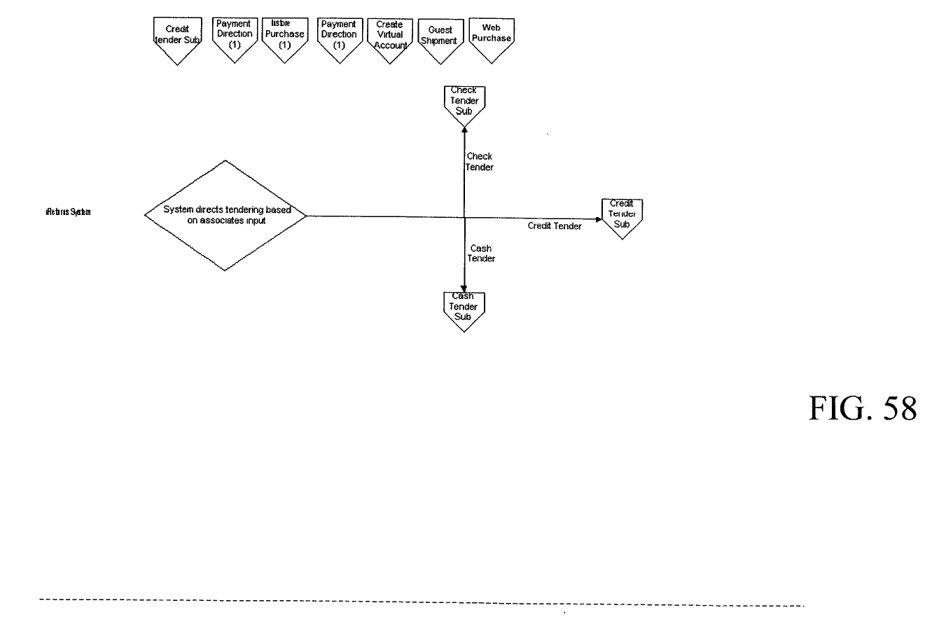

FIG. 58 is a flow diagram of a tendering subroutine for use in conjunction with FIGS. 50, 55, 57, 59, 62, 63, and 64, in accordance with a second embodiment of the present invention.

FIG. 59 shows a flow diagram of a payment direction subroutine for use in conjunction with FIGS. 47 and 57, in accordance with a second embodiment of the present invention.

FIG. 60 presents a flow diagram of a storage subroutine for use in conjunction with FIGS. 48, 56, 65, 66, 67, 68, 71, and 76, in accordance with a second embodiment of the present invention.

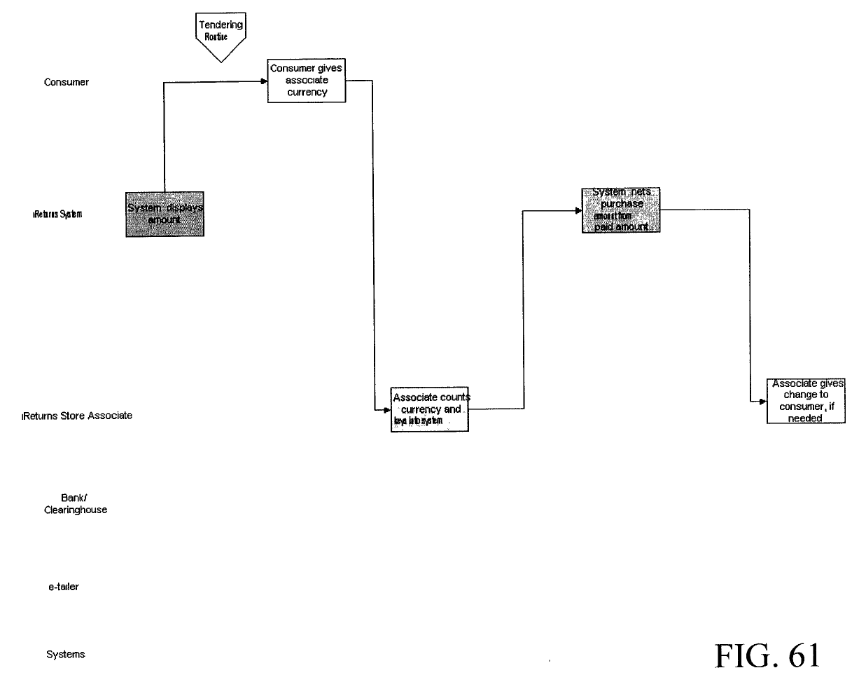

FIG. 61 is a flow diagram of a cash tender subroutine for use in conjunction with FIG. 58, in accordance with a second embodiment of the present invention.

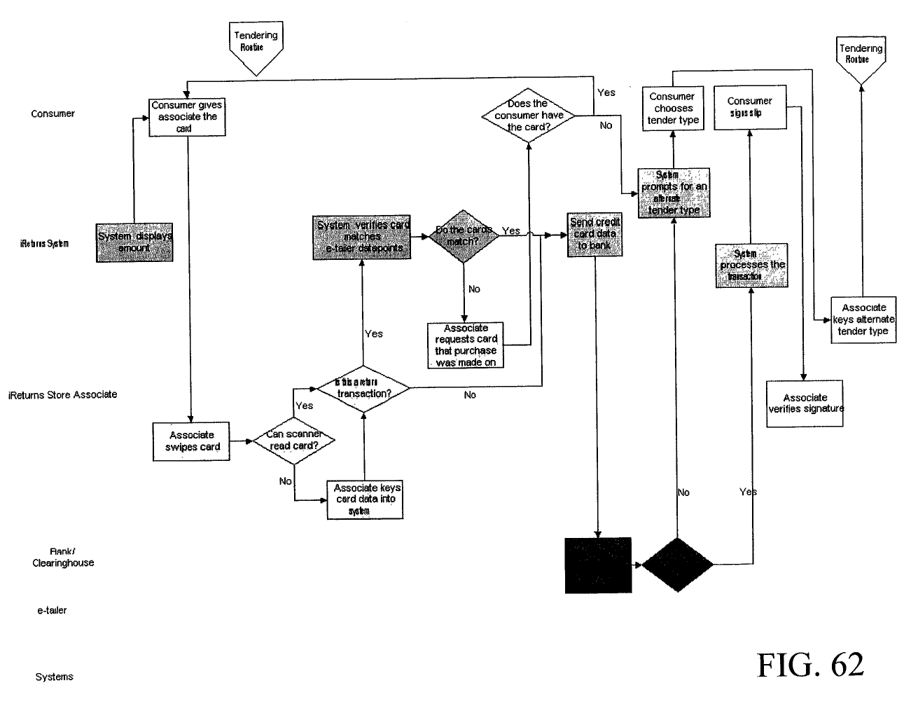

FIG. 62 shows a flow diagram of a credit tender subroutine for use in conjunction with FIG. 58, in accordance with a second embodiment of the present invention.

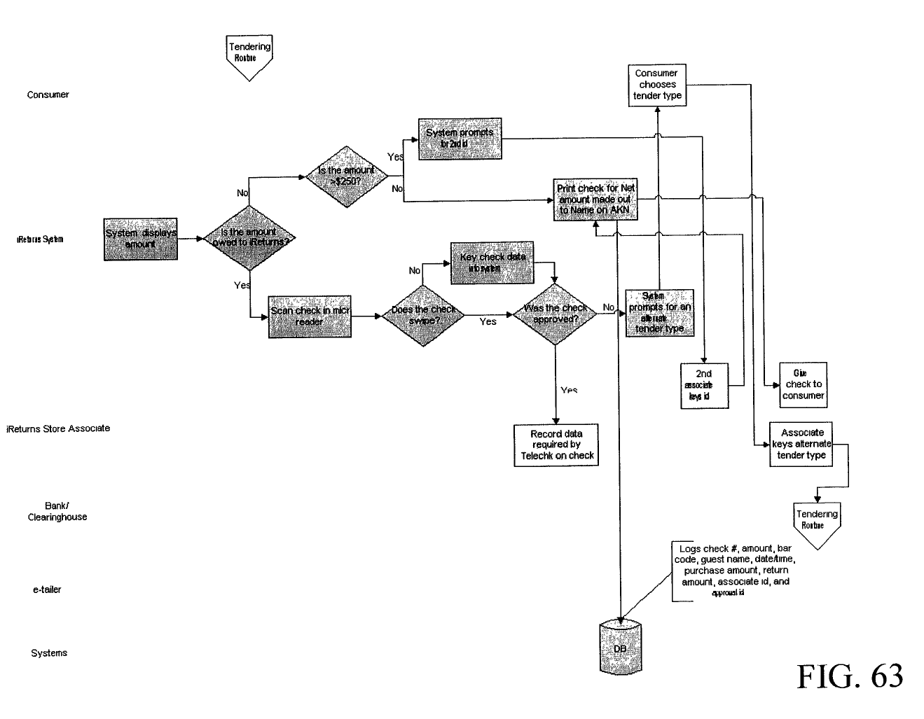

FIG. 63 presents a flow diagram of a check tender subroutine for use in conjunction with FIG. 58, in accordance with a second embodiment of the present invention.

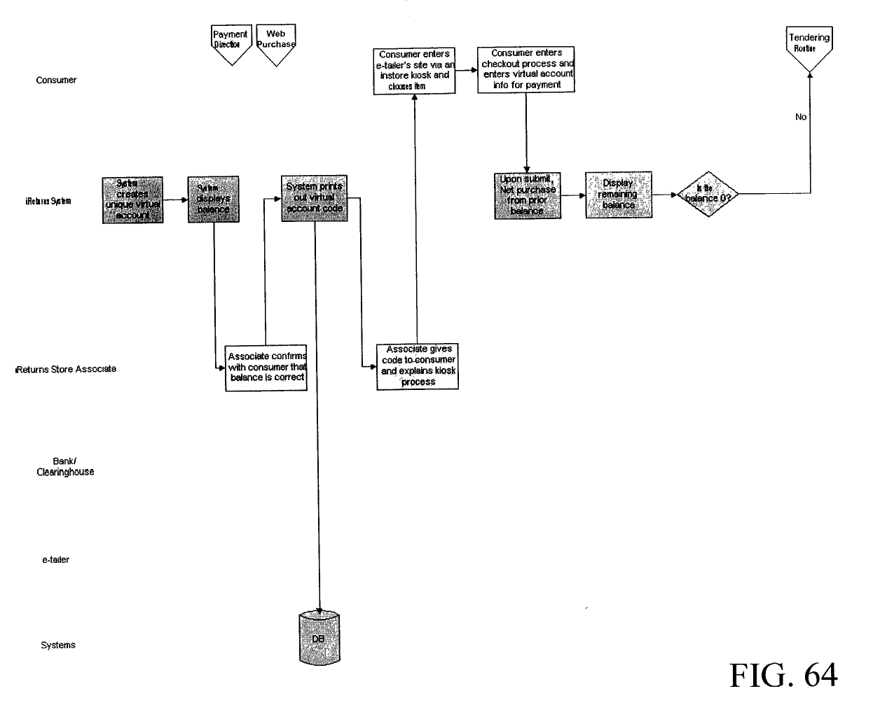

FIG. 64 is a flow diagram of a create virtual account subroutine for use in conjunction with FIGS. 50, 56, and 59, in accordance with a second embodiment of the present invention.

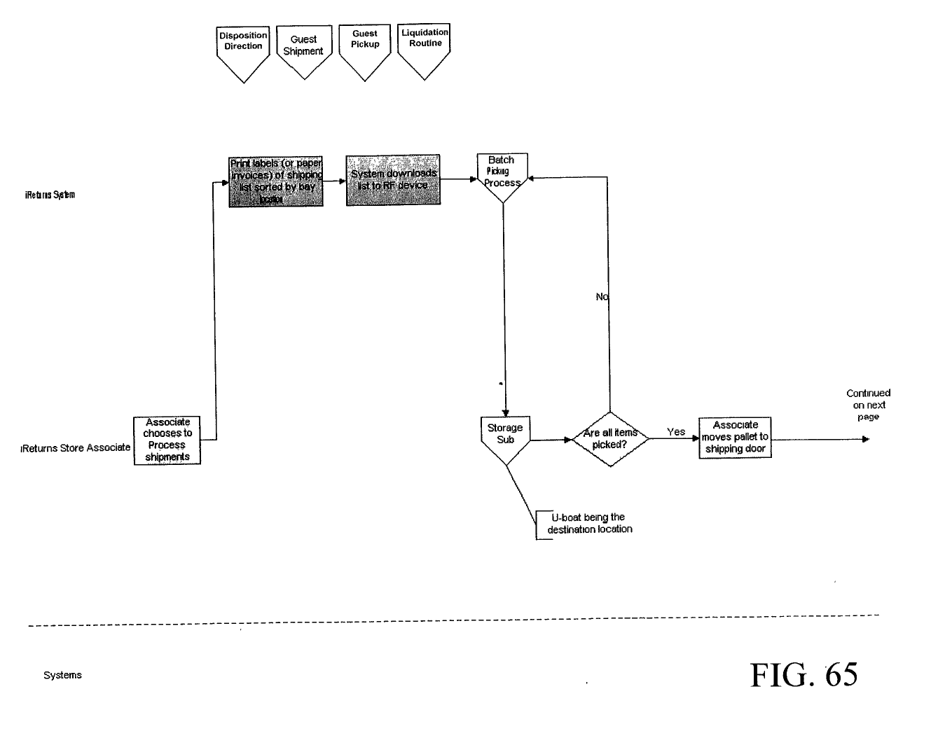

FIG. 65 shows a flow diagram of the first portion of a shipping subroutine for use in conjunction with FIGS. 70, 71, and 72, in accordance with a second embodiment of the present invention.

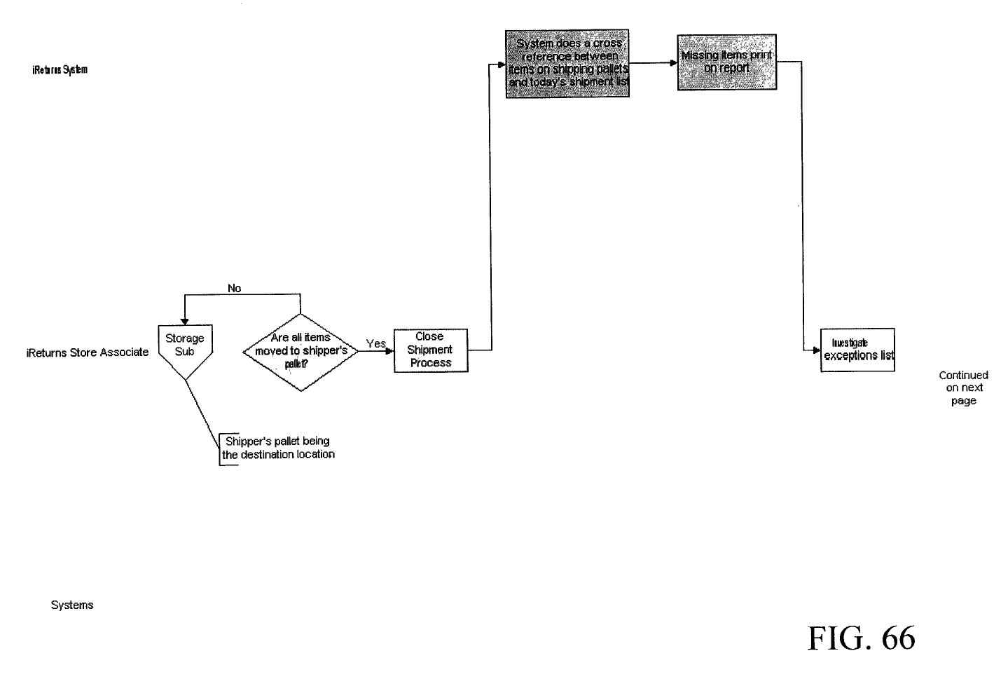

FIG. 66 presents a flow diagram of the second portion of the shipping subroutine of FIG. 65.

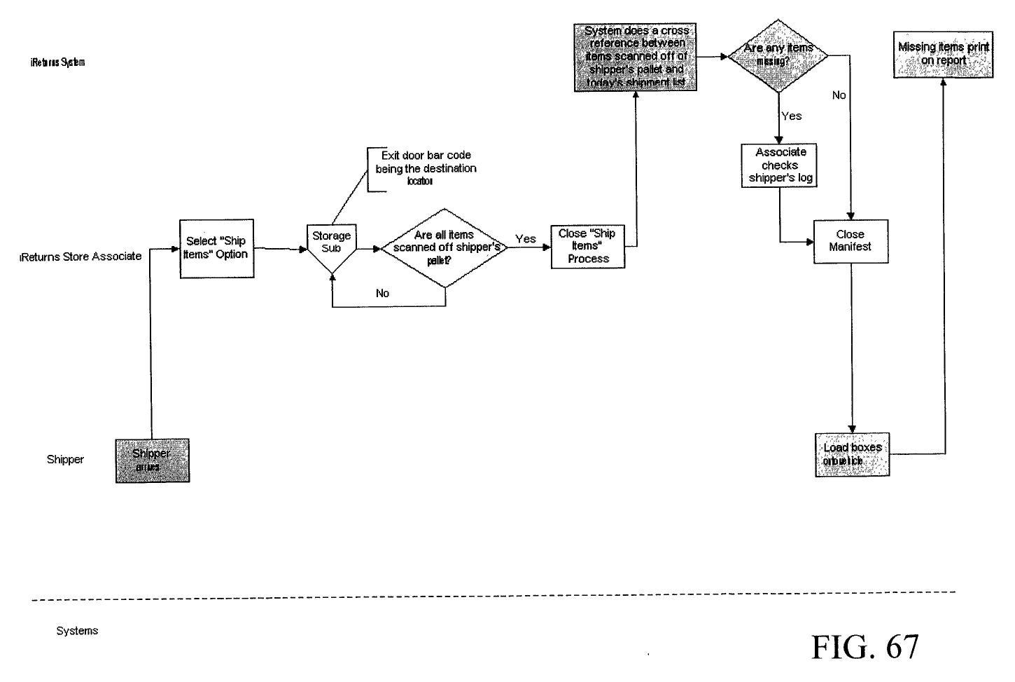

FIG. 67 is a flow diagram of the third portion of the shipping subroutine of FIGS. 65 and 66.

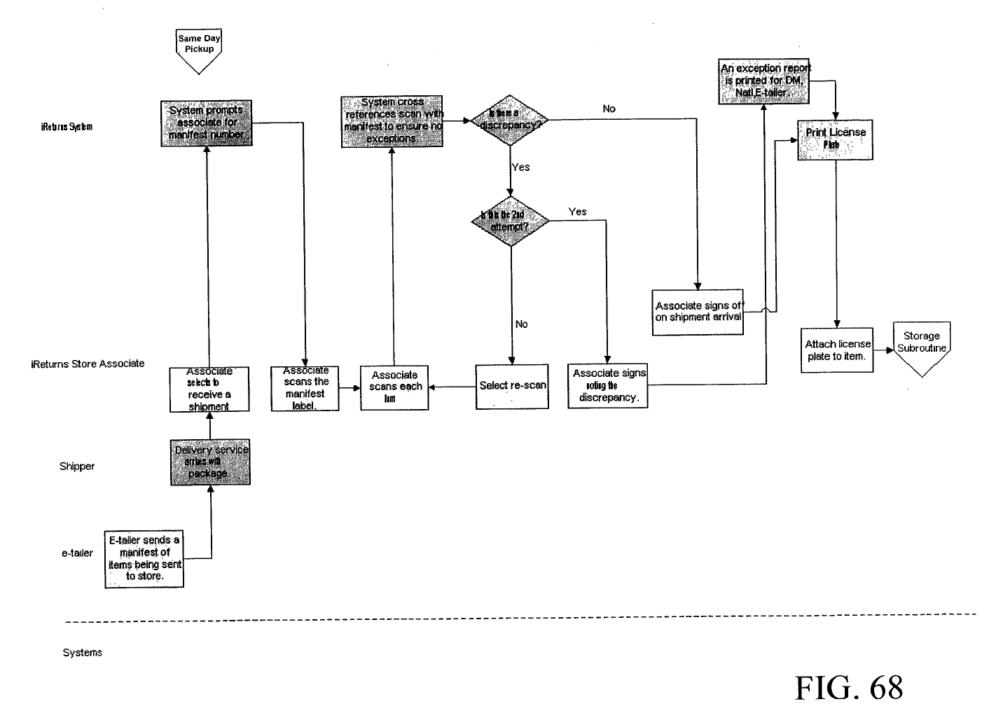

FIG. 68 shows a flow diagram of a receive shipment subroutine for use in conjunction with FIG. 51, in accordance with a second embodiment of the present invention.

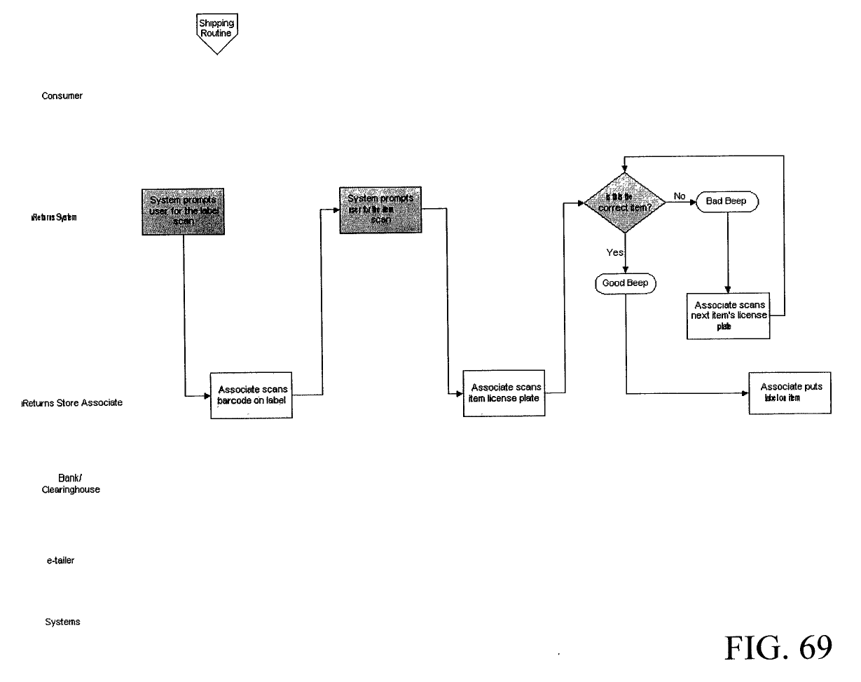

FIG. 69 presents a flow diagram of a batch picking process subroutine for use in conjunction with FIG. 65, in accordance with a second embodiment of the present invention.

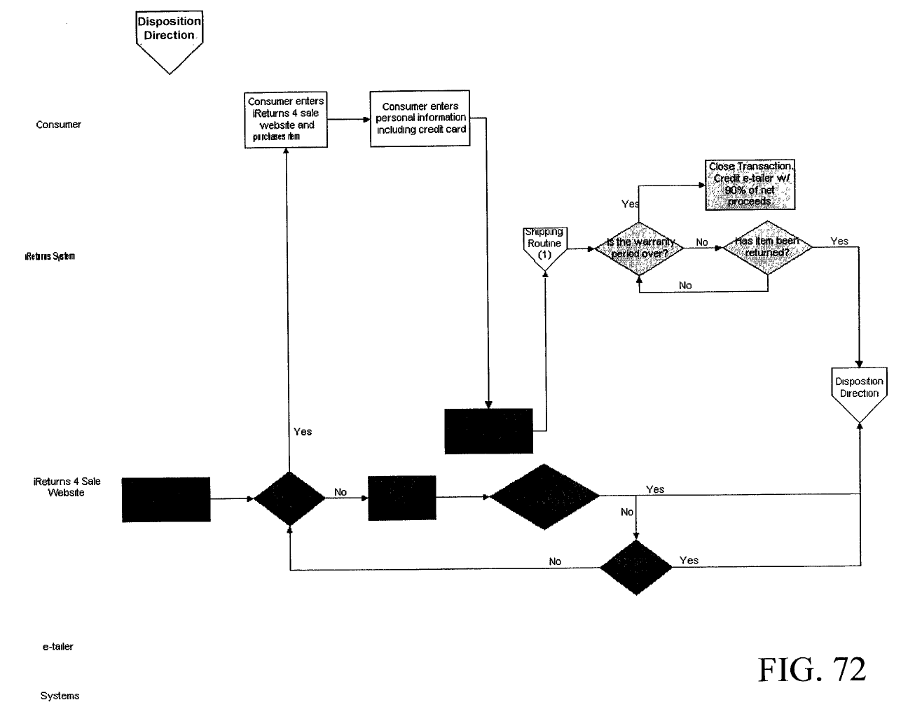

FIG. 70 is a flow diagram of a disposition direction subroutine for use in conjunction with FIGS. 48 and 72, in accordance with a second embodiment of the present invention.

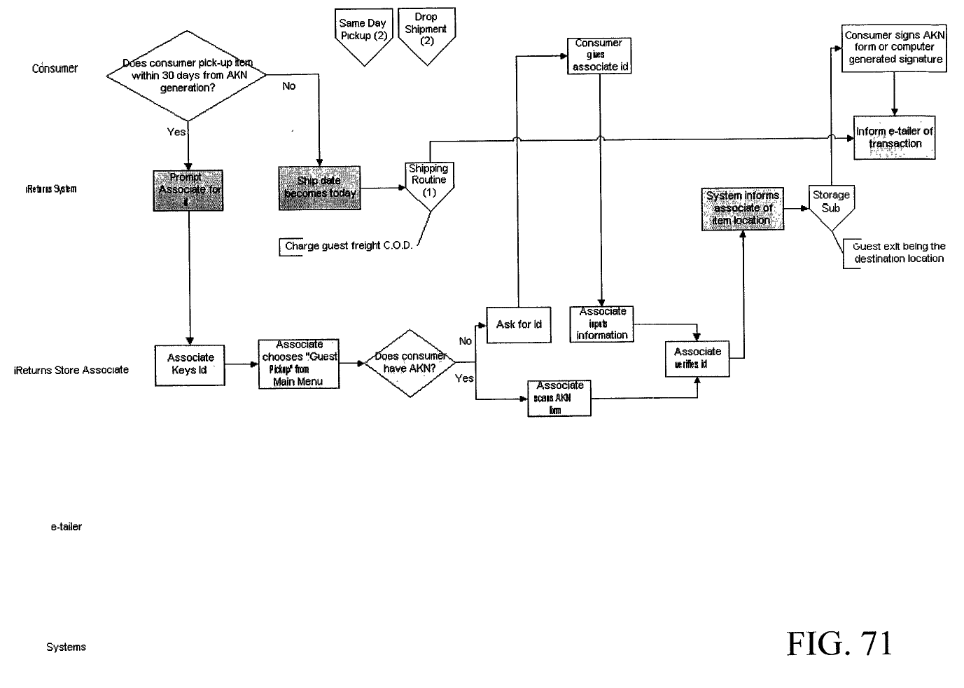

FIG. 71 shows a flow diagram of a guest pickup subroutine for use in conjunction with FIGS. 52 and 54, in accordance with a second embodiment of the present invention.

FIG. 72 presents a flow diagram of a liquidation subroutine for use in conjunction with FIG. 70, in accordance with a second embodiment of the present invention.

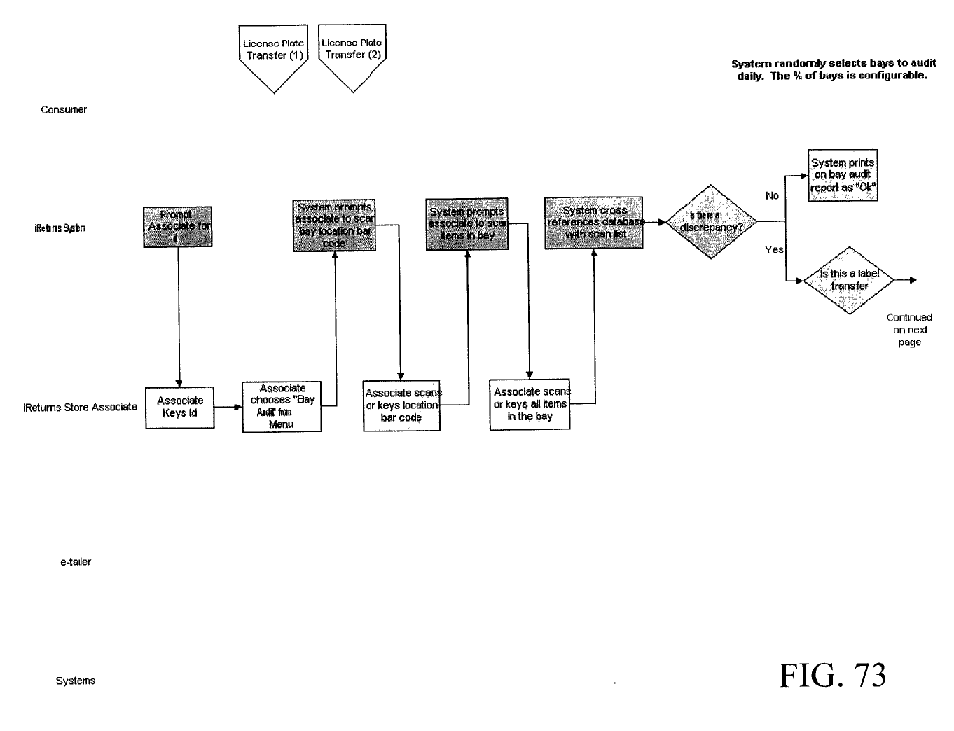

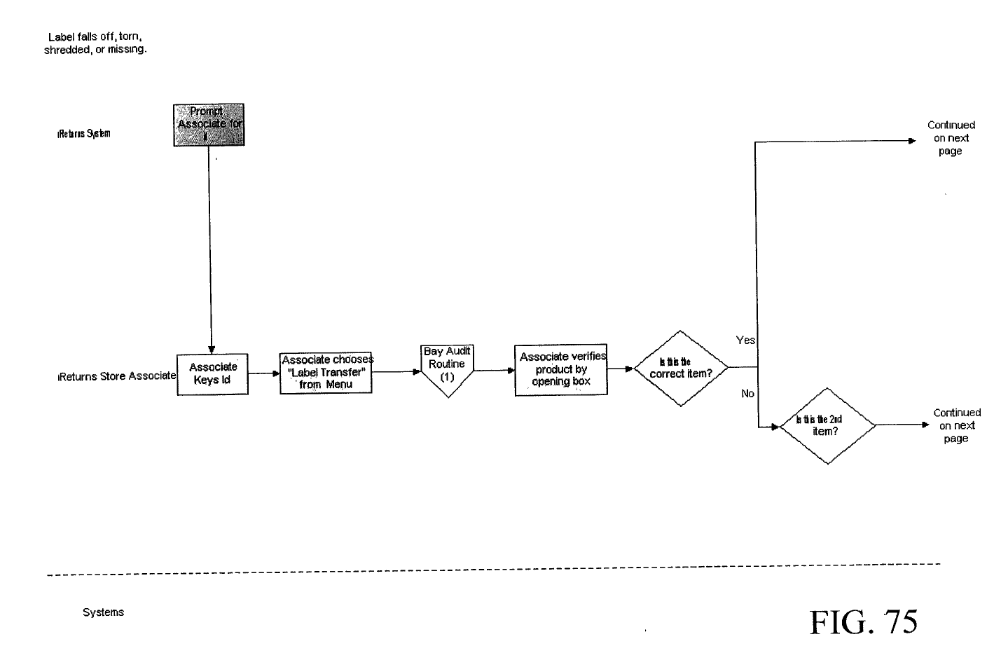

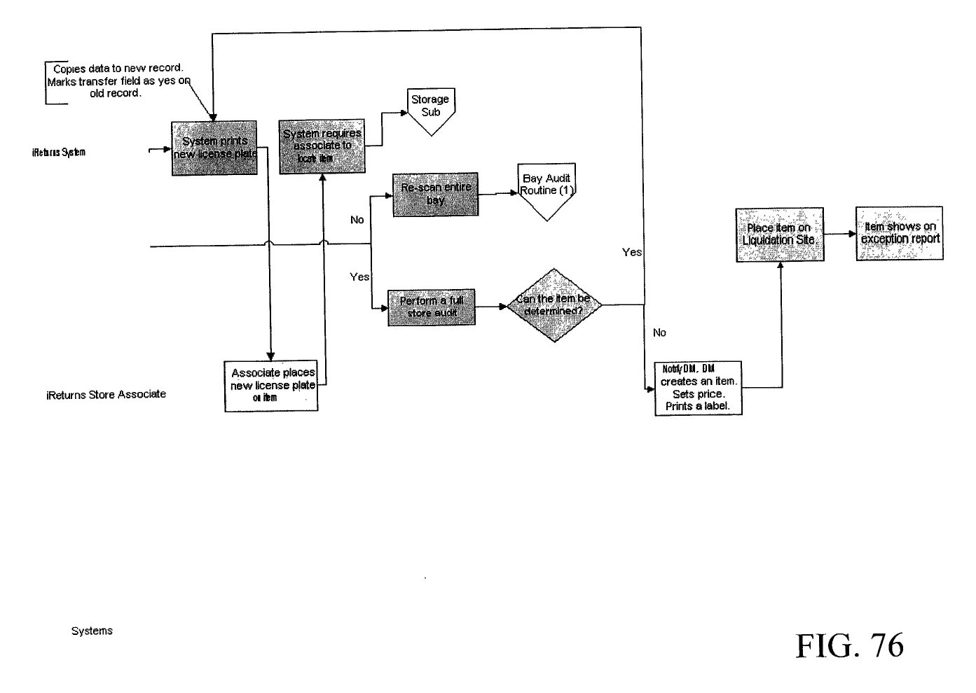

FIG. 73 is a flow diagram of the first portion of a bay audit subroutine for use in conjunction with FIGS. 75 and 76, in accordance with a second embodiment of the present invention.

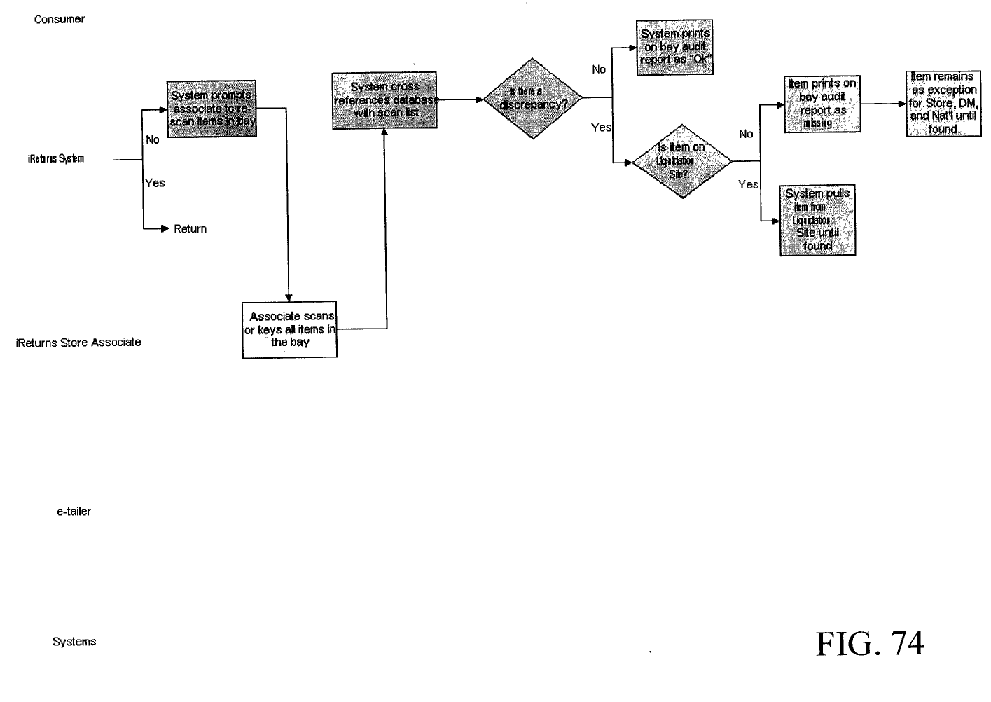

FIG. 74 shows a flow diagram of the second portion of the bay audit subroutine of FIG. 3.

FIG. 75 is a flow diagram of the first portion of a license plate transfer subroutine for use in accordance with a second embodiment of the present invention.

FIG. 76 shows a flow diagram of the second portion of the license plate transfer subroutine of FIG. 3.

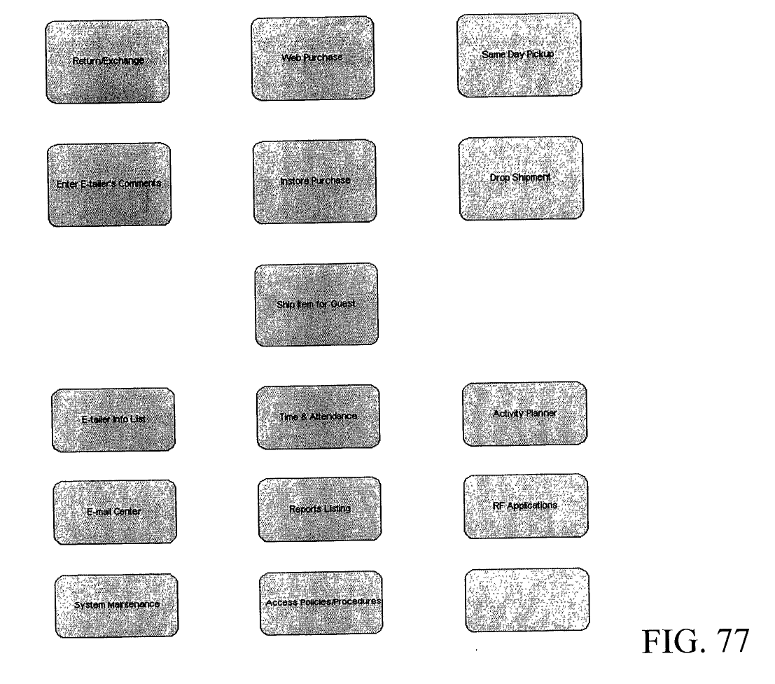

FIG. 77 presents an example main selection screen for a GUI for use in accordance with a second embodiment of the present invention.

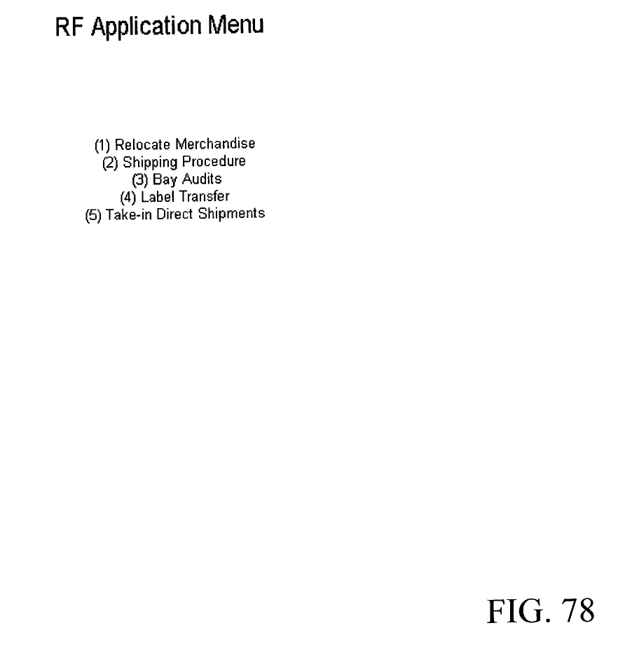

FIG. 78 is an example RF application menu for use with a second embodiment of the present invention.

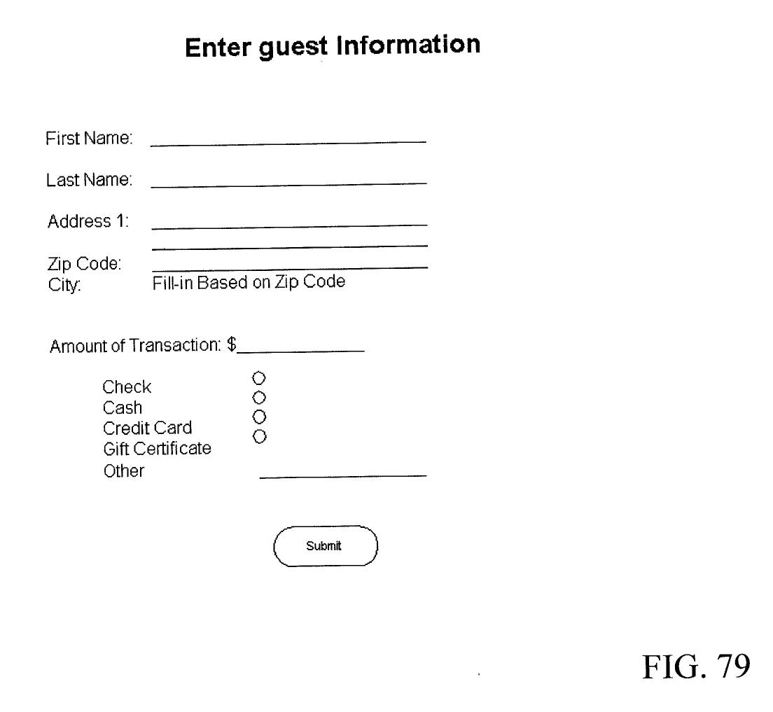

FIG. 79 shows an example web purchase form for use with a second embodiment of the present invention.

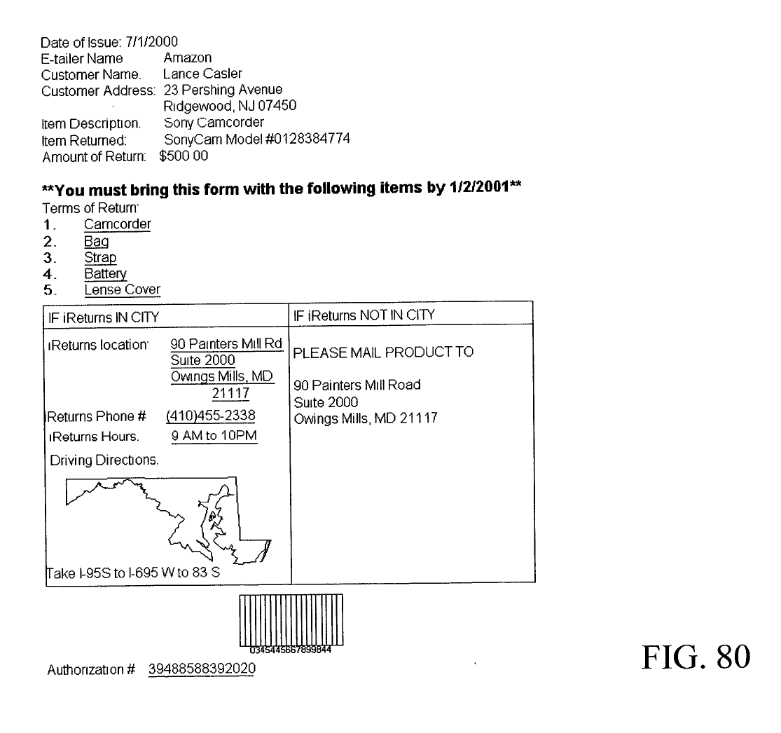

FIG. 80 presents an example return form or ticket with representative bar code for use with a second embodiment of the present invention.

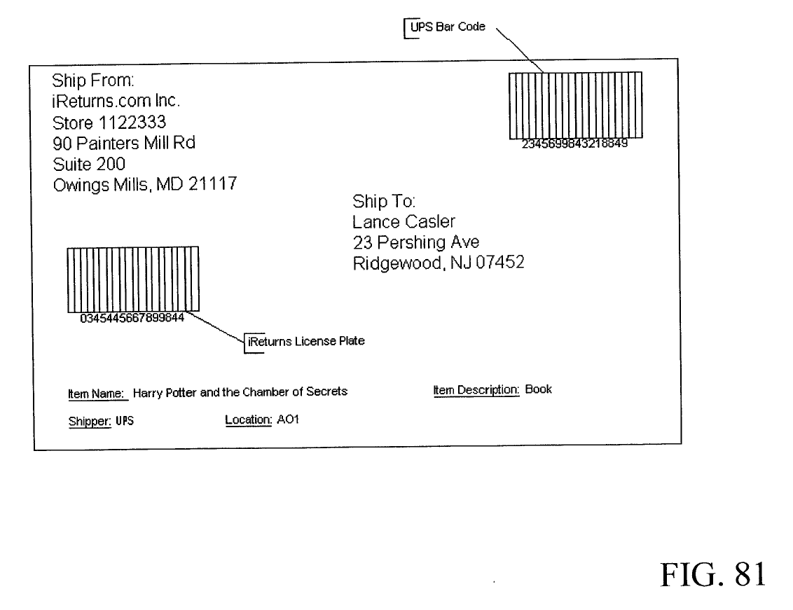

FIG. 81 is an example shipment label for use with a second embodiment of the present invention.

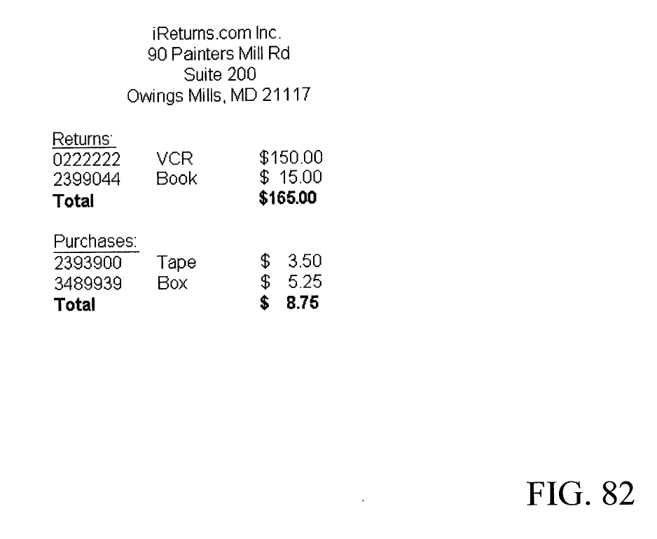

FIG. 82 shows an example of a receipt for use with a second embodiment of the present invention.

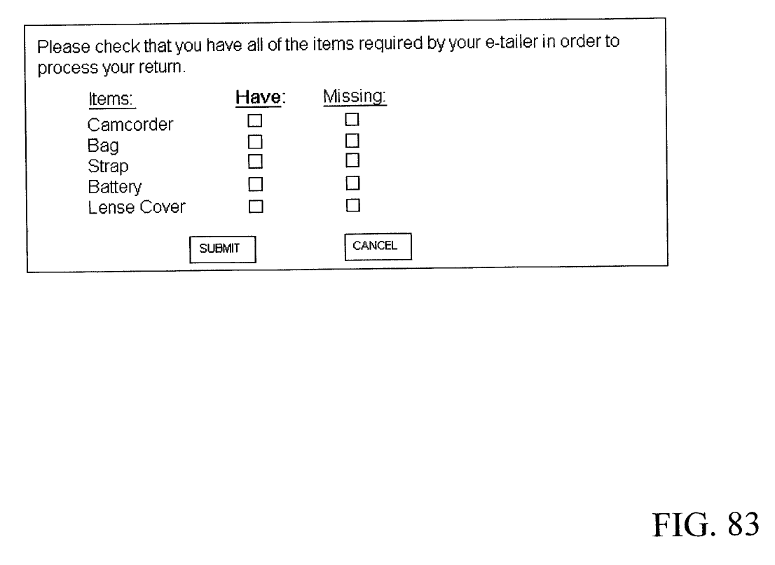

FIG. 83 presents an example return checklist for use via a network, such as the Internet, in accordance with a second embodiment of the present invention.

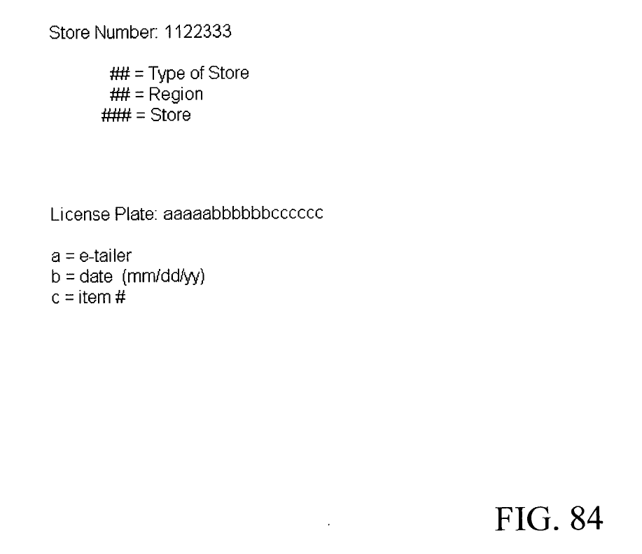

FIG. 84 is an example of store number and license plate formats for use in accordance with embodiments of the present invention.

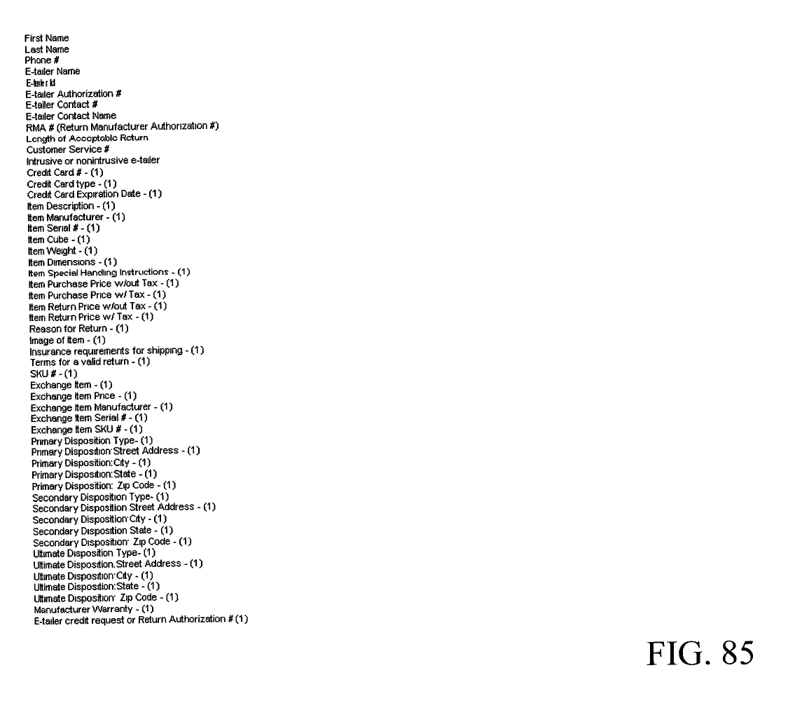

FIG. 85 shows the first part of an example list of data inputs from a merchant for use in accordance with a second embodiment of the present invention.

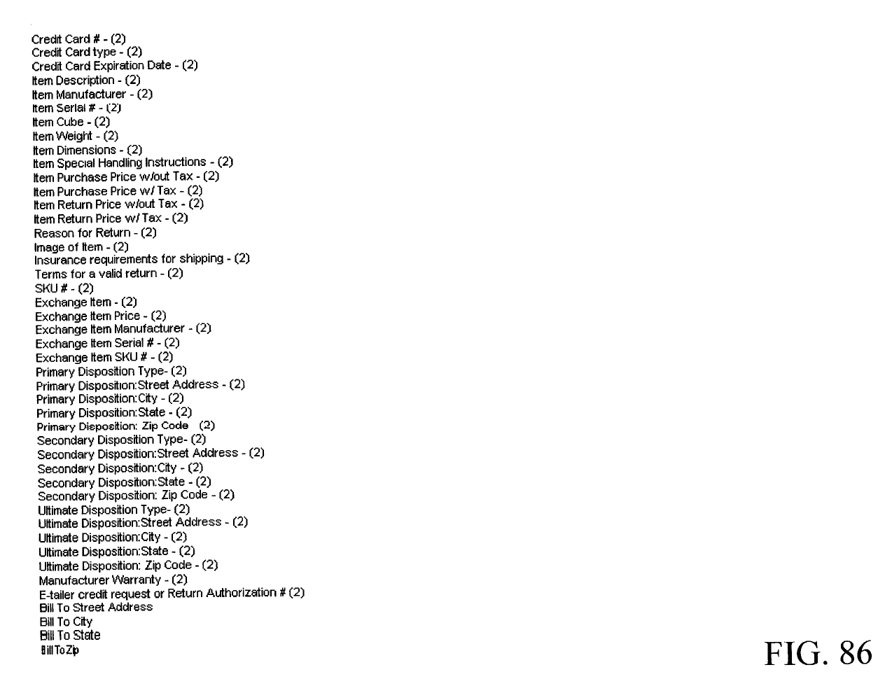

FIG. 86 presents the second part of an example list of data inputs from a merchant for use in accordance with a second embodiment of the present invention.

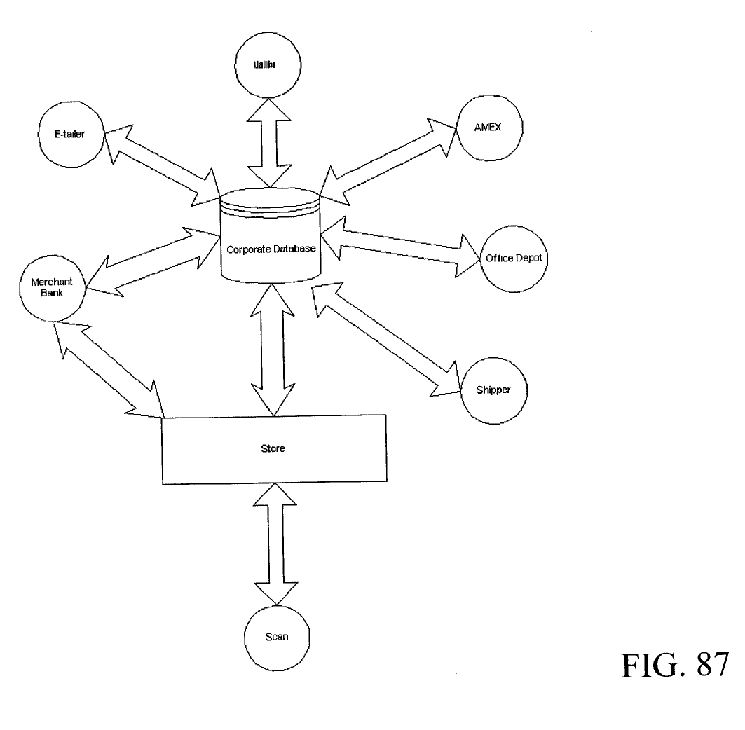

FIG. 87 presents a pictogram of a system architecture in accordance with a second embodiment of the present invention.

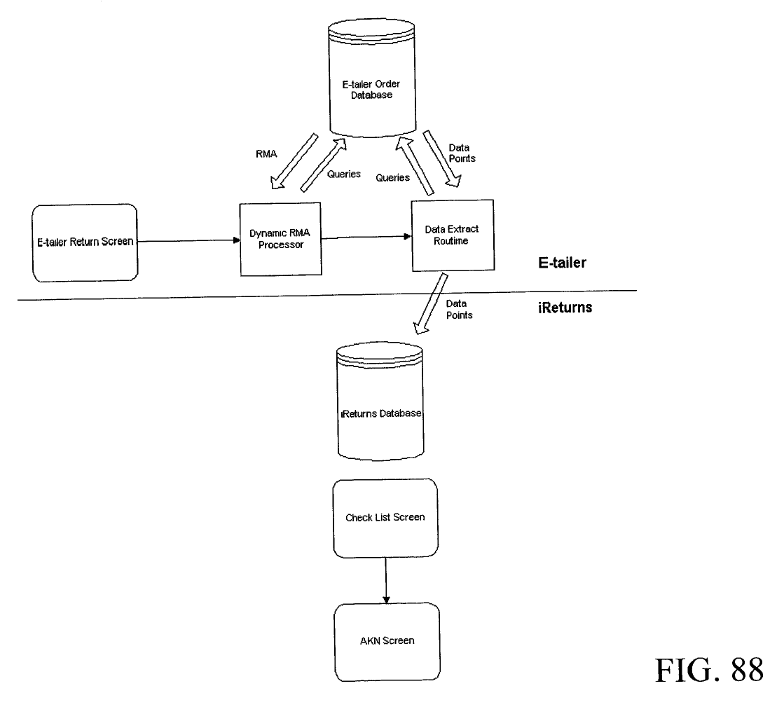

FIG. 88 is a first version of dynamic rate-monotonic analysis (RMA) in accordance with a second embodiment of the present invention.

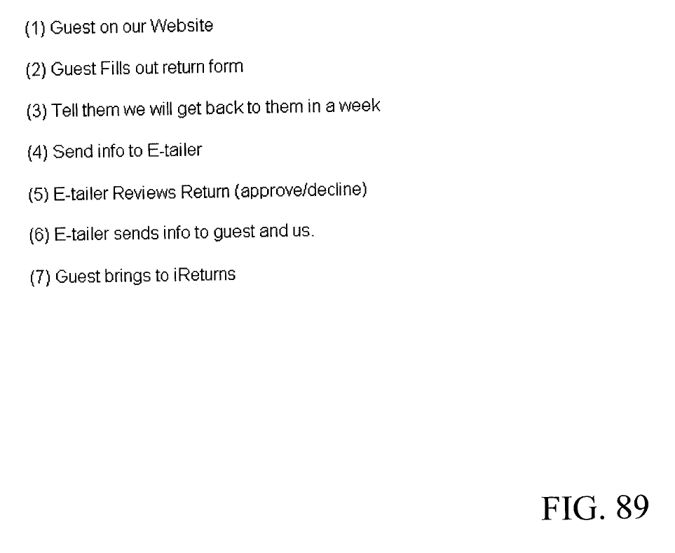

FIG. 89 shows a second version of dynamic RMA in accordance with a second embodiment of the present invention.

Thus, while there have been shown, described, and pointed out fundamental novel features of the invention as applied to embodiments thereof, it will be understood that various omissions, substitutions, and changes in the form and the details of the disclosed invention may be made by those skilled in the art without departing from the spirit of the invention.

What is claimed is:

1. A method for providing return of items via a network and via an item return location, the method comprising:
receiving a selection to return an item;
receiving information relating to the item to be returned;
determining return information for the item from the received information relating to the item to be returned;
assigning coded information relating to the item to be returned, the coded information being associated with the determined return information;
transmitting the coded information via the network, the coded information to be provided with return of the item;
at the item return location, reading the provided coded information;
accessing the determined return information; and
evaluating the item for return based on the determined return information.

2. The method of claim 1, wherein the information relating to the item to be returned includes information about a returnee.

3. The method of claim 1, wherein the return information includes a determination whether the item is returnable.

4. The method of claim 1., wherein the item to be returned includes components, and wherein the information relating to the item to be returned includes a list of the components.

5. The method of claim 1, wherein determining return information for the item from the received information relating to the item to be returned comprises:
determining whether the item is opened.

6. The method of claim 1, wherein determining return information for the item from the received information relating to the item to be returned comprises:
determining whether the item is damaged.

7. The method of claim 1, wherein information relating to the item to be returned includes information regarding whether the item is opened.

8. The method of claim 1, wherein information relating to the item to be returned includes information regarding whether the item is damaged.

9. The method of claim 1, wherein the coded information comprises a bar code.

10. The method of claim 1, wherein the coded information comprises a printable form.

11. The method of claim 1, wherein transmitting the coded information via the network comprises:
transmitting the coded information to a terminal.

12. The method of claim 11, wherein the terminal is coupled to a printer.

13. The method of claim 12, wherein the coded information is printed on the printer.

14. The method of claim 13, wherein reading the provided coded information comprises:
reading the printed coded information.

15. The method of claim 13, wherein the printed coded information comprises a printed bar code, and wherein reading the printed coded information comprises:
a bar code reader reading the printed bar code.

16. The method of claim 1, wherein the network is the Internet.

17. The method of claim 1, further comprising:
storing the received information relating to the item to be returned.

18. The method of claim 1, further comprising:
storing the determined return information.

19. The method of claim 1, wherein the determined return information is stored in a repository.

20. The method of claim 19, wherein the repository comprises a database.

21. The method of claim 19, wherein accessing the determined return information comprises:
retrieving the determined return information from the repository.

22. The method of claim 4, wherein evaluating the item for return based on the determined return information includes:
determining if the list of components matches the components for the item to be returned.

23. The method of claim 5, further comprising:
if the item is opened, auctioning the item.

24. The method of claim 23, wherein the item is auctioned using a reverse auction.

25. The method of claim 3, further comprising:
if the item is returnable, warehousing the item.

26. The method of claim 5, further comprising:
if the item is not opened, warehousing the item.

27. The method of claim 5, further comprising:
if the item is not opened, shipping the item to a customer.

28. The method of claim 1, wherein the determined return information includes disposition instructions for the item.

29. The method of claim 1, wherein the read provided coded information is stored in a repository.

30. The method of claim 29, wherein the item is sold by a merchant.

31. The method of claim 30, further comprising:
providing access for the merchant to the repository.

32. The method of claim 31, wherein the repository is accessible via the network.

33. A system for providing return of an item via a network, comprising:
a server, the server being accessible by at least one terminal via the network for obtaining return of the item and for transmitting coded information to the at least one terminal;
a return location terminal coupled to the server via the network; and
a coded information reader coupled to the return location terminal;
wherein the server receives a selection to return an item from the at least one terminal;
wherein the server receives information relating to the item to be returned;
wherein the server determines return information for the item from the received information relating to the item to be returned;
wherein the server assigns coded information relating to the item to be returned, the coded information being associated with the determined return information;
wherein the server transmits the coded information to the at least one terminal via the network, the coded information to be provided with return of the item;
wherein the coded information reader reads the provided coded information; and
wherein the return location terminal accesses the determined return information.

34. The system of claim 33, wherein the information relating to the item to be returned includes information about a returnee.

35. The system of claim 33, wherein the return information includes a determination whether the item is returnable.

36. The system of claim 33, wherein the item to be returned includes components, and wherein the information relating to the item to be returned includes a list of the components.

37. The system of claim 33, wherein determining return information for the item from the received information relating to the item to be returned comprises:
determining whether the item is opened.

38. The system of claim 33, wherein the server determines return information for the item from the received information relating to the item to be returned by determining whether the item is damaged.

39. The system of claim 33, wherein information relating to the item to be returned includes information regarding whether the item is opened.

40. The system of claim 33, wherein information relating to the item to be returned includes information regarding whether the item is damaged.

41. The system of claim 33, wherein the coded information comprises a bar code.

42. The system of claim 33, wherein the coded information comprises a printable form.

43. The system of claim 33, wherein the at least one terminal is coupled to a printer.

44. The system of claim 43, wherein the coded information is printed on the printer.

45. The system of claim 44, wherein the printed coded information comprises a printed bar code, and wherein the coded information reader comprises a bar code reader.

46. The system of claim 33, wherein the network is the Internet.

47. The system of claim 33, wherein the at least one terminal is coupled to the network via a coupling.

48. The system of claim 47, wherein the coupling comprises one from a group consisting of a wired connection, a wireless connection, and a fiberoptic connection.

49. The system of claim 33, wherein the at least one terminal comprises one selected from a group consisting of a personal computer, a minicomputer, a microcomputer, a main frame computer, a hand held device, and a telephone device.

50. The system of claim 33, wherein the return location terminal comprises one selected from a group consisting of a personal computer, a minicomputer, a microcomputer, a main frame computer, a hand held device, and a telephone device.

51. The system of claim 33, wherein the server comprises one selected from a group consisting of a personal computer, a minicomputer, a microcomputer, and a main frame computer.

52. The system of claim 33, wherein the server comprises a storage device, the storage device including an accessible repository.

53. The system of claim 33, further comprising:
a repository server coupled to the server, the repository server comprising a storage device, wherein the storage device includes an accessible repository.

54. The method of claim 52, wherein the accessible repository comprises a database.

55. A method for a returnee to return an item purchased from a first party via a second party, the method comprising:
the first party receiving information relating to the item and producing return information;
the first party transmitting coded information to the returnee;
the second party receiving the coded information; and
the second party accessing the produced return information to determine whether to accept return of the item.

56. A system for providing return of items via a network and via an item return location, the system comprising:
means for receiving a selection to return an item;
means for receiving information relating to the item to be returned;
means for determining return information for the item from the received information relating to the item to be returned;
means for assigning coded information relating to the item to be returned, the coded information being associated with the determined return information;
means for transmitting the coded information via the network, the coded information to be provided with return of the item;
at the item return location, means for reading the provided coded information;
means for accessing the determined return information; and
means for evaluating the item for return based on the determined return information.
